(19) United States
(12) Patent Application Publication
(10) Pub. No.: US 2025/0004095 A1
(43) Pub. Date: Jan. 2, 2025

(54) RADAR APPARATUS AND RADAR SIGNAL PROCESSING METHOD

(71) Applicant: Panasonic Automotive Systems Co., Ltd., Kanagawa (JP)

(72) Inventors: Takaaki KISHIGAMI, Tokyo (JP); Hidekuni YOMO, Kanagawa (JP); Junji SATO, Tokyo (JP)

(21) Appl. No.: 18/828,769

(22) Filed: Sep. 9, 2024

Related U.S. Application Data
(63) Continuation of application No. PCT/JP2022/035955, filed on Sep. 27, 2022.

(30) Foreign Application Priority Data
Mar. 23, 2022 (JP) 2022-047159

(51) Int. Cl. G01S 7/02; G01S 7/35; G01S 13/02; G01S 13/32; G01S 13/931

(52) U.S. Cl. CPC G01S 7/0234; G01S 7/025; G01S 7/026; G01S 7/354; G01S 13/325; G01S 13/931; G01S 2013/0254

(57) ABSTRACT

A radar apparatus includes: a plurality of transmission antennas including a first transmission antenna for emitting a first linearly polarized wave and a second transmission antenna adjacent to the first transmission antenna and for emitting a second linearly polarized wave different from the first linearly polarized wave; and transmission circuitry, which, in operation, performs multiplexing transmission of a transmission signal to which a phase rotation amount with a phase different by ξ or −ξ between the first transmission antenna and the second transmission antenna in each transmission period is applied, from the plurality of transmission antennas.

### TECHNICAL FIELD

The present disclosure relates to a radar apparatus and a radar signal processing method.

### BACKGROUND ART

Recently, a study of radar apparatuses using a radar transmission signal of a short wavelength including a microwave or a millimeter wave that can achieve high resolution has been carried out. Further, it has been required to develop a radar apparatus which detects not only vehicles but also small objects such as pedestrians in a wide-angle range (e.g., referred to as “wide-angle radar apparatus”) in order to improve the outdoor safety.

Examples of the configuration of the radar apparatus having a wide-angle sensing range include a configuration using a technique of receiving a reflected wave from a target by an array antenna composed of a plurality of antennas (or also referred to as antenna elements), and estimating the direction of arrival of the reflected wave (or referred to as the angle of arrival) using a signal processing algorithm based on received phase differences with respect to element spacings (antenna spacings) (Direction of Arrival (DOA) estimation). Examples of the DOA estimation include a Fourier method, and, a Capon method, Multiple Signal Classification (MUSIC), and Estimation of Signal Parameters via Rotational Invariance Techniques (ESPRIT) that are methods achieving higher resolution.

Further, there has been a proposed radar apparatus, for example, in which a transmitter in addition to a receiver is provided with a plurality of antennas (array antenna), and which is configured to perform beam scanning through signal processing using the transmission and reception array antennas (which may also be referred to as a Multiple Input Multiple Output (MIMO) radar) (e.g., see Non-Patent Literature (hereinafter referred to as “NPL”) 1).

### CITATION LIST

### Patent Literature

### PTL 1

Japanese Unexamined Patent Application Publication (Translation of PCT Application) No. 2011-526371

### PTL 2

U.S. Pat. No. 9,541,638

### PTL 3

US Patent Application Publication No. 2019/0064337

### PTL 4

US Patent Application Publication No. 2020/0363497

### PTL 5

Japanese Patent Application Laid-Open No. 2020-148754

### Non-Patent Literature

### NPL 1

J. Li, and P. Stoica, “MIMO Radar with Colocated Antennas,” Signal Processing Magazine, IEEE Vol. 24, Issue: 5, pp. 106-114, 2007 NPL 2
M. Kronauge, H. Rohling, “Fast two-dimensional CFAR procedure,” IEEE Trans. Aerosp. Electron. Syst., 2013, 49, (3), pp. 1817-1823

### NPL 3

Direction-of-arrival estimation using signal subspace modeling Cadzow, J. A.; Aerospace and Electronic Systems, IEEE Transactions on Volume: 28, Issue: 1 Publication Year: 1992, Page(s): 64-79

### SUMMARY OF INVENTION

However, methods for a radar apparatus (e.g., MIMO radar) to sense a target object (or a target) have not been comprehensively studied.

One non-limiting and exemplary embodiment of the present disclosure facilitates providing a radar apparatus and a radar signal processing method with an enhanced sensing accuracy for sensing a target object.

A radar apparatus according to one exemplary embodiment of the present disclosure includes: a plurality of transmission antennas including a first transmission antenna for emitting a first linearly polarized wave and a second transmission antenna adjacent to the first transmission antenna and for emitting a second linearly polarized wave different from the first linearly polarized wave; and transmission circuitry, which, in operation, performs multiplexing transmission of a transmission signal to which a phase rotation amount with a phase different by φ or −φ between the first transmission antenna and the second transmission antenna in each transmission period is applied, from the plurality of transmission antennas.

Note that these generic or specific exemplary embodiments may be achieved by a system, an apparatus, a method, an integrated circuit, a computer program, or a recoding medium, and also by any combination of the system, the apparatus, the method, the integrated circuit, the computer program, and the recoding medium.

According to an exemplary embodiment of the present disclosure, the target-object sensing accuracy of a radar apparatus can be improved.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 is a block diagram illustrating an example of a configuration of a radar apparatus;

FIG. 2 illustrates an example of a transmission signal in a case where a chirp pulse is used;

FIG. 3 illustrates examples of assignment of Doppler shift amounts and orthogonal codes;

FIG. 4 illustrates examples of assignment of Doppler shift amounts and orthogonal codes;

FIG. 5 illustrates examples of assignment of Doppler shift amounts and orthogonal codes;

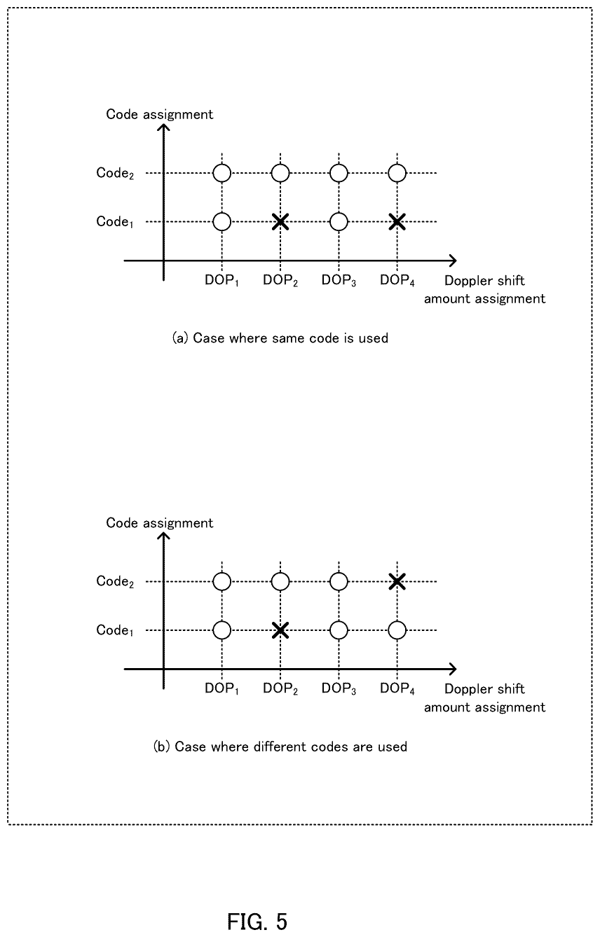

FIG. 6 illustrates an example of transmission antennas;

FIG. 7 illustrates an example of transmission antennas;

FIG. 8 illustrates an example of transmission antennas;

FIG. 9 illustrates an example of directivity of a left-handed circularly polarized wave;

FIG. 10 illustrates an example of directivity of a right-handed circularly polarized wave;

FIG. 11 illustrates an example of transmission signals and reception signals in a case where a chirp pulse is used;

FIG. 12 illustrates an example of Doppler domain compression processing;

FIG. 13 illustrates examples of assignment of Doppler shift amounts and orthogonal codes;

FIG. 14 illustrates an example of Doppler aliasing determination;

FIG. 15 illustrates an arrangement example of antennas;

FIG. 16 illustrates an arrangement example of antennas;

FIG. 17 illustrates an arrangement example of antennas;

FIG. 18 illustrates an arrangement example of antennas;

FIG. 19 is a block diagram illustrating an example of a configuration of a radar apparatus;

FIG. 20 illustrates an arrangement example of antennas;

FIG. 21 is a block diagram illustrating an example of a configuration of a radar apparatus;

FIG. 22 illustrates an example of switching control of transmission signals;

FIG. 23 illustrates an example of switching control of transmission signals;

FIG. 24 illustrates an exemplary transmission switching control table;

FIG. 25 is a block diagram illustrating an example of a configuration of a radar apparatus;

FIG. 26 illustrates an exemplary Doppler multiplexing assignment table;

FIG. 27 illustrates an exemplary Doppler multiplexing assignment table; and

FIG. 28 illustrates an exemplary Doppler multiplexing assignment table.

### DESCRIPTION OF EMBODIMENTS

A MIMO radar transmits, from a plurality of transmission antennas (also referred to as “transmission array antenna”), signals (radar transmission waves) that are time-division, frequency-division, or code-division multiplexed, for example. The MIMO radar then receives signals (radar reflected waves) reflected, for example, by an object around the radar using a plurality of reception antennas (also referred to as “reception array antenna”) to separate and receive multiplexed transmission signals from reception signals. Through such processing, the MIMO radar performs array signal processing using these reception signals as a virtual reception array.

Further, in the MIMO radar, it is possible to enlarge the antenna aperture of the virtual reception array so as to enhance the angular resolution by appropriately arranging element spacings in transmission and reception array antennas. Alternatively, the MIMO radar allows reduction of sidelobes or grating lobes by more dense arrangement of the antenna spacings of the virtual reception array.

For example, Patent Literature (hereinafter, referred to as “PTL”) 1 discloses a MIMO radar (hereinafter referred to as a “time-division multiplexing MIMO radar”) that uses, as a multiplexing transmission method for the MIMO radar, time-division multiplexing transmission by which signals are transmitted at transmission times shifted per transmission antenna. The time-division multiplexing MIMO radar outputs transmission pulses, which are an example of transmission signals, while sequentially switching the transmission antennas in a defined period. The time-division multiplexing MIMO radar receives, at a plurality of reception antennas, signals that are the transmission pulses reflected by an object, performs processing of correlating the reception signals with the transmission pulses, and then performs, for example, spatial fast Fourier transform (FFT) processing (processing for estimation of the directions of arrival of the reflected waves).

The time-division multiplexing MIMO radar sequentially switches the transmission antennas, from which the transmission signals (for example, the transmission pulses or radar transmission waves) are to be transmitted, in a defined period. The time-division multiplexing MIMO radar can thus extract propagation path responses indicated by the product (=Nt×Na) of number Nt of transmission antennas and number Na of reception antennas, so as to perform the array signal processing using these Nt×Na reception signals as a virtual reception array. For example, it is difficult to utilize the transmission antennas such that the number thereof is made greater than the number of transmission antennas obtained by the transmission signals time-division multiplexed by switching of the transmission antennas (e.g., the number of time-division multiplexing). For example, when the radar apparatus transmits a transmission signal using Nt transmission antennas by number Nt of time-division multiplexing, it is difficult to extract propagation path responses that exceed (Nt×Na). Accordingly, when the number of antennas is limited due to constraints such as the cost or installation location of the radar apparatus, the angular resolution or a sidelobe reducing effect can be limited and it may be impossible to enhance the angular measurement performance.

Next, by way of example, attention will be paid to a method of multiplexing and transmitting transmission signals simultaneously from a plurality of transmission antennas.

Examples of the method for simultaneously multiplexing and transmitting transmission signals from a plurality of transmission antennas include a method (hereinafter referred to as Doppler multiplexing transmission) for transmitting signals such that a plurality of transmission signals can be separated in the Doppler frequency domain on the receiver (see, for example, NPL 2).

In the Doppler multiplexing transmission, transmission signals transmitted from transmission antennas different from a reference transmission antenna are, at a transmitter, given respective Doppler shift amounts different from that given to a transmission signal transmitted from the reference transmission antenna, and are simultaneously transmitted from a plurality of transmission antennas (e.g., Nt transmission antennas). In the Doppler multiplexing transmission, the signals received using a plurality of reception antennas (e.g., Na reception antennas) are each filtered in the Doppler frequency domain, so that the transmission signals transmitted from the transmission antennas are separated and received. Thus, the MIMO radar using the Doppler multiplexing transmission (hereinafter, referred to as “Doppler multiplexing MIMO radar”) can extract propagation path responses indicated by the product (=Nt×Na) of number Nt of transmission antennas and number Na of reception antennas, and performs array signal processing using these (Nt×Na) reception signals as a virtual reception array. For example, it is difficult to utilize the transmission antennas such that the number thereof is made greater than the number of transmission antennas performing Doppler multiplexing transmission (e.g., the number of Doppler multiplexing). For example, when the radar apparatus transmits transmission signals using Nt transmission antennas with number Nt of Doppler multiplexing, it is difficult to extract propagation path responses that exceed (Nt×Na) in number.

Further, another method of multiplexing and transmitting transmission signals simultaneously from a plurality of transmission antennas is code multiplexing transmission (see, for example, PTL 2). For example, a MIMO radar using the code multiplexing transmission (hereinafter, referred to as “code multiplexing MIMO radar”) performs code multiplexing transmission from a plurality transmission antennas (e.g., Nt transmission antennas) by repeating, for each repeated transmission of the transmission signals (e.g., chirp signals), application of phase modulation based on a code string (hereinafter, also referred to as a code or a code sequence) different for each transmission antenna. Further, the code multiplexing MIMO radar extracts distance information of code-multiplexed reception signals by performing wave detection processing on signals received using, for example, a plurality of reception antennas (e.g., Na reception antennas). Further, the code multiplexing MIMO radar performs, for example, on the distance information obtained for each repeated transmission of the transmission signals, Fourier transform processing in a velocity direction by dividing the distance information into M pieces (for example, the code length of the code string is used as M). The code multiplexing MIMO radar separates the code-multiplexed reception signals by applying phase correction based on detected velocity components to M results of the Fourier transform processing in the velocity direction, and multiplying the M results by inverse code strings for separating code strings applied for each transmission antenna.

Such a configuration of the code multiplexing MIMO radar allows the code multiplexing MIMO radar to reduce mutual interference between the code-multiplexed reception signals and separate the code-multiplexed reception signals, for example, even when the relative velocity between a target and the code multiplexing MIMO radar is not zero. Thus, the code multiplexing MIMO radar can extract propagation path responses indicated by the product (=Nt×Na) of number Nt of transmission antennas and number Na of reception antennas, and performs array signal processing using these (Nt×Na) reception signals as a virtual reception array. For example, it is difficult to utilize the transmission antennas such that the number thereof is made greater than the number of transmission antennas performing code multiplexing transmission (e.g., the number of code multiplexing). For example, when the radar apparatus transmits transmission signals using Nt transmission antennas with number Nt of code multiplexing, it is difficult to extract propagation path responses that exceed (Nt×Na) in number.

Further, there are techniques for improving radar detection performance or identification performance by using, for example, an antenna that emits differently polarized radio waves or an antenna that receives differently polarized radio waves (see, for example, PTL 3 or 4). A radar apparatus using a plurality of polarized waves is also referred to as a “polarization radar (Polarimetric radar),” for example.

For example, PTL 3 or PTL 4 discloses a method for detecting and identifying an object by transmitting a transmission signal by an antenna using vertically polarized waves or horizontally polarized waves, and by using a signal received by an antenna using vertically polarized waves or horizontally polarized waves. PTL 4 discloses, for example, a method for detecting and identifying an object by transmitting a transmission signal by an antenna using left-handed circularly polarized waves or right-handed circularly polarized waves, and by using a signal received by an antenna using left-handed circularly polarized waves or right-handed circularly polarized waves. Note that an antenna using linearly polarized waves such as the vertically polarized waves or the horizontally polarized waves, or circularly polarized waves such as left-handed circularly polarized waves or right-handed circularly polarized waves are also referred to as a “polarized antenna.”

Such a polarization radar uses a plurality of different types of polarized antennas while improving the detection performance or identification performance of the radar. For example, four transmission antennas are used to transmit four types of left-handed circularly polarized waves and right-handed circularly polarized waves in addition to the vertically polarized waves and horizontally polarized waves. Further, when configuring a MIMO radar for each polarization, a larger number of transmission antennas are used. For example, 4×Nt transmission antennas are used to perform MIMO multiplexing transmission using Nt transmission antennas for each of 4 polarizations. For example, in one exemplary embodiment of the present disclosure, a radar apparatus (e.g., a polarimetric radar apparatus or a polarimetric MIMO radar) generates a new polarized wave (e.g., circularly polarized wave) by combining polarized antennas, thereby performing multiplexing transmission using a large number of polarized waves using a small number of transmission antennas. With this configuration, the radar apparatus of one exemplary embodiment according to the present disclosure makes it possible to reduce an increase in number of transmission antennas and utilize more virtual reception antennas, so as to improve the angular measurement performance of the radar apparatus and improve the sensing accuracy for sensing a target object.

Embodiments of the present disclosure will be described below in detail with reference to the drawings. In the embodiments, the same constituent elements are identified with the same numerals, and a description thereof is omitted because of redundancy.

The following describes a configuration of a radar apparatus (for example, MIMO radar configuration) having a transmitting branch in which multiplexed different transmission signals are simultaneously sent from a plurality of transmission antennas, and a receiving branch in which the transmission signals are separated and subjected to reception processing.

Further, by way of example, a description will be given below of a configuration of a radar system using a frequency-modulated pulse wave such as a chirp pulse (e.g., also referred to as chirp pulse transmission (fast chirp modulation)). However, the modulation scheme is not limited to frequency modulation. For example, an exemplary embodiment of the present disclosure is also applicable to a radar system that uses a pulse compression radar configured to transmit a pulse train after performing phase modulation or amplitude modulation on the pulse train.

Further, the radar apparatus performs Doppler multiplexing transmission, for example. In addition, in the Doppler multiplexing transmission, the radar apparatus multiplexes and transmits signals by encoding (for example, performing code division multiplexing (CDM) on) the signals to which different phase rotations (for example, phase shifts), the number of which corresponds to the number of Doppler multiplexing, are applied, (hereinafter, such signals are referred to as “Doppler multiplexed transmission signals”) (hereinafter, such multiplexing is referred to as “Coded Doppler Multiplexing”).

### [Configuration of Radar Apparatus]

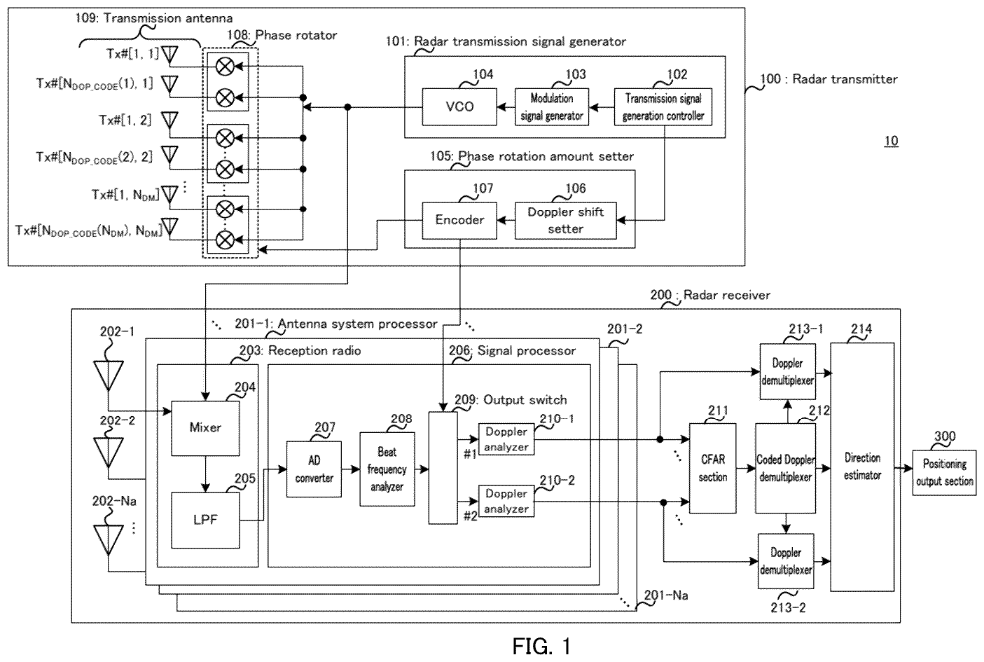

Radar apparatus 10 in FIG. 1 includes radar transmitter (transmission branch) 100, radar receiver (reception branch) 200, and positioning output section 300.

Radar transmitter 100 generates radar signals (radar transmission signals) and transmits the radar transmission signals in a defined transmission period (hereinafter, referred to as “radar transmission period”) using a transmission array antenna composed of a plurality of transmission antennas 109 (for example, Nt transmission antennas).

Radar receiver 200 receives reflected wave signals, which are radar transmission signals reflected by a target object (target) (not illustrated), using a reception array antenna composed of a plurality of reception antennas 202-1 to 202-Na. Radar receiver 200 performs signal processing on the reflected wave signals received at reception antennas 202 to, for example, detect the presence or absence of the target object, or estimate the distances through which the reflected wave signals arrive, the Doppler frequencies (for example, the relative velocities), and the directions of arrival, and outputs information on an estimation result (for example, positioning information).

Positioning output section 300 performs positioning output processing based on the information on the estimation result of the direction of arrival inputted from radar receiver 200.

Note that, radar apparatus 10 may be mounted, for example, on a mobile body such as a vehicle, and a positioning output of positioning output section 300 (e.g., information on the estimation result) may, for example, be connected to an Electronic Control Unit (ECU) (not illustrated) such as an Advanced Driver Assistance System (ADAS) or an autonomous driving system for enhancing the collision safety and utilized for a vehicle drive control or alarm call control.

Radar apparatus 10 may also be mounted on a relatively high-altitude structure (not illustrated), such as, for example, a roadside utility pole or traffic lights. Radar apparatus 10 may also be utilized, for example, as a sensor of a support system for enhancing the safety of passing vehicles or pedestrians, or as a sensor of a suspicious intrusion prevention system (not illustrated). The positioning output of radar receiver 200 may also be connected, for example, to a control device (not illustrated) in the support system or the suspicious intrusion prevention system for enhancing safety and may be utilized for an alarm call control or an abnormality detection control. The use of radar apparatus 10 is not limited to the above, and may also be used for other uses.

In addition, the target object is an object to be detected by radar apparatus 10. Examples of the target object include vehicles (including four-wheel and two-wheel vehicles), a person, and a block or a curb.

### [Configuration of Radar Transmitter 100]

Radar transmitter 100 includes radar transmission signal generator 101, phase rotation amount setter 105, phase rotators 108, and transmission antennas 109.

Radar transmission signal generator 101 generates a radar transmission signal. Radar transmission signal generator 101 includes, for example, transmission signal generation controller 102, modulation signal generator 103, and Voltage Controlled Oscillator (VCO) 104. Hereinafter, the components of radar transmission signal generator 101 will be described.

Transmission signal generation controller 102 configures, for example, a transmission signal generation timing for each radar transmission period, and outputs information on the configured transmission signal generation timing to modulation signal generator 103 and phase rotation amount setter 105 (e.g., Doppler shift setter 106). Here, the radar transmission period is represented by “Tr.”

Modulation signal generator 103 periodically generates, for example, saw-toothed modulation signals based on the information on the transmission signal generation timing for each radar transmission period Tᵣ inputted from transmission signal generation controller 102.

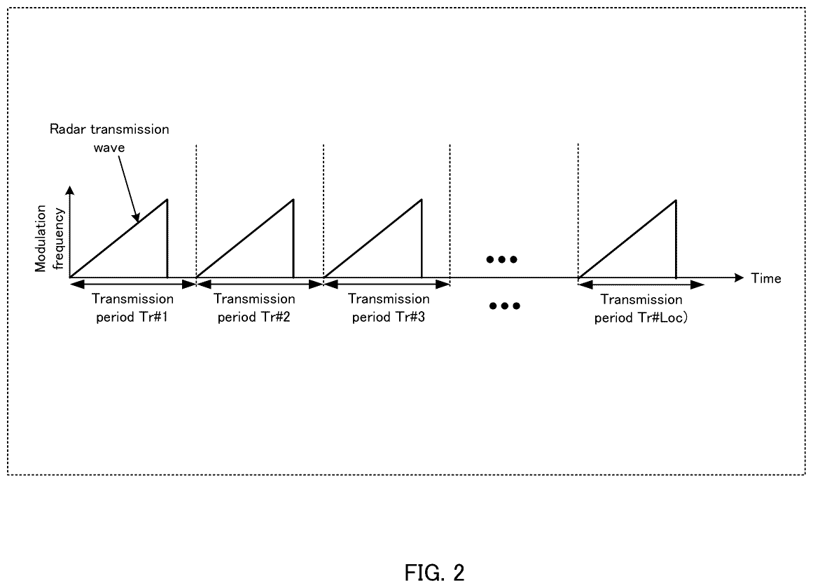

VCO 104 outputs, based on the modulation signals inputted from modulation signal generator 103, frequency-modulated signals (hereinafter referred to as, for example, frequency chirp signals or chirp signals) to phase rotators 108 and radar receiver 200 (mixer 204 described below) as the radar transmission signals (radar transmission waves) illustrated in FIG. 2.

Phase rotation amount setter 105 configures phase rotation amounts given (applied) to radar signals for each radar transmission period Tᵣ at phase rotators 108 (e.g., phase rotation amounts corresponding to the coded Doppler multiplexing transmission) based on the information on the transmission signal generation timing for each radar transmission period Tᵣ inputted from transmission signal generation controller 102. Phase rotation amount setter 105 includes, for example, Doppler shift setter 106 and encoder 107.

Doppler shift setter 106 configures phase rotation amounts that are given (applied) to the radar transmission signals (e.g., chirp signals) and that correspond to Doppler shift amounts, for example, based on the information on the transmission signal generation timing for each radar transmission period Tr.

Encoder 107 configures a phase rotation amount corresponding to coding, for example, based on the information on the transmission signal generation timing for each radar transmission period Tr. Encoder 107 calculates phase rotation amounts for phase rotators 108 based on, for example, the phase rotation amounts outputted from Doppler shift setter 106 and the phase rotation amount corresponding to coding, and outputs the phase rotation amounts to phase rotators 108. Further, encoder 107 outputs, for example, information on code sequences used for coding (for example, elements of orthogonal code sequences) to radar receiver 200 (for example, output switch 209).

The number of coded Doppler multiplexing for Doppler multiplexed signals that is configured by encoder 107 does not have to depend on the phase rotation amounts (Doppler shift amounts) of respective transmission antennas 109 configured by phase rotators 108. For example, even when phase rotators 108 configures the same phase rotation amount (Doppler shift amount) for a pair of adjacent transmission antennas 109, encoder 107 may configure the same number of coded Doppler multiplexing or may configure different values.

Phase rotators 108 apply the phase rotation amounts inputted from encoder 107 to the chirp signals inputted from VCO 104 and outputs the signals subjected to phase rotation to transmission antennas 109. For example, each of phase rotators 108 includes a phase shifter, a phase modulator, and the like (not illustrated).

The output signals of phase rotators 108 are amplified to a defined transmission power and are radiated respectively from transmission antennas 109 to space. For example, radar transmission signals are multiplexed by application of the phase rotation amounts corresponding to the Doppler shift amounts and the orthogonal code sequences and are transmitted from a plurality of transmission antennas 109.

Next, an exemplary configuration method for phase rotation amount setter 105 to configure the phase rotation amounts will be described.

Doppler shift setter 106 configures phase rotation amount φ_{ndm} for applying Doppler shift amount DOP_{ndm} and outputs phase rotation amount φ_{ndm} to encoder 107. Here, ndm=1 to N_{DM}. N_{DM} denotes the configured number of different Doppler shift amounts and is hereinafter referred to as the “number of Doppler multiplexing.”

In radar apparatus 10, since coding performed by encoder 107 is used for some purposes, number N_{DM} of Doppler multiplexing may be set smaller than number Nt of transmission antennas 109 used for multiplexing transmission. Note that, number N_{DM} of Doppler multiplexing is greater than or equal to 2.

Doppler shift amounts at equal intervals, or Doppler shift amounts at unequal intervals may, for example, be configured as Doppler shift amounts DOP₁, DOP₂, . . . , and DOP_{N_DM} (“N_DM” is also represented as “N_{DM}”). Doppler shift amounts DOP₁, DOP₂, . . . , and DOP_{N_DM} may be configured to satisfy, for example, 0≤DOP₁, DOP₂, . . . , DOP_{N_DM} (1/TrL_{oc}) since the coding by encoder 107 described later is used for some purposes. Alternatively, Doppler shift amounts DOP₁, DOP₂, . . . , and DOP_{N_DM}, for example, may be configured to satisfy Expression 1:

$$\begin{matrix}[ 1 ] & \\ \frac{- 1}{2 {T}_{r} {L}_{o c}} \leq D O {P}_{1} , {DOP}_{2} , … , {DOP}_{N \_ DM} < \frac{1}{2 {T}_{r} {L}_{o c}} . & ( Expression 1 )\end{matrix}$$

Further, for example, minimum Doppler shift interval Δf_{MinInterval} between Doppler shift amounts DOP₁, DOP₂, . . . , and DOP_{N_DM} may satisfy following Expression 2. Note that, the Doppler shift interval may be defined as an absolute value of a difference between any two of Doppler shift amounts DOP₁, DOP₂, . . . , and DOP_{N_DM}. Here, Loc represents the number of code elements. For example, Loc represents the code length of a code used in encoder 107. In the following, by way of example, Loc=2 is used (the example will be described later).

$$\begin{matrix}[ 2 ] & \\ 0 < Δ {f}_{MinInterval} \leq \frac{1}{{T}_{r} {N}_{D M} {L}_{o c}} . & ( Expression 2 )\end{matrix}$$

Further, phase rotation amounts φ_{ndm} for applying Doppler shift amounts DOP₁, DOP₂, . . . , and DOP_{N_DM} may, for example, be assigned as given by following Expression 3:

$$\begin{matrix}[ 3 ] & \\ {ϕ}_{n d m} = 2 π {DOP}_{n d m} / ( \frac{1}{{T}_{r} {L}_{o c}} ) . & ( Expression 3 )\end{matrix}$$

Note that, when the Doppler shift amounts at the equal interval of Δf_{MinInterval} are configured (hereinafter, such Doppler shift amounts are referred to as “equal-interval Doppler shift amount configuration”), phase rotation amounts φ_{ndm} for applying Doppler shift amounts DOP_{ndm} are assigned, for example, as given by following Expression 4:

$$\begin{matrix}[ 4 ] & \\ {ϕ}_{n d m} = 2 π ( n d m - 1 ) Δ {f}_{MinInterval} / ( \frac{1}{{T}_{r} {L}_{o c}} ) . & ( Expression 4 )\end{matrix}$$

Note that, as minimum Doppler shift interval Δf_{MinInterval} is made narrower, the interference between Doppler multiplexed signals is more likely to occur, and the target detection accuracy is more likely to be reduced (e.g., degraded). Thus, it is preferable that the intervals between the Doppler shift amounts be widened as much as possible within the range satisfying the constraints of Expression 2. For example, when the equal sign holds true in Expression 2 (e.g., Δf_{MinInteval}=1/(TᵣN_{DM}L_{OC})), the intervals between the Doppler multiplexed signals in the Doppler domain can be maximized (hereinafter, referred to as “maximum equal-interval Doppler shift amount configuration”). In this case, a phase rotation range greater than or equal to 0 and less than 2π are equally divided into N_{DM} sub-ranges, and Doppler shift amounts DOP₁, DOP₂, . . . , and DOP_{N_DM} are assigned respective different phase rotation amounts. For example, phase rotation amount φ_{ndm} for applying Doppler shift amount DOP_{ndm} is assigned as given by following Expression 5. Note that, in the following, the angle is expressed in radian.

$$\begin{matrix}[ 5 ] & \\ {ϕ}_{n d m} = \frac{2 π ( n d m - 1 )}{{N}_{D M}} & ( Expression 5 )\end{matrix}$$

In Expression 5, for example, when number N_{DM} of Doppler multiplexing is 2, phase rotation amount φ₁ for applying Doppler shift amount DOP₁ is 0, and phase rotation amount φ₂ for applying Doppler shift amount DOP₂ is π. Likewise, in Expression 5, for example, when number N_{DM} of Doppler multiplexing is 4, phase rotation amount φ₁ for applying Doppler shift amount DOP₁ is 0, phase rotation amount φ₂ for applying Doppler shift amount DOP₂ is π/2, phase rotation amount φ₃ for applying Doppler shift amount DOP₃ is π, and phase rotation amount φ₄ for applying Doppler shift amount DOP₄ is 3π/2. For example, intervals between phase rotation amounts φ_{ndm} for applying Doppler shift amounts DOP_{ndm} are equal intervals.

Note that, the assignment of the phase rotation amounts for applying Doppler shift amounts DOP₁, DOP₂, . . . , and DOP_{N_DM} is not limited to this assignment method. For example, the assignment of the phase rotation amounts given by Expression 5 may be shifted. For example, the phase rotation amounts may be assigned such that φ_{ndm}=2π(ndm)/N_{DM}. Alternatively, phase rotation amounts φ₁, φ₂, . . . , and φ_{N_DM} may be randomly assigned for Doppler shift amounts DOP₁, DOP₂, . . . , and DOP_{NDM} (where “N_DM” corresponds to N_{DM}) using an assignment table of the phase rotation amounts.

In addition, in the equal-interval Doppler shift amount configuration, when the denominator of phase rotation amount φ_{ndm} given by Expression 4 is set to an integer and the phase rotation amounts are set to integer values in units of Degree, it becomes easier to configure the phase rotation amounts. For example, by setting Δf_{MinInterval}=1/Tᵣ(N_{DM}+Nᵢₙₜ)L_{OC}, the denominator of phase rotation amount φ_{ndm} given by Expression 4 is set to an integer value as given by following Expression 6. Further, when Nᵢₙₜ is configured such that the value of the denominator (N_{DM}+Nᵢₙₜ) in Expression 6 is a divisor of 360, the phase rotation amount is set to an integer value, and it becomes easier to configure the phase rotation amounts.

$$\begin{matrix}[ 6 ] & \\ {ϕ}_{n d m} = \frac{2 π ( n d m - 1 )}{{N}_{D M} + {N}_{int}} & ( Expression 6 )\end{matrix}$$

Here, Nᵢₙₜ takes an integer value greater than or equal to 0. For example, when Nᵢₙₜ=1 is configured in the case of N_{DM}=7, φ_{ndm}=2π(ndm−1)/(N_{DM}+Nᵢₙₜ)=π(ndm−1)/4 holds. Accordingly, φ₁, φ₂, . . . , and φ_{N_DM} are integer values in units of Degree such as 0°, 45°, 90°, 135°, . . . , and 270°, respectively, and it becomes easier to configure the phase rotation amounts.

Note that, when Nᵢₙₜ=0 in Expression 6, the maximum equal-interval Doppler shift amount configuration is used.

Regarding phase rotation amounts φ₁, . . . , and φ_{N_DM} for applying N_{DM} Doppler shift amounts inputted from Doppler shift setter 106, encoder 107 configures the phase rotation amounts based on one or a plurality (equal to or less than N_{CM}) of orthogonal code sequences. Further, encoder 107 configures the phase rotation amounts based on both the Doppler shift amounts and the orthogonal code sequences, for example, the “coded Doppler phase rotation amounts” for generating coded Doppler multiplexed signals, and outputs the coded Doppler phase rotation amounts to phase rotators 108.

An example of the operation of encoder 107 will be described below.

For example, encoder 107 uses orthogonal code sequences with number N_{CM} of codes (for example, the number of code multiplexing) and with code length Loc.

In the following, N_{CM} orthogonal code sequences with code length Loc are denoted as Code_{ncm}={OC_{ncm}(1), OC_{ncm}(2), . . . , OC_{ncm}(Loc)}. OC_{ncm}(noc) represents the nocth code element in ncmth orthogonal code sequence Code_{ncm}. Here, noc denotes the index of a code element, and noc=1, . . . , Loc.

In the present embodiment, for example, an orthogonal code sequence having a code length Loc of 2 and having number N_{CM} (=2) of condes (for example, the number of code multiplexing) may be used. For example, Code₁={OC₁(1), OC₁(2)} and Code₂={OC₂(1), OC₂(2)} may be used as orthogonal code sequences having a code length Loc of 2 and N_{CM} of 2. Each of the code elements takes a real number or a complex value. Also, for example, with reference to nocth code element OC₁(noc) in the first code, nocth code element OC₂(noc) in the second code having a phase different by +90° in the case of noc=1 and by −90° in the case of noc=2 may be used. Alternatively, a code element whose phase is different by −90° in the case of noc=1 and by +90° in the case of noc=2 may be used.

For example, as an orthogonal code sequence of N_{CM}=2 having code length Loc=2, Code₁={1, 1} and Code₂={j, −j} are codes that satisfy the above-described relationship (or conditions), and these codes are codes that are orthogonal to each other. Examples of the codes satisfying the above-described conditions include {1, 1} and {−j, j}. Further, another example of the codes satisfying the above-described conditions is {1, j} and {j, 1}. Here, j is an imaginary unit (j²=−1).

When the orthogonal code sequence used in the present embodiment is generally expressed, the second code may be expressed as Code₂={j×A, −j×B} or Code₂={−j×A, j×B} with respect to the first code Code₁={A, B}. These codes are orthogonally related to each other, and, with reference to nocth code element OC₁(noc) in the first code, nocth code element OC₂(noc) in the second code is a code element having a phase different by +900 in the case of noc=1 and by −90° in the case of noc=2, or a phase different by −90° in the case of noc=1 and by +90° in the case of noc=2. Here, A and B are a real number or a complex number, and the absolute values of A and B are equal, and for example, |A|=|B| holds true.

Here, with reference to nocth code element OC₁(noc) in the first code, nocth code element OC₂(noc) in the second code is a code element having a phase different by +90° in the case of noc=1 and by −90° in the case of noc=2, or a phase different by −90° in the case of noc=1 and by +90° in the case of noc=2, but the phase difference is not limited to a phase difference of ±90°.

For example, a phase difference of ±ξ may be added to nocth code elements in the first code and the second code. ξ may be in the range of π/6 to 5π/6 radians (=30° to 150°). For example, in a case where the phase deviation between transmission antennas 109 is corrected in advance, a circularly polarized wave in which a main beam direction of a transmission beam is changed in dependence on “ξ” is generated in the course of beam transmission described later. For example, in a case where the transmission antenna spacing for beam transmission is λ/2 and ξ=90°, a circularly polarized wave in which the main beam direction is the front 0° direction is generated. In addition, for example, in the case of ξ=30°, the circularly polarized wave is generated in which the main beam direction is shifted by about −15° from the front direction. In addition, for example, in the case of ξ=150°, the circularly polarized wave is generated in which the main beam direction is shifted by about +150 from the front direction. Here, λ is the wavelength of a high-frequency signal output from transmission antenna 109 (in the case of using a chirp signal, the wavelength at the center frequency of the chirp signal).

For example, in a case where the main-beam direction may be a direction different from the front direction (or a case where an angle having a preferable axial ratio as a circularly polarized wave is the front direction), nocth code element OC₂(noc) in the second code may be a code element having a phase different by +ξ in the case of noc=1 and by −ξ in the case of noc=2 or a phase different by −ξ in the case of noc=1 and by +ξ in the case of noc=2 with reference to nocth code element OC₁(noc) in the first code. Here, for example, it is possible to use a range of π/6 to 5π/6 radians (=300 to 150°) for ξ.

When such an orthogonal code sequence is generally expressed, the second code may be expressed as Code₂={exp(jξ)×A, −exp(jξ)×B} or Code₂={−exp(jξ)×A, exp(jξ)×B} with respect to the first code Code₁={A, B}. These codes are orthogonally related to each other, and, with reference to nocth code element OC₁(noc) in the first code, nocth code element OC₂(noc) in the second code is a code element having a radian phase different by +ξ in the case of noc=1 and by −ξ in the case of noc=2, or a radian phase different by −ξ in the case of noc=1 and by +ξ in the case of noc=2. Here, A and B are a real number or a complex number, and the absolute values of A and B are equal, and for example, |A|=|B| holds true.

The following explanation describes an example in which Code₁={1, 1} and Code₂={j, −j} is mainly used, but the present disclosure is not limited thereto. Code₁={A, B} and Code₂={j×A, −j×B} or Code₂={−j×A, j×B} or Code₁={A, B} and Code₂={exp(jξ)×A, −exp(jξ)×B} or Code₂={−exp(jξ)×A, exp(jξ)×B} may be used, and the same effect can be obtained.

Further, in Variation 1 and Variation 2 of Embodiment 1 to be described later in addition to the present embodiment, an example in which Code₁={1, 1} and Code₂={j, −j} are mainly used is described, but the present disclosure is not limited thereto. Code₁={A, B} and Code₂={j×A, −j×B} or Code₂={−j×A, j×B} or Code₁={A, B} and Code₂={exp(jξ)×A, −exp(jξ)×B} or Code₂={−exp(jξ)×A, exp(jξ)×B} may be used, and the same effects can be obtained. Here, for example, it is possible to use a range of π/6 to 5π/6 radians (=30° to 150°) for ξ.

In encoder 107, the number of code multiplexing (hereinafter referred to as the number of coded Doppler multiplexing) for encoding a Doppler multiplexed signal using ndmth Doppler shift amount DOP_{ndm} inputted from Doppler shift setter 106 is represented by “N_{DOP_CODE}(ndm).” Here, ndm=1 to N_{DM}.

Encoder 107 configures number N_{DOP_CODE}(N_{DM}) of coded Doppler multiplexing such that, for example, the sum of numbers N_{DOP_CODE}(1), N_{DOP_CODE}(2), . . . , and N_{DOP_CODE}(N_{DM}) of coded Doppler multiplexing for encoding Doppler multiplexed signals is equal to number Nt of transmission antennas 109 used for multiplexing transmission. For example, encoder 107 configures number N_{DOP_CODE}(ndm) of coded Doppler multiplexing so as to satisfy following Expression 7. This allows radar apparatus 10 to perform multiplexing transmission in the Doppler domain and in the code domain (hereinafter referred to as the coded Doppler multiplexing transmission) using Nt transmission antennas 109.

$$\begin{matrix}[ 7 ] & \\ {\sum }_{ndm = 1}^{{N}_{D M}} {N}_{DOP \_ CODE} ( n d m ) = N t & ( Expression 7 )\end{matrix}$$

Further, encoder 107 may configure numbers N_{DOP_CODE}(1), N_{DOP_CODE}(2), . . . , and N_{DOP_CODE}(N_{DM}) of coded Doppler multiplexing, for example, using the equal-interval Doppler shift amount configuration including the maximum equal-interval Doppler shift amount configuration, such that different numbers of coded Doppler multiplexing ranging from 1 through N_{CM} are included. For example, encoder 107 does not use number N_{CM} of codes for all the numbers of coded Doppler multiplexing, but configures number N_{DOP_CODE}(ndm) of coded Doppler multiplexing corresponding to at least one Doppler shift amount DOP_{ndm} such that this number of coded Doppler multiplexing is smaller than N_{CM}. Accordingly, among a plurality of combinations of the Doppler shift amounts DOP_{ndm} and the orthogonal code sequences, number N_{DOP_CODE}(ndm) of multiplexing (number of coded Doppler multiplexing) by the orthogonal code sequences which is associated with at least one Doppler shift amount DOP_{ndm} may differ from the numbers of coded Doppler multiplexing associated with the other Doppler shift amounts. For example, encoder 107 configures non-uniform numbers of coded Doppler multiplexing for the Doppler multiplexed signal. With this configuration, radar apparatus 10 can individually separate and receive the coded Doppler multiplexed signals transmitted from a plurality of transmission antennas 109 over a Doppler range of ±½Tr, for example, by aliasing judgement processing in reception processing described later.

Alternatively, encoder 107 may configure numbers N_{DOP_CODE}(1), N_{DOP_CODE}(2), . . . , and N_{DOP_CODE}(N_{DM}) of coded Doppler multiplexing, for example, using the equal-interval Doppler shift amount configuration of intervals narrower than the intervals of the maximum equal-interval Doppler shift amount configuration, such that the same number of coded Doppler multiplexing in the range of from 1 through N_{CM} is included. For example, encoder 107 may configure number N_{CM} of codes for all the numbers of coded Doppler multiplexing. Accordingly, among a plurality of combinations of Doppler shift amounts DOP_{ndm} and the orthogonal code sequences, numbers N_{DOP_CODE}(ndm) of multiplexing (number of coded Doppler multiplexing) by the orthogonal code sequences which are associated with Doppler shift amounts DOP_{ndm} may be the same. For example, encoder 107 configures the numbers of coded Doppler multiplexing for the Doppler multiplexed signals uniformly. With this configuration, radar apparatus 10 can individually separate and receive the coded Doppler multiplexed signals transmitted from a plurality of transmission antennas 109 over a Doppler range of ±1/(2×Loc×Tr), for example, by aliasing judgement processing in reception processing described later.

Alternatively, encoder 107 may configure numbers N_{DOP_CODE}(1), N_{DOP_CODE}(2), . . . , and N_{DOP_CODE}(N_{DM}) of coded Doppler multiplexing, for example, using the maximum equal-interval Doppler shift amount configuration such that the same number of coded Doppler multiplexing in the range of from 1 through N_{CM} is included. For example, encoder 107 may configure number N_{CM} of codes for all the numbers of coded Doppler multiplexing. For example, encoder 107 configures the numbers of coded Doppler multiplexing for the Doppler multiplexed signals uniformly. In the case of this configuration, for example, the aliasing judgement processing in the reception processing described below is not applied. In addition, radar apparatus 10 can individually separate and receive the coded Doppler multiplexed signals transmitted from a plurality of transmission antennas 109 over a Doppler range of ±1/(2Loc×N_{DM}×Tr), for example.

With respect to phase rotation amount φ_{ndm} for applying ndmth Doppler shift amount DOP_{ndm}, encoder 107 configures coded Doppler phase rotation amount ψndop_code(ndm), ndm(m) for mth transmission period Tr that is given by following Expression 8, and outputs coded Doppler phase rotation amount ψ_{ndop_code(ndm), ndm}(m) to phase rotator 108:

$$\begin{matrix}[ 8 ] & \\ {ψ}_{ndop \_ code ( n d m ) , n d m} ( m ) = floor [ \frac{( m - 1 )}{L o c} ] \times {ϕ}_{n d m} + angle [ {OC}_{ndop \_ code ( n d m )} ( OC\_INDEX ) ] & ( Expression 8 )\end{matrix}$$

Here, the subscript “ndop_code(ndm)” represents an index less than or equal to number N_{DOP_CODE}(ndm) of coded Doppler multiplexing for phase rotation amount φ_{ndm} for applying Doppler shift amount DOP_{ndm}. For example, ndop_code(ndm)=1, . . . , N_{DOP_CODE}(ndm). Here, angle[x] is an operator outputting the radian phase of real number x, and for example, angle[1]=0, angle[−1]=π, angle[j]=π/2, and angle[−j]=−π/2. In addition, floor[x] is an operator that outputs the largest integer that does not exceed real number x. The character “j” is an imaginary unit.

For example, as given by Expression 8, coded Doppler phase rotation amount ω_{ndop_code(ndm), ndm}(m) provides a constant phase rotation amount for applying Doppler shift amount DOP_{ndm} (for example, the first term in Expression 8) in the duration of Loc transmission periods (“Loc” is the code length used for coding), and applies a phase rotation amount corresponding to each of Loc code elements OC_{ndop_code(ndm)}(1), . . . , and OC_{ndop_code(ndm)}(Loc) of code Code_{ndop_code}(ndm) used for coding (the second term in Expression 8).

Further, encoder 107 outputs, in each transmission period (Tr), orthogonal code element index OC_INDEX to radar receiver 200 (output switch 209 described below). OC_INDEX represents an orthogonal code element index indicating an element of orthogonal code sequence Code_{ndop_code}(ndm), and cyclically varies in the range of from 1 to Loc in each transmission period (Tr), as given by following Expression 9:

$$\begin{matrix}[ 9 ] & \\ OC\_INDEX = mod ( M - 1 , Loc ) + 1. & ( Expression 9 )\end{matrix}$$

Here, mod(x, y) denotes a modulo operator and is a function that outputs the remainder after x is divided by y. Further, m=1, . . . , Nc. Nc denotes the number of transmission periods used for radar positioning (hereinafter referred to as “radar-transmission-signal transmission times”). In addition, radar-transmission-signal transmission times Nc is set to an integer multiple of Loc (by a factor of Ncode). For example, Nc=Loc×Ncode.

Next, an example method by encoder 107 for configuring numbers N_{DOP_CODE}(ndm) of coded Doppler multiplexing for Doppler multiplexed signals non-uniformly will be described.

For example, encoder 107 configures number N_{CM} of orthogonal code sequences (in other words, the number of code multiplexing or the number of codes) satisfying the condition below. For example, number N_{CM} of orthogonal code sequences and number N_{DM} of Doppler multiplexing satisfy the following relationship for number Nt of transmission antennas 109 used for multiplexing transmission:

(Number N_{CM} of orthogonal code sequences)×(Number N_{DM} of Doppler multiplexing)>Number Nt of transmission antennas used for multiplexing transmission.

For example, among numbers N_{CM} of orthogonal code sequences and numbers N_{DM} of Doppler multiplexing satisfying the above-described condition, the use of a combination yielding a smaller product (N_{CM}×N_{DM}) is desirable in terms of both characteristics and complexity of circuit configuration. Note that among numbers N_{CM} of orthogonal code sequences and numbers N_{DM} of Doppler multiplexing satisfying the above-described condition, a combination having a smaller value of the product (N_{CM}×N_{DM}) is not limitative, and any other combination may be applied.

Note that, in the present embodiment, an orthogonal code sequence having a number of codes (for example, number of code multiplexing) N_{CM} of 2 that have a code length Loc of 2 is used.

For example, in a case where Nt=5, the combination of N_{DM}=3 and N_{CM}=2 is desirable.

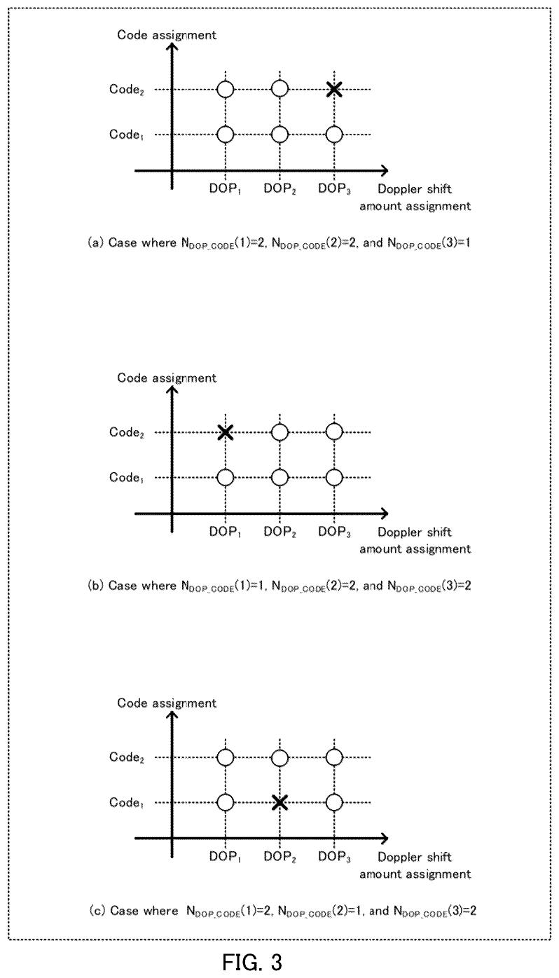

By way of example, FIG. 3 illustrate a case where Nt=5, N_{DM}=3, and N_{CM}=2. For example, the assignment of Doppler shift amounts DOP₁, DOP₂, and DOP₃ and orthogonal codes Code₁ and Code₂ is determined in accordance with the configuration of N_{DOP_CODE}(1), N_{DOP_CODE}(2), and N_{DOP_CODE}(3) as illustrated in FIG. 3.

For example, (a) in FIG. 3 illustrates an example where N_{DOP_CODE}(1)=2, N_{DOP_CODE}(2)=2, and N_{DOP_CODE}(3)=1, (b) in FIG. 3 illustrates an example where N_{DOP_CODE}(1)=1, N_{DOP_CODE}(2)=2, and N_{DOP_CODE}(3)=2, and (c) in FIG. 3 illustrates an example where N_{DOP_CODE}(1)=2, N_{DOP_CODE}(2)=1, and N_{DOP_CODE}(3)=2.

Note that, in (a) and (b) of FIG. 3, Code₁ is used for the Doppler shift amounts corresponding to number N_{DOP_CODE}(ndm)=1 of coded Doppler multiplexing, but the present disclosure is not limited thereto. For example, when the number of coded Doppler multiplexing is set to be smaller than N_{CM}, Code₂ may be used instead of Code₁ as illustrated in (c) of FIG. 3.

As illustrated in (a) of FIG. 3, N_{DOP_CODE}(1)=N_{DOP_CODE}(2)=2 and N_{DOP_CODE}(3)=1, that is, N_{DOP_CODE}(1)=N_{DOP_CODE}(2)≠N_{DOP_CODE}(3), in which number N_{DOP_CODE} Of coded Doppler multiplexing is configured in a non-uniform manner for each of Doppler shift amounts DOP₁, DOP₂, and DOP₃. In such configurations, the Doppler frequency range can be equivalent to, for example, the maximum Doppler velocity at the time of single-antenna transmission (the details will be described below).

Further, for example, in a case where Nt=6 or 7, the combination of N_{DM}=4 and N_{CM}=2 is desirable.

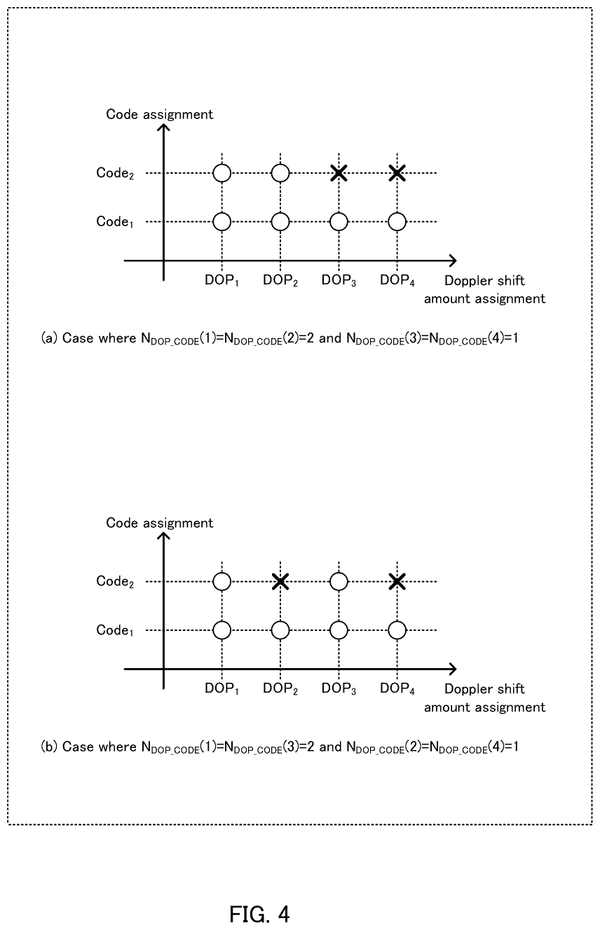

By way of example, FIG. 4 illustrates a case where Nt=6, N_{DM}=4, and N_{CM}=2. For example, the assignment of Doppler shift amounts DOP₁, DOP₂, DOP₃, and DOP₄ and orthogonal codes Code₁ and Code₂ is determined in accordance with the configuration of N_{DOP_CODE}(1), N_{DOP_CODE}(2), N_{DOP_CODE}(3), and N_{DOP_CODE}(4) as illustrated in FIG. 4.

For example, (a) in FIG. 4 illustrates an example where N_{DOP_CODE}(1)=N_{DOP_CODE}(2)=2 and N_{DOP_CODE}(3)=N_{DOP_CODE}(4)=1, and (b) in FIG. 4 illustrates an example where N_{DOP_CODE}(1)=N_{DOP_CODE}(3)=2 and N_{DOP_CODE}(2)=N_{DOP_CODE}(4)=1.

Note that, in FIG. 4, Code₁ is used for the Doppler shift amounts corresponding to number N_{DOP_CODE}(ndm)=1 of coded Doppler multiplexing, but the present disclosure is not limited thereto. For example, for configurations in which the numbers of coded Doppler multiplexing are each smaller than N_{CM}, Code₂ may be used in place of Code₁ as illustrated in at (a) in FIG. 4, or both Code₁ and Code₂ may be used as illustrated at (b) in FIG. 4.

Further, for example, as illustrated in FIG. 4, in a case where Nt=6, N_{DM}=4, and N_{CM}=2, there are two Doppler shift amounts that do not use all the codes. Further, for example, in the case of N_{DM}=4, in respect of the combinations of Doppler shift amounts that do not use all the codes, there are six combinations (=₄C₂) of two Doppler shift amounts selected from four Doppler shift amounts, and in each of the six combinations, there are four combinations (=N_{CM}×N_{CM}) of codes used. Accordingly, in a case where Nt=6, N_{DM}=4, and N_{CM}=2, there is a total of 24 combinations of Doppler shift amounts DOP and orthogonal codes Code assigned.

Likewise, for example, in a below case where Nt=8, the combination of N_{DM}=5 and N_{CM}=2 is desirable. For example, in a case where Nt=9, the combination of N_{DM}=5 and N_{CM}=2 is desirable. For example, in a case where Nt=10, the combination of N_{DM}=6 and N_{CM}=2 is desirable. Note that, number Nt of transmission antennas 109 is not limited to that in the examples described above, and an exemplary embodiment of the present disclosure is also applicable in the case where Nt=11 or more.

Next, an example method by encoder 107 for configuring numbers N_{DOP_CODE}(ndm) of coded Doppler multiplexing uniformly for Doppler multiplexed signals will be described.

Note that, for the method by encoder 107 for configuring numbers N_{DOP_CODE}(ndm) of coded Doppler multiplexing uniformly for Doppler multiplexed signals, the use of a combination having a smaller product (N_{CM}×N_{DM}) from among numbers N_{CM} of orthogonal code sequences and numbers N_{DM} of Doppler multiplexing satisfying the following condition is desirable in terms of both characteristics and complexity of circuit configuration. However, the present disclosure is not limited to the combination having a smaller value of the product (N_{CM}×N_{DM}), but other combinations may also be applicable.

For example, encoder 107 configures number N_{CM} of orthogonal code sequences (e.g., the number of code multiplexing or the number of codes) satisfying the condition below. For example, number N_{CM} of orthogonal code sequences and number N_{DM} of Doppler multiplexing satisfy the following relationship for number Nt of transmission antennas 109 used for multiplexing transmission:

(Number N_{CM} of orthogonal code sequences)×(Number N_{DM} of Doppler multiplexing)=Number Nt of transmission antennas used for multiplexing transmission.

For example, in a case where Nt=4, the combination of N_{DM}=2 and N_{CM}=2 is desirable. For example, in a case where Nt=6, the combination of N_{DM}=3 and N_{CM}=2 is desirable. For example, in a case where Nt=8, the combination of N_{DM}=4 and N_{CM}=2 is desirable. For example, in a case where Nt=10, the combination of N_{DM}=5 and N_{CM}=2 is desirable. For example, in a case where Nt=12, the combination of N_{DM}=6 and N_{CM}=2 is desirable.

Note that, number Nt of transmission antennas 109 is not limited to those in the examples described above, and the exemplary embodiment of the present disclosure is applicable to other numbers. In this case, in order to satisfy the combination of integers satisfying number N_{CM} of orthogonal code sequences>1 and number N_{DM} of Doppler multiplexing >1, and to satisfy (number N_{CM} of orthogonal code sequences)×(number N_{DM} of Doppler multiplexing)=number Nt of transmission antennas used for multiplexing transmission, number Nt of transmission antennas used for multiplexing transmission may be set to 4 or more, and to satisfy the above condition.

Next, a configuration example of coded Doppler phase rotation amount ψ_{ndop_code(ndm), ndm}(m) will be described.

For example, a description will be given of a case where in encoder 107, number Nt of transmission antennas used for multiplexing transmission is 4, number N_{DM} of Doppler multiplexing is 2, and number N_{CM} of code multiplexing is 2, and orthogonal code sequences Code₁={1, 1} and Code₂={j, −j} with code length Loc=2 are used. In this case, for example, when numbers N_{DOP_CODE}(1) and N_{DOP_CODE}(2) of coded Doppler multiplexing are 2 and 2, encoder 107 configures coded Doppler phase rotation amounts ψ_{1, 1}(m), ψ_{2, 1}(m), ψ_{1, 2}(m), and ψ_{2, 2}(m) given by following Expressions 10 to 13 and outputs these coded Doppler phase rotation amounts to phase rotators 108:

$$\begin{matrix}[ 10 ] & \\ \{ {ψ}_{1 , 1} ( 1 ) , {ψ}_{1 , 1} ( 2 ) , {ψ}_{1 , 1} ( 3 ) , {ψ}_{1 , 1} ( 4 ) , {ψ}_{1 , 1} ( 5 ) , {ψ}_{1 , 1} ( 6 ) , {ψ}_{1 , 1} ( 7 ) , \\ {ψ}_{1 , 1} ( 8 ) , … \} = \{ 0 , 0 , {ϕ}_{1} , {ϕ}_{1} , 2 {ϕ}_{1} , 2 {ϕ}_{1} , 3 {ϕ}_{1} , 3 {ϕ}_{1} , … \} ; & ( Expression 10 )\end{matrix}$$

$$\begin{matrix}[ 11 ] & \\ \{ {ψ}_{2 , 1} ( 1 ) , {ψ}_{2 , 1} ( 2 ) , {ψ}_{2 , 1} ( 3 ) , {ψ}_{21} ( 4 ) , {ψ}_{2 , 1} ( 5 ) , \\ {ψ}_{2 , 1} ( 6 ) , {ψ}_{2 , 1} ( 7 ) , {ψ}_{2 , 1} ( 8 ) , … \} = \{ \frac{π}{2} , - \frac{π}{2} , {ϕ}_{1} + \frac{π}{2} , \\ {ϕ}_{1} - \frac{π}{2} , 2 {ϕ}_{1} + \frac{π}{2} , 2 {ϕ}_{1} - \frac{π}{2} , 3 {ϕ}_{1} + \frac{π}{2} , 3 {ϕ}_{1} - \frac{π}{2} , … \} ; & ( Expression 11 )\end{matrix}$$

$$\begin{matrix}[ 12 ] & \\ \{ {ψ}_{1 , 2} ( 1 ) , {ψ}_{1 , 2} ( 2 ) , {ψ}_{1 , 2} ( 3 ) , {ψ}_{1 , 2} ( 4 ) , {ψ}_{1 , 2} ( 5 ) , {ψ}_{1 , 2} ( 6 ) , {ψ}_{1 , 2} ( 7 ) , \\ {ψ}_{1 , 2} ( 8 ) , … \} = \{ 0 , 0 , {ϕ}_{2} , {ϕ}_{2} , 2 {ϕ}_{2} , 2 {ϕ}_{2} , 3 {ϕ}_{2} , 3 {ϕ}_{2} , … \} ; and & ( Expression 12 )\end{matrix}$$

$$\begin{matrix}[ 13 ] & \\ \{ {ψ}_{2 , 2} ( 1 ) , {ψ}_{2 , 2} ( 2 ) , {ψ}_{2 , 2} ( 3 ) , {ψ}_{2 , 2} ( 4 ) , {ψ}_{2 , 2} ( 5 ) , \\ {ψ}_{2 , 2} ( 6 ) , {ψ}_{2 , 2} ( 7 ) , {ψ}_{2 , 2} ( 8 ) , … \} = \{ \frac{π}{2} , - \frac{π}{2} , {ϕ}_{2} + \frac{π}{2} , \\ {ϕ}_{2} - \frac{π}{2} , 2 {ϕ}_{2} + \frac{π}{2} , 2 {ϕ}_{2} - \frac{π}{2} , 3 {ϕ}_{2} + \frac{π}{2} , 3 {ϕ}_{2} - \frac{π}{2} , … \} . & ( Expression 13 )\end{matrix}$$

Here, as an example, φ_{ndm}=2π(ndm−1)/N_{DM} in Expression 5 is used as the phase rotation amount for applying Doppler shift amount DOP_{ndm}, and phase rotation amount φ₁=0 for applying Doppler shift amount DOP₁ and phase rotation amount φ₂=π for applying Doppler shift amount DOP₂ are used. In this case, encoder 107 configures coded Doppler phase rotation amounts ψ_{1, 1}(m), ψ_{2, 1}(m), ψ_{1, 2}(m), and ψ_{2, 2}(m) given by following Expressions 14 to 17 and outputs these coded Doppler phase rotation amounts to phase rotators 108. Here, m=1, . . . , Nc. Here, a modulo operation for 2π is performed, and results are expressed in radians ranging from 0 to less than 2π (the same applies to the following description).

$$\begin{matrix}[ 14 ] & \\ \{ {ψ}_{1 , 1} ( 1 ) , {ψ}_{1 , 1} ( 2 ) , {ψ}_{1 , 1} ( 3 ) , {ψ}_{1 , 1} ( 4 ) , {ψ}_{1 , 1} ( 5 ) , \\ {ψ}_{1 , 1} ( 6 ) , {ψ}_{1 , 1} ( 7 ) , {ψ}_{1 , 1} ( 8 ) , … \} = \{ 0 , 0 , 0 , 0 , 0 , 0 , 0 , 0 , … \} ; & ( Expression 14 )\end{matrix}$$

$$\begin{matrix}[ 15 ] & \\ \{ {ψ}_{2 , 1} ( 1 ) , {ψ}_{2 , 1} ( 2 ) , {ψ}_{2 , 1} ( 3 ) , {ψ}_{2 , 1} ( 4 ) , {ψ}_{2 , 1} ( 5 ) , {ψ}_{2 , 1} ( 6 ) , {ψ}_{2 , 1} ( 7 ) , \\ {ψ}_{2 , 1} ( 8 ) , … \} = \{ \frac{π}{2} , - \frac{π}{2} , \frac{π}{2} , - \frac{π}{2} , \frac{π}{2} , - \frac{π}{2} , \frac{π}{2} , - \frac{π}{2} , … \} ; & ( Expression 15 )\end{matrix}$$

$$\begin{matrix}[ 16 ] & \\ \{ {ψ}_{1 , 2} ( 1 ) , {ψ}_{1 , 2} ( 2 ) , {ψ}_{1 , 2} ( 3 ) , {ψ}_{1 , 2} ( 4 ) , {ψ}_{1 , 2} ( 5 ) , {ψ}_{1 , 2} ( 6 ) , \\ {ψ}_{1 , 2} ( 7 ) , {ψ}_{1 , 2} ( 8 ) , … \} = \{ 0 , 0 , π , π , 0 , 0 , π , π , … \} ; and & ( Expression 16 )\end{matrix}$$

$$\begin{matrix}[ 17 ] & \\ \{ {ψ}_{2 , 2} ( 1 ) , {ψ}_{2 , 2} ( 2 ) , {ψ}_{2 , 2} ( 3 ) , {ψ}_{2 , 2} ( 4 ) , {ψ}_{2 , 2} ( 5 ) , {ψ}_{2 , 2} ( 6 ) , {ψ}_{2 , 2} ( 7 ) , \\ {ψ}_{2 , 2} ( 8 ) , … \} = \{ \frac{π}{2} , - \frac{π}{2} , \frac{3 π}{2} , \frac{π}{2} , \frac{π}{2} , - \frac{π}{2} , \frac{3 π}{2} , - \frac{π}{2} , … \} . & ( Expression 17 )\end{matrix}$$

As given by Expressions 14 to 17, when the phase rotation amounts are set to φ_{ndm}=2π(ndm−1)/N_{DM}, into which 2π is equally divided, coded Doppler phase rotation amounts ψ_{1, 1}(m), ψ_{2, 1}(m), ψ_{1, 2}(m), and ψ_{2, 2}(m) are changed in transmission periods given by N_{DM}×N_{CM}=2×2=4.

As another example, φ_{ndm}=2π(ndm)/N_{DM} may be used as the phase rotation amount for applying Doppler shift amount DOP_{ndm}, and phase rotation amount φ₁=π for applying Doppler shift amount DOP₁ and phase rotation amount φ₂=0 for applying Doppler shift amount DOP₂ may be configured. In this case, encoder 107 configures coded Doppler phase rotation amounts ψ_{1, 1}(m), ψ_{2, 1}(m), ψ_{1, 2}(m), and ψ_{2, 2}(m) as given by following Expressions 18 to 21 and outputs the coded Doppler phase rotation amounts to phase rotators 108. Here, m=1, . . . , N_{c}.

$$\begin{matrix}[ 18 ] & \\ \{ {ψ}_{1 , 1} ( 1 ) , {ψ}_{1 , 1} ( 2 ) , {ψ}_{1 , 1} ( 3 ) , {ψ}_{1 , 1} ( 4 ) , {ψ}_{1 , 1} ( 5 ) , {ψ}_{1 , 1} ( 6 ) , \\ {ψ}_{1 , 1} ( 7 ) , {ψ}_{1 , 1} ( 8 ) , … \} = \{ 0 , 0 , π , π , 0 , 0 , π , π , … \} ; & ( Expression 18 )\end{matrix}$$

$$\begin{matrix}[ 19 ] & \\ \{ {ψ}_{2 , 1} ( 1 ) , {ψ}_{2 , 1} ( 2 ) , {ψ}_{2 , 1} ( 3 ) , {ψ}_{2 , 1} ( 4 ) , {ψ}_{2 , 1} ( 5 ) , {ψ}_{2 , 1} ( 6 ) , {ψ}_{2 , 1} ( 7 ) , \\ {ψ}_{2 , 1} ( 8 ) , … \} = \{ \frac{π}{2} , - \frac{π}{2} , \frac{3 π}{2} , \frac{π}{2} , \frac{π}{2} , - \frac{π}{2} , \frac{3 π}{2} , - \frac{π}{2} , … \} ; & ( Expression 19 )\end{matrix}$$

$$\begin{matrix}[ 20 ] & \\ \{ {ψ}_{1 , 2} ( 1 ) , {ψ}_{1 , 2} ( 2 ) , {ψ}_{1 , 2} ( 3 ) , {ψ}_{1 , 2} ( 4 ) , {ψ}_{1 , 2} ( 5 ) , {ψ}_{1 , 2} ( 6 ) , \\ {ψ}_{1 , 2} ( 7 ) , {ψ}_{1 , 2} ( 8 ) , … \} = \{ 0 , 0 , 0 , 0 , 0 , 0 , 0 , 0 , … \} ; and & ( Expression 20 )\end{matrix}$$

$$\begin{matrix}[ 21 ] & \\ \{ {ψ}_{2 , 2} ( 1 ) , {ψ}_{2 , 2} ( 2 ) , {ψ}_{2 , 2} ( 3 ) , {ψ}_{2 , 2} ( 4 ) , {ψ}_{2 , 2} ( 5 ) , {ψ}_{2 , 2} ( 6 ) , {ψ}_{2 , 2} ( 7 ) , \\ {ψ}_{2 , 2} ( 8 ) , … \} = \{ \frac{π}{2} , - \frac{π}{2} , \frac{π}{2} , - \frac{π}{2} , \frac{π}{2} , - \frac{π}{2} , \frac{π}{2} , - \frac{π}{2} , … \} . & ( Expression 21 )\end{matrix}$$

As given by Expressions 14 to 17 or Expressions 18 to 21, the number of phases (for example, two phases of 0 and π) used for the phase rotation amounts (for example, the phase rotation amounts for applying the Doppler shift amounts) is smaller than number Nt=4 of transmission antennas 109 used for multiplexing transmission. For example, as given by Expressions 14 to 17 or Expressions 18 to 21, the number of phases (e.g., two phases of 0 and π) used for the phase rotation amounts for applying the Doppler shift amounts is equal to number N_{DM}=2 of Doppler shift amounts used for multiplexing transmission (e.g., the number of Doppler multiplexing).

In addition, for example, a description will be given of a case where in encoder 107, number Nt of transmission antennas used for multiplexing transmission is 6, number N_{DM} of Doppler multiplexing is 4, and number N_{CM} of code multiplexing is 2, and orthogonal code sequences Code₁={1, 1} and Code₂={j, −j} with code length Loc=2 are used. In this case, for example, if numbers N_{DOP_CODE}(1), N_{DOP_CODE} (2), N_{DOP_CODE} (3), and N_{DOP_CODE}(4) of coded Doppler multiplexing are 1, 1, 2, and 2, respectively, encoder 107 configures coded Doppler phase rotation amounts ψ_{1, 1}(m), ψ_{1, 2}(m), ψ_{1, 3}(m), ψ_{2, 3}(m), ψ_{1, 4}(m), and ψ_{2, 4}(m) given by following Expressions 22 to 27 and outputs the coded Doppler phase rotation amounts to phase rotators 108. Here, m=1, . . . , Nc.

$$\begin{matrix}[ 22 ] & \\ \{ {ψ}_{1 , 1} ( 1 ) , {ψ}_{1 , 1} ( 2 ) , {ψ}_{1 , 1} ( 3 ) , {ψ}_{1 , 1} ( 4 ) , {ψ}_{1 , 1} ( 5 ) , {ψ}_{1 , 1} ( 6 ) , {ψ}_{1 , 1} ( 7 ) , \\ {ψ}_{1 , 1} ( 8 ) , … \} = \{ 0 , 0 , {ϕ}_{1} , {ϕ}_{1} , 2 {ϕ}_{1} , 2 {ϕ}_{1} , 3 {ϕ}_{1} , 3 {ϕ}_{1} , … \} ; & ( Expression 22 )\end{matrix}$$

$$\begin{matrix}[ 23 ] & \\ \{ {ψ}_{1 , 2} ( 1 ) , {ψ}_{1 , 2} ( 2 ) , {ψ}_{1 , 2} ( 3 ) , {ψ}_{1 , 2} ( 4 ) , {ψ}_{1 , 2} ( 5 ) , {ψ}_{1 , 2} ( 6 ) , {ψ}_{1 , 2} ( 7 ) , \\ {ψ}_{1 , 2} ( 8 ) , … \} = \{ 0 , 0 , {ϕ}_{2} , {ϕ}_{2} , 2 {ϕ}_{2} , 2 {ϕ}_{2} , 3 {ϕ}_{2} , 3 {ϕ}_{2} , … \} ; & ( Expression 23 )\end{matrix}$$

$$\begin{matrix}[ 24 ] & \\ \{ {ψ}_{1 , 3} ( 1 ) , {ψ}_{1 , 3} ( 2 ) , {ψ}_{1 , 3} ( 3 ) , {ψ}_{1 , 3} ( 4 ) , {ψ}_{1 , 3} ( 5 ) , {ψ}_{1 , 3} ( 6 ) , {ψ}_{1 , 3} ( 7 ) , \\ {ψ}_{1 , 3} ( 8 ) , … \} = \{ 0 , 0 , {ϕ}_{3} , {ϕ}_{3} , 2 {ϕ}_{3} , 2 {ϕ}_{3} , 3 {ϕ}_{3} , 3 {ϕ}_{3} , … \} ; & ( Expression 24 )\end{matrix}$$

$$\begin{matrix}[ 25 ] & \\ \{ {ψ}_{2 , 3} ( 1 ) , {ψ}_{2 , 3} ( 2 ) , {ψ}_{2 , 3} ( 3 ) , {ψ}_{2 , 3} ( 4 ) , {ψ}_{2 , 3} ( 5 ) , \\ {ψ}_{2 , 3} ( 6 ) , {ψ}_{2 , 3} ( 7 ) , {ψ}_{2 , 3} ( 8 ) , … \} = \{ \frac{π}{2} , - \frac{π}{2} , {ϕ}_{3} + \frac{π}{2} , \\ {ϕ}_{3} - \frac{π}{2} , 2 {ϕ}_{3} + \frac{π}{2} , 2 {ϕ}_{3} - \frac{π}{2} , 3 {ϕ}_{3} + \frac{π}{2} , 3 {ϕ}_{3} - \frac{π}{2} , … \} ; & ( Expression 25 )\end{matrix}$$

$$\begin{matrix}[ 26 ] & \\ \{ {ψ}_{1 , 4} ( 1 ) , {ψ}_{1 , 4} ( 2 ) , {ψ}_{1 , 4} ( 3 ) , {ψ}_{1 , 4} ( 4 ) , {ψ}_{1 , 4} ( 5 ) , {ψ}_{1 , 4} ( 6 ) , {ψ}_{1 , 4} ( 7 ) , \\ {ψ}_{1 , 4} ( 8 ) , … \} = \{ 0 , 0 , {ϕ}_{4} , {ϕ}_{4} , 2 {ϕ}_{4} , 2 {ϕ}_{4} , 3 {ϕ}_{4} , 3 {ϕ}_{4} , … \} ; and & ( Expression 26 )\end{matrix}$$

$$\begin{matrix}[ 27 ] & \\ \{ {ψ}_{2 , 4} ( 1 ) , {ψ}_{2 , 4} ( 2 ) , {ψ}_{2 , 4} ( 3 ) , {ψ}_{2 , 4} ( 4 ) , {ψ}_{2 , 5} ( 5 ) , \\ {ψ}_{2 , 4} ( 6 ) , {ψ}_{2 , 4} ( 7 ) , {ψ}_{2 , 4} ( 8 ) , … \} = \{ \frac{π}{2} , - \frac{π}{2} , {ϕ}_{4} + \frac{π}{2} , \\ {ϕ}_{4} - \frac{π}{2} , 2 {ϕ}_{4} + \frac{π}{2} , 2 {ϕ}_{4} - \frac{π}{2} , 3 {ϕ}_{4} + \frac{π}{2} , 3 {ϕ}_{4} - \frac{π}{2} , … \} . & ( Expression 27 )\end{matrix}$$

Here, as an example, φ_{ndm}=2π(ndm−1)/N_{DM} is used as the phase rotation amount for applying Doppler shift amount DOP_{ndm}, and phase rotation amount φ₁=0 for applying Doppler shift amount DOP₁, phase rotation amount φ₂=π/2 for applying Doppler shift amount DOP₂, phase rotation amount φ₃=π for applying Doppler shift amount DOP₃, and phase rotation amount φ₄=3π/2 for applying Doppler shift amount DOP₄ are used. In this case, encoder 107 configures coded Doppler phase rotation amounts ψ_{1, 1}(m), ψ_{1, 2}(m), ψ_{1, 3}(m), ψ_{2, 3}(m), ψ_{1, 4}(m), and ψ_{2, 4}(m) given by following Expressions 28 to 33 and outputs the coded Doppler phase rotation amounts to phase rotators 108. Here, m=1, . . . , Nc.

$$\begin{matrix}[ 28 ] & \\ \{ {ψ}_{1 , 1} ( 1 ) , {ψ}_{1 , 1} ( 2 ) , {ψ}_{1 , 1} ( 3 ) , {ψ}_{1 , 1} ( 4 ) , {ψ}_{1 , 1} ( 5 ) , \\ {ψ}_{1 , 1} ( 6 ) , {ψ}_{1 , 1} ( 7 ) , {ψ}_{1 , 1} ( 8 ) , … \} = \{ 0 , 0 , 0 , 0 , 0 , 0 , 0 , 0 , … \} ; & ( Expression 28 )\end{matrix}$$

$$\begin{matrix}[ 29 ] & \\ \{ {ψ}_{1 , 2} ( 1 ) , {ψ}_{1 , 2} ( 2 ) , {ψ}_{1 , 2} ( 3 ) , {ψ}_{1 , 2} ( 4 ) , {ψ}_{1 , 2} ( 5 ) , {ψ}_{1 , 2} ( 6 ) , {ψ}_{1 , 2} ( 7 ) , \\ {ψ}_{1 , 2} ( 8 ) , … \} = \{ 0 , 0 , \frac{π}{2} , \frac{π}{2} , π , π , \frac{3 π}{2} , \frac{3 π}{2} … \} ; & ( Expression 29 )\end{matrix}$$

$$\begin{matrix}[ 30 ] & \\ \{ {ψ}_{1 , 3} ( 1 ) , {ψ}_{1 , 3} ( 2 ) , {ψ}_{1 , 3} ( 3 ) , {ψ}_{1 , 3} ( 4 ) , {ψ}_{1 , 3} ( 5 ) , {ψ}_{1 , 3} ( 6 ) , \\ {ψ}_{1 , 3} ( 7 ) , {ψ}_{1 , 3} ( 8 ) , … \} = \{ 0 , 0 , π , π , 0 , 0 , π , π , … \} ; & ( Expression 30 )\end{matrix}$$

$$\begin{matrix}[ 31 ] & \\ \{ {ψ}_{2 , 3} ( 1 ) , {ψ}_{2 , 3} ( 2 ) , {ψ}_{2 , 3} ( 3 ) , {ψ}_{2 , 3} ( 4 ) , {ψ}_{2 , 3} ( 5 ) , {ψ}_{2 , 3} ( 6 ) , {ψ}_{2 , 3} ( 7 ) , \\ {ψ}_{2 , 3} ( 8 ) , … \} = \{ \frac{π}{2} , - \frac{π}{2} , \frac{3 π}{2} , \frac{π}{2} , \frac{π}{2} , - \frac{π}{2} , \frac{3 π}{2} , \frac{π}{2} , … \} ; & ( Expression 31 )\end{matrix}$$

$$\begin{matrix}[ 32 ] & \\ \{ {ψ}_{1 , 4} ( 1 ) , {ψ}_{1 , 4} ( 2 ) , {ψ}_{1 , 4} ( 3 ) , {ψ}_{1 , 4} ( 4 ) , {ψ}_{1 , 4} ( 5 ) , {ψ}_{1 , 4} ( 6 ) , {ψ}_{1 , 4} ( 7 ) , \\ {ψ}_{1 , 4} ( 8 ) , … \} = \{ 0 , 0 , \frac{3 π}{2} , \frac{3 π}{2} , π , π , \frac{π}{2} , \frac{π}{2} , … \} ; and & ( Expression 32 )\end{matrix}$$

$$\begin{matrix}[ 33 ] & \\ \{ {ψ}_{2 , 4} ( 1 ) , {ψ}_{2 , 4} ( 2 ) , {ψ}_{2 , 4} ( 3 ) , {ψ}_{2 , 4} ( 4 ) , {ψ}_{2 , 5} ( 5 ) , {ψ}_{2 , 4} ( 6 ) , {ψ}_{2 , 4} ( 7 ) , \\ {ψ}_{2 , 4} ( 8 ) , … \} = \{ \frac{π}{2} , - \frac{π}{2} , 0 , π , \frac{3 π}{2} , \frac{π}{2} , π , 0 , … \} . & ( Expression 33 )\end{matrix}$$

As given by Expressions 28 to 33, when the phase rotation amounts are set to φ_{ndm}=2π(ndm−1)/N_{DM}, into which 2π is equally divided, coded Doppler phase rotation amounts ψ_{1, 1}(m), ψ_{1, 2}(m), ψ_{1, 3}(m), ψ_{2, 3}(m), ψ_{1, 4}(m), and ψ_{2, 4}(m) are changed in transmission periods given by N_{DM}×N_{CM} 4×2=8.

Further, as illustrated in Expressions 28 to 33, the number of phases used for the phase rotation amounts (e.g., the phase rotation amounts for applying the Doppler shift amounts) (e.g., four phases of 0, π/2, π, and 3π/2) is less than number Nt=6 of transmission antenna 109 used for multiplexing transmission. For example, as given by Expressions 28 to 33, the number of phases (e.g., four phases of 0, π/2, π, and 3π/2) used for the phase rotation amounts for applying the Doppler shift amounts is equal to number N_{DM}=4 of Doppler shift amounts used for multiplexing transmission (e.g., the number of Doppler multiplexing).

The description has been given of, as examples, the configurations of phase rotation amounts in a case where number Nt of transmission antennas 109 is 4 and number N_{DM} of Doppler multiplexing is 2 and in a case where number Nt of transmission antennas 109 is 6 and number N_{DM} of Doppler multiplexing is 4. However, number Nt of transmission antennas 109 and number N_{DM} of Doppler multiplexing are not limited to the values described above. For example, the number of phases used for the phase rotation amounts may be set smaller than number Nt of transmission antennas 109 used for multiplexing transmission, regardless of number Nt of transmission antennas 109. Further, the number of phases used for the phase rotation amounts for applying the Doppler shift amounts may be equal to number N_{DM} of Doppler shift amounts used for multiplexing transmission.

Further, the configuration of the phase rotation amounts as given by the maximum equal-interval Doppler shift amount configuration may be used for the configuration of the phase rotation amounts as in the above example, or the configuration of the phase rotation amounts given by the equal-interval Doppler shift amount configuration, for example, Expression 6, may also be used.

The foregoing description has been given of the configuration method for phase rotation amount setter 105 to configure the phase rotation amounts.

In FIG. 1, phase rotators 108 apply the phase rotation amounts in each transmission period Tr to the chirp signals inputted from radar transmission signal generator 101, based on coded Doppler phase rotation amounts ω_{ndop_code(ndm), ndm}(m) configured by phase rotation amount setter 105. Here, ndm=1, . . . , N_{DM}, and ndop_code(ndm)=1, . . . , N_{DOP_CODE}(ndm).

The sum of numbers N_{DOP_CODE}(1), N_{DOP_CODE}(2), . . . , and N_{DOP_CODE}(N_{DM}) of coded Doppler multiplexing is set to be equal to number Nt of transmission antennas 109, and Nt coded Doppler phase rotation amounts are respectively inputted to Nt phase rotators 108.

Each of Nt phase rotators 108 applies, in each transmission period Tr, inputted coded Doppler phase rotation amount ψ_{ndop_code(ndm), ndm}(m) to a chirp signal inputted from radar transmission signal generator 101. The outputs of Nt phase rotators 108 (referred to as, for example, coded Doppler multiplexed signals) are amplified to a defined transmission power and are then radiated into space from Nt transmission antennas 109 of a transmission array antenna section.

In the following, phase rotator 108 that applies coded Doppler phase rotation amount ψ_{ndop_code(ndm), ndm}(m) is represented by “phase rotator PROT #[ndop_code(ndm), ndm].” Likewise, transmission antenna 109 that radiates the output of phase rotator PROT #[ndop_code(ndm), ndm] into a space is represented by “transmission antenna Tx #[ndop_code(ndm), ndm].” Here, ndm=1, . . . , N_{DM}, and ndop_code(ndm)=1, . . . N_{DOP_CODE}(ndm).

In the present embodiment, the orthogonal code sequence having number N_{CM} (2) of codes (for example, number of code multiplexing) that have a code length Loc of 2 is used. Therefore, N_{DOP_CODE}(ndm)=1 or 2, and ndop_code(ndm)≤2.

For example, a description will be given of a case where number Nt of transmission antennas used for multiplexing transmission is 4, number N_{DM} of Doppler multiplexing is 2, number N_{CM} of code multiplexing is 2, orthogonal code sequences Code₁={1, 1} and Code₂={j, −j} with code length Loc=2 are configured, and numbers N_{DOP_CODE}(1) and N_{DOP_CODE}(2) of coded Doppler multiplexing are 2 and 2, respectively. In this case, coded Doppler phase rotation amounts ψ_{1, 1}(m), ψ_{2, 1}(m), ψ_{1, 2}(m), and ψ_{2, 2}(m) are inputted from encoder 107 to phase rotators 108 in each transmission period.

For example, phase rotator PROT #[1, 1] applies, in each transmission period, phase rotation amount ψ_{1, 1}(m) given by following Expression 34 to a chirp signal generated by radar transmission signal generator 101 in each transmission period. The output of phase rotator PROT #[1, 1] is outputted from transmission antenna Tx #[1, 1]. Here, cp(t) denotes a chirp signal for each transmission period.

$$\begin{matrix}[ 34 ] & \\ exp [ j {ψ}_{1 , 1} ( 1 ) ] c p ( t ) , exp [ j {ψ}_{1 , 11} ( 2 ) ] c p ( t ) , \\ exp [ j {ψ}_{1 , 1} ( 3 ) ] c p ( t ) , … , exp [ j {ψ}_{1 , 1} ( N c ) ] c p ( t ) & ( Expression 34 )\end{matrix}$$

Likewise, phase rotator PROT #[2, 1] applies, in each transmission period, phase rotation amount ψ_{2, 1}(m) given by following Expression 35 to a chirp signal generated by radar transmission signal generator 101 in each transmission period. The output of phase rotator PROT #[2, 1] is outputted from transmission antenna Tx #[2, 1].

$$[ 35 ]$$

$$exp [ j {ψ}_{2 , 1} ( 1 ) ] cp ( t ) , exp [ j {ψ}_{2 , 1} ( 2 ) ] cp ( t ) , \\ exp [ j {ψ}_{2 , 1} ( 3 ) ] cp ( t ) , … , exp [ j {ψ}_{2 , 1} ( Nc ) ] cp ( t ) \qquad ( Expression 35 )$$

Likewise, phase rotator PROT #[1, 2] applies, in each transmission period, phase rotation amount ψ_{1, 2}(m) given by following Expression 36 to a chirp signal generated by radar transmission signal generator 101 in each transmission period. The output of phase rotator PROT #[1, 2] is outputted from transmission antenna Tx #[1, 2].

$$[ 36 ]$$

$$exp [ j {ψ}_{1 , 2} ( 1 ) ] cp ( t ) , exp [ j {ψ}_{1 , 2} ( 2 ) ] cp ( t ) , \\ exp [ j {ψ}_{1 , 2} ( 3 ) ] cp ( t ) , … , exp [ j {ψ}_{1 , 2} ( Nc ) ] cp ( t ) \qquad ( Expression 36 )$$

Likewise, phase rotator PROT #[2, 2] applies, in each transmission period, phase rotation amount ψ_{2, 2}(m) given by following Expression 37 to a chirp signal generated by radar transmission signal generator 101 in each transmission period. The output of phase rotator PROT #[2, 2] is outputted from transmission antenna Tx #[2, 2].

$$[ 37 ]$$

$$exp [ j {ψ}_{2 , 2} ( 1 ) ] cp ( t ) , exp [ j {ψ}_{2 , 2} ( 2 ) ] cp ( t ) , \\ exp [ j {ψ}_{2 , 2} ( 3 ) ] cp ( t ) , … , exp [ j {ψ}_{2 , 2} ( Nc ) ] cp ( t ) \qquad ( Expression 37 )$$

The foregoing description has been given of a configuration example of coded Doppler phase rotation amount ψ_{ndop_code(ndm), ndm}(m).

Further, in the present embodiment, polarization by transmission antennas 109 and the arrangement of transmission antennas 109 are associated with the assignment of the coded Doppler phase rotation amounts, for example, as described below. This association allows radar apparatus 10 to utilize not only transmission antenna 109 for multiplexing transmission but also a transmission antenna for a polarization (for example, circular polarization) different from the polarization (for example, horizontal polarization and vertical polarization) of the transmission antenna for multiplexing transmission (an example will be described later) in radar processing.

For example, at least one set of adjacent transmission antennas 109 includes antennas that emit (or radiate) respective different orthogonally polarized waves (e.g., horizontally polarized waves and vertically polarized waves), and transmits radar transmission signals using the same Doppler multiplexing (e.g., Doppler shift amount).

In the present embodiment, the orthogonal code sequence having number N_{CM} (2) of codes (for example, number of code multiplexing) that have a code length Loc of 2 is used and, thus, N_{DOP_CODE}(ndm__{BF})=2 holds true.

For example, adjacent N_{DOP_CODE}(ndm__{BF}) (=2) transmission antennas 109 include transmission antenna Tx #[1, ndm__{BF}] and transmission antenna Tx #[2, ndm__{BF}] to which phase rotator PROT #[1, ndm__{BF}] and phase rotator PROT #[2, ndm__{BF}] are assigned. Here, ndm__{BF} may be any of 1 to N_{DM}. For example, transmission antennas 109 adjacent to each other in a plurality of transmission antennas 109 are antennas which emit respective different orthogonally polarized waves, and among a plurality of combinations of Doppler shift amounts DOP_{ndm} and the orthogonal code sequences, the Doppler shift amounts are the same (for example, ndm=ndm__{BF}) between combinations associated with the respective antennas.

For example, one or more combinations (e.g., pairs) may be included that satisfy the aforementioned association between, on one hand, the assignment of the coded Doppler phase rotation amounts and, on the other hand, the polarizations and arrangement of transmission antennas 109.

By way of example, a description will be given of a case where number Nt of transmission antennas used for multiplexing transmission is 4, number N_{DM} of Doppler multiplexing is 2, number N_{CM} of code multiplexing is 2, orthogonal code sequences Code₁={1, 1} and Code₂={j, −j} with code length Loc=2 are configured, and numbers N_{DOP_CODE}(1) and N_{DOP_CODE}(2) of coded Doppler multiplexing are 2 and 2, respectively. Note that number N_{BF} of beam transmission antennas is set to 2, and ndm__{BF}=1 and 2 are used as indices of Doppler multiplexed signals used for the beam transmission antennas.

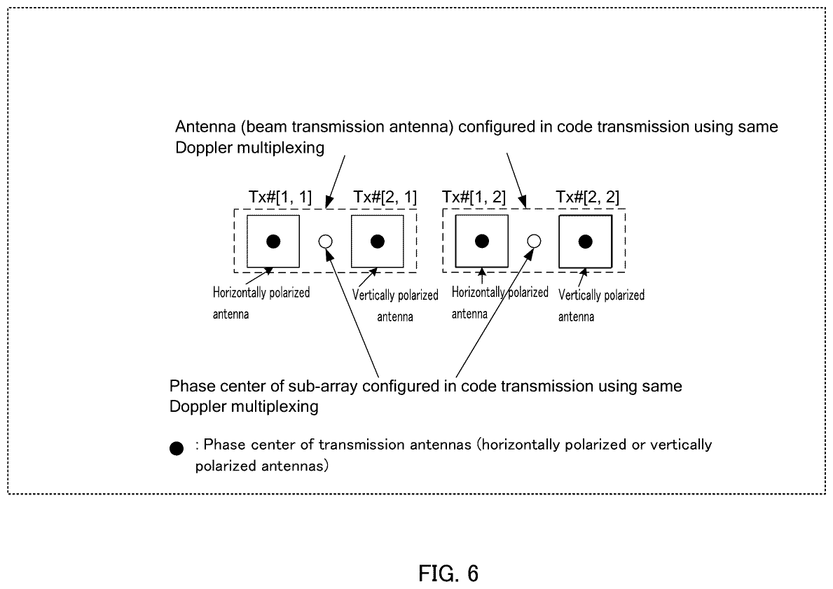

In FIG. 6, for example, horizontally adjacent Nt=4 transmission antennas 109 are transmission antenna Tx #[1, 1], transmission antenna Tx #[2, 1], transmission antenna Tx #[1, 2], and transmission antenna Tx #[2, 2] from the left.

In FIG. 6, among the four transmission antennas 109, left 2 (=N_{DOP_CODE}(1)) adjacent transmission antennas Tx #[1, 1 and Tx #[2, 1] transmit radar transmission signals using the same Doppler multiplexing (Doppler shift amount=DOP₁). Further, antennas for radiating linearly polarized radio waves orthogonal to each other are used as transmission antennas Tx #[1, 1] and Tx #[2, 1] that transmit radar transmission signals using the same Doppler multiplexing (Doppler shift amount=DOP₁). For example, in the embodiment illustrated in FIG. 6, an antenna (for example, a “horizontally polarized antenna”) that radiates a horizontally polarized radio wave may be used as transmission antenna Tx #[1, 1], and an antenna (for example, a “vertically polarized antenna”) that radiates a vertically polarized radio wave may be used as transmission antenna Tx #[2, 1]. Note that the present disclosure is not limited to this, and the vertically polarized antenna may also be used as transmission antenna Tx #[1, 1], and the horizontally polarized antenna may also be used as transmission antenna Tx #[2, 1]. Note that black solid circles (e) in FIG. 6 indicate the phase centers of transmission antennas.

Further, in FIG. 6, among four transmission antennas 109, right 2 (=N_{DOP_CODE}(2)) adjacent transmission antennas Tx #[1, 2] and Tx #[2, 2] transmit radar transmission signals using the same Doppler multiplexing (Doppler shift amount=DOP₂). Further, antennas for radiating linearly polarized radio waves orthogonal to each other are used as transmission antennas Tx #[1, 2] and Tx #[2, 2] that transmit radar transmission signals using the same Doppler multiplexing (Doppler shift amount=DOP₂). For example, in the embodiment illustrated in FIG. 6, a horizontally polarized antenna may be used as transmission antenna Tx #[1, 2], and a vertically polarized antenna may be used as transmission antenna Tx #[2, 2]. Note that the present disclosure is not limited to this, and the vertically polarized antenna may also be used for transmission antenna Tx #[1, 2], and the horizontally polarized antenna may also be used for transmission antenna Tx #[2, 2].

By way of another example, a description will be given of a case where number Nt of transmission antennas used for multiplexing transmission is 5, number N_{DM} of Doppler multiplexing is 3, number N_{CM} of code multiplexing is 2, orthogonal code sequences Code₁={1, 1} and Code₂={j, −j} with code length Loc=2 are configured, and numbers N_{DOP_CODE}(1) and N_{DOP_CODE}(2) of coded Doppler multiplexing are 2 and 2, respectively. Note that number N_{BF} of beam transmission antennas is set to 2, and ndm__{BF1}=1 and ndm__{BF2}=2 are used as indices of Doppler multiplexed signals used for the beam transmission antennas.

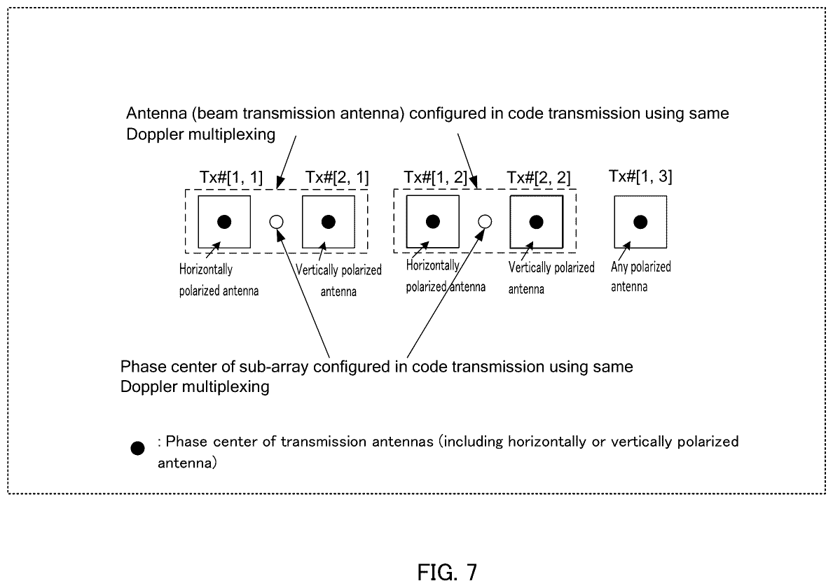

In FIG. 7, for example, horizontally adjacent Nt=5 transmission antennas 109 are transmission antenna Tx #[1, 1], transmission antenna Tx #[2, 1], transmission antenna Tx #[1, 2], transmission antenna Tx #[2, 2], and transmission antenna Tx #[1, 3] from the left. Note that black solid circles (●) in FIG. 7 indicate the phase centers of transmission antennas.

In FIG. 7, among the five transmission antennas 109, left 2 (=N_{DOP_CODE}(1)) adjacent transmission antennas Tx #[1, 1] and Tx #[2, 1] transmit radar transmission signals using the same Doppler multiplexing (Doppler shift amount=DOP₁). Further, antennas for radiating linearly polarized radio waves orthogonal to each other are used as transmission antennas Tx #[1, 1] and Tx #[2, 1] that transmit radar transmission signals using the same Doppler multiplexing (Doppler shift amount=DOP₁). For example, in the embodiment illustrated in FIG. 7, a horizontally polarized antenna may be used for transmission antenna Tx #[1, 1], and a vertically polarized antenna may be used for transmission antenna Tx #[2, 1]. Note that the present disclosure is not limited to this, and the vertically polarized antenna may also be used for transmission antenna Tx #[1, 1], and the horizontally polarized antenna may also be used for transmission antenna Tx #[2, 1].

In addition, 2 (=N_{DOP_CODE}(2)) adjacent transmission antennas Tx #[1, 2] and Tx #[2, 2] to the right of the transmission antennas Tx #[1, 1] and Tx #[2, 1] transmit radar transmission signals using the same Doppler multiplexing (Doppler shift amount=DOP₂). Further, antennas for radiating linearly polarized radio waves orthogonal to each other are used as transmission antennas Tx #[1, 2] and Tx #[2, 2] that transmit radar transmission signals using the same Doppler multiplexing (Doppler shift amount=DOP₂). For example, in the embodiment illustrated in FIG. 7, a horizontally polarized antenna may be used for transmission antenna Tx #[1, 2], and a vertically polarized antenna may be used for transmission antenna Tx #[2, 2]. Note that the present disclosure is not limited to this, and the vertically polarized antenna may also be used for transmission antenna Tx #[1, 2], and the horizontally polarized antenna may also be used for transmission antenna Tx #[2, 2]. Note that any polarized antenna may be used as transmission antenna Tx #[1, 3].

Further, for example, in a case where a plurality of sets (or pairs) of adjacent horizontally polarized antennas and vertically polarized antennas described above are included, radar apparatus 10 may configure a Doppler shift amount different for each of the plurality of sets. For example, in FIGS. 6 and 7, the Doppler shift amounts may be different between the set of transmission antennas Tx #[1, 1] and Tx #[2, 1] and the set of transmission antennas Tx #[1, 2] and Tx #[2, 2].

As is understood from the above examples, at least one set of adjacent transmission antennas 109 (e.g., corresponding to first transmission antennas) includes transmission antenna 109 that radiates a horizontally polarized wave and transmission antenna 109 (e.g., corresponding to a second transmission antenna) that radiates a vertically polarized wave. Further, the same Doppler shift amount is configured for at least one set of adjacent transmission antennas 109, and the radar transmission signals are transmitted using the same Doppler multiplexing. For example, at least one set of adjacent transmission antennas 109 may perform code multiplexing transmission using the same Doppler multiplexing to radiate radar transmission signals in space using different polarized antennas.

Here, reception signals for each transmission period that correspond to the radar transmission signals on which the code multiplexing transmission is performed using the same Doppler multiplexing can be regarded as reception signals corresponding to beam transmission by a plurality of transmission antennas 109. For example, the transmission by at least one set of adjacent transmission antennas 109 described above is equivalent to beam transmission by a sub-array composed of such adjacent transmission antennas 109. When radar apparatus 10 transmits a radar transmission signal from the at least one set of adjacent transmission antennas 109 described above, for example, at an equal power, such transmission may be treated as transmission by a new transmission antenna (hereinafter, referred to as a “beam transmission antenna”) for which a midpoint position between adjacent transmission antennas 109 serves as the phase center of the sub-array (details will be described later in conjunction with the reception processing). In FIGS. 6 and 7, a white circle (◯) indicates the phase center of each beam transmission antenna.

Further, for example, polarized antennas that radiate linearly polarized radio waves orthogonal to each other, such as a horizontally polarized antenna and a vertically polarized antenna, may be used as the at least one set of adjacent transmission antennas 109. Thus, the reception signal for each transmission period corresponding to the radar transmission signal that is transmitted using code multiplexing by using the same Doppler multiplexing can be regarded as a reception signal corresponding to transmission from a transmission antenna from which a circularly polarized radio wave is radiated, from among at least one set of the plurality of adjacent transmission antennas 109. This principle will be described below using computer simulation.

A description will be given of a computer simulation that combines two orthogonal linearly polarized antennas (e.g., a horizontally polarized antenna and a vertically polarized antenna) to generate differently polarized waves (right-handed circularly polarized waves or left-handed circularly polarized waves) will be described.

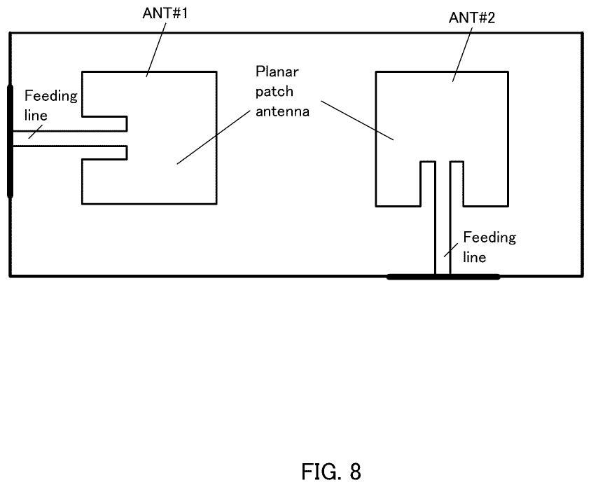

For example, regarding power supply phases for power supply to the horizontally polarized antenna (ANT #1) and the vertically polarized antenna (ANT #2), a description will be given of a result of the computer simulation conducted with ANT #1 being used as a reference (e.g., 0 degrees), and the phase of ANT #2 being set to 90 degrees or −90 degrees as illustrated in FIG. 8. Here, the element spacing between the horizontally polarized antenna (ANT #1) and the vertically polarized antenna (ANT #2) is set to 0.5 wavelength.

Note that the element spacing is not limited to 0.5 wavelength, and may be widened. When the element spacing is widened, the beam width of the main beam formed by two antennas is narrowed, and the viewing angle securing the axial ratio is narrowed. In addition, when the element spacing is set to a spacing that is widened by about one wavelength or more, a grating lobe is generated in a direction different from the main beam direction formed by two antennas, and radio waves that become circularly polarized waves are radiated in the main beam direction and the grating lobe direction.

Although FIG. 8 illustrates an example of the linearly polarized antennas using planar patch antennas for single-point feeding, the present disclosure is not limited to this, and an antenna element of a type for performing two-point feeding to the planar patch antennas may be used. Further, a plurality of antenna elements used to form an array may be used.

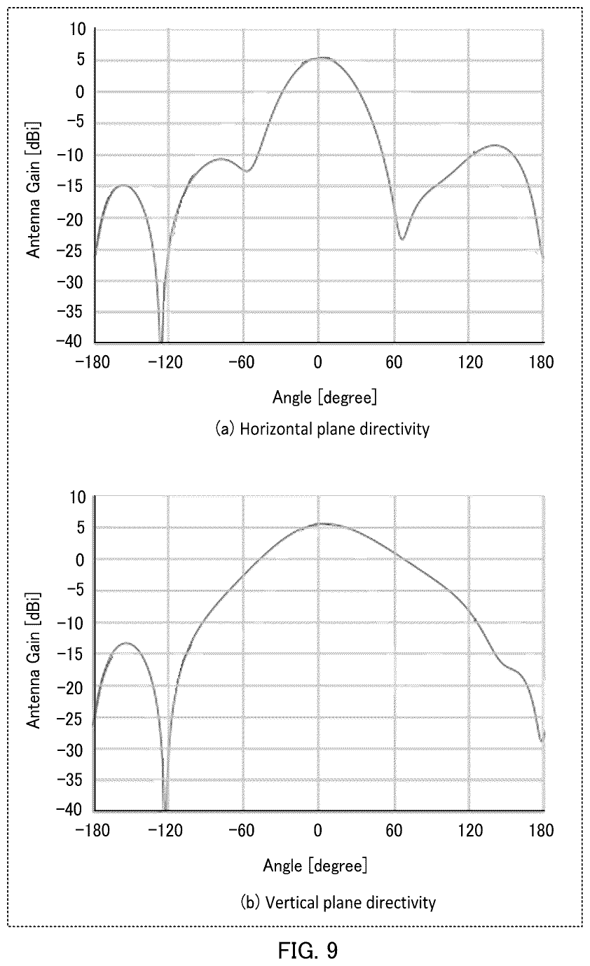

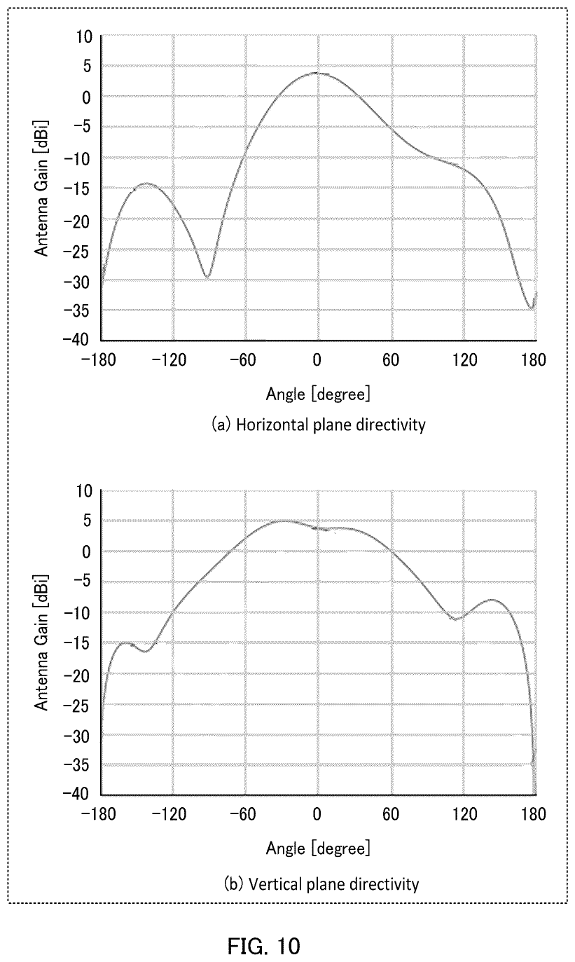

For example, when the phase of ANT #2 is shifted by 90 degrees with reference to ANT #1, a left-handed circularly polarized wave with a directivity illustrated in FIG. 9 is emitted. Part (a) of FIG. 9 illustrates the directivity in the horizontal plane, and part (b) of FIG. 9 illustrates the directivity in the vertical plane. Further, when the phase of ANT #2 is shifted by −90 degrees with reference to ANT #1, a right-handed circularly polarized wave with a directivity illustrated in FIG. 10 is emitted. Part (a) of FIG. 10 illustrates the directivity in the horizontal plane, and part (b) of FIG. 10 illustrates the directivity in the vertical plane.

Here, two types of phases [0°, 90° ] and [0°, −90° ] for generating a left-handed circularly polarized wave or a right-handed circularly polarized wave using ANT #1 and ANT #2 correspond to cases where Code₁={1, 1}, Code₂={j, −j} are used as orthogonal code sequences of N_{CM}=2 having a code length Loc of 2 in encoder 107. For example, when these codes are orthogonal to each other and nocth code element OC_{ncm}(noc) of the first code is used as a reference, nocth code element OC_{ncm}(noc) of the second code differs in phase by +90° or −90°. Here, noc=1 or 2. For example, among the plurality of orthogonal codes, the phase of code element OC corresponding to each transmission period differs by 90° between first code Code₁ for the radar transmission signal transmitted from ANT #1={1, 1} and second code Code₂ for the radar transmission signal transmitted from ANT #2={j, −j}.

The radar transmission signals, which are signals encoded by encoder 107 and transmitted with code multiplexing by using the same Doppler multiplexing, retain a relationship of being transmitted from the plurality of transmission antennas 109 with phases being different by +90° or −90°. Therefore, reception signals corresponding to the radar transmission signals can be regarded as reception signals corresponding to transmissions from the transmission antenna from which the radio waves that become the circularly polarized waves are radiated.

For example, when Code₁={1, 1} and Code₂={j, −j} are used, the phase rotation amount corresponding to the first code element “1” of Code₁ may be given to the radar transmission signal transmitted from ANT #1, and the phase rotation amount corresponding to the first code element “j” of Code₂ may be given to the radar transmission signal transmitted from ANT #2 in the first transmission period. As a result, in the first transmission period, ANT #1 and ANT #2 radiate radio waves that become left-handed circularly polarized waves. Further, for example, in the second transmission period following the first transmission period, the phase rotation amount corresponding to the second code element “1” of Code₁ may be given to the radar transmission signal transmitted from ANT #1, and the phase rotation amount corresponding to the second code element “−j” of Code₂ may be given to the radar transmission signal transmitted from ANT #2. As a result, in the second transmission period, ANT #1 and ANT #2 radiate radio waves that become right-handed circularly polarized waves.

As is understood from the above, for example, radar apparatus 10 (radar transmitter 100) performs multiplexing transmission of the radar transmission signals from ANT #1 and ANT #2 by giving the transmission signals the phase rotation amounts making the phase at each transmission period different by 90° between ANT #1 and ANT #2. With such a transmission method, radar apparatus 10 can use transmission antennas more than number Nt of transmission antennas for multiplexing transmission and can use a transmission antenna of a polarization (for example, circular polarization) different from the polarizations (for example, horizontal polarization and vertical polarization) of transmission antennas 109.

Note that, the example in which transmission antennas 109 are horizontally arranged has been described with reference to FIGS. 6 and 7, the arrangement method of transmission antennas 109 is not limited thereto. For example, transmission antennas 109 may be vertically arranged, or may be arranged in a horizontal and vertical plane. Further, antennas constituting transmission antennas 109 may be composed of a plurality of horizontally arranged sub-array elements, a plurality of vertically arranged sub-array elements, or a plurality of sub-array elements arranged in a horizontal and vertical plane. In addition, the antennas illustrated in FIGS. 6 and 7 may be a part of a plurality of antennas that radar apparatus 10 includes.

As is understood, in the present embodiment, a plurality of transmission antennas 109 are associated respectively with the combinations (for example, assignment) of Doppler shift amounts DOP_{ndm} and orthogonal code sequences Code_{ncm} such that at least one of Doppler shift amount DOP_{ndm} and orthogonal code sequence Code_{ncm} differs from combination to combination.

Further, in the present embodiment, when numbers N_{DOP_CODE}(ndm) of coded Doppler multiplexing for the Doppler multiplexed signals are configured non-uniformly, the numbers of multiplexing by orthogonal code sequences Code_{ncm} (for example, numbers N_{DOP_CODE}(ndm) of coded Doppler multiplexing) corresponding respectively to Doppler shift amounts DOP_{ndm} may be different among the combinations of Doppler shift amounts DOP_{ndm} and orthogonal code sequences Code_{ncm}. By way of example, as illustrated in FIG. 3, Nt transmission antennas 109 may at least include a plurality of (e.g., two) transmission antennas 109 from which transmission signals that are code-multiplexed using different orthogonal code sequences are transmitted, and at least one transmission antenna 109 from which a transmission signal that is not code-multiplexed is transmitted. For example, radar transmission signals transmitted from radar transmitter 100 include at least a coded Doppler multiplexed signal for which number N_{DOP_CODE}(ndm) of coded Doppler multiplexing is set to number N_{CM} of codes, and a coded Doppler multiplexed signal for which number N_{DOP_CODE}(ndm) of coded Doppler multiplexing is set smaller than number N_{CM} of codes.

Further, in the present embodiment, when numbers N_{DOP_CODE}(ndm) of coded Doppler multiplexing for the Doppler multiplexed signals are configured uniformly, the numbers of multiplexing by orthogonal code sequences Code_{ncm} (for example, numbers N_{DOP_CODE}(ndm) of coded Doppler multiplexing) corresponding respectively to Doppler shift amounts DOP_{ndm} may be the same among the combinations of Doppler shift amounts DOP_{ndm} and orthogonal code sequences Code_{ncm}.

### [Configuration of Radar Receiver 200]

In FIG. 1, radar receiver 200 includes Na reception antennas 202, which constitute an array antenna. Radar receiver 200 further includes Na antenna system processors 201-1 to 201-Na, constant false alarm rate (CFAR) section 211, coded Doppler demultiplexer 212, Doppler demultiplexer 213, and direction estimator 214.

Each of reception antennas 202 receives a reflected wave signal that is a radar transmission signal reflected from a target object (target), and outputs the received reflected wave signal to the corresponding one of antenna system processors 201 as a reception signal.

Each of antenna system processors 201 includes reception radio 203 and signal processor 206.

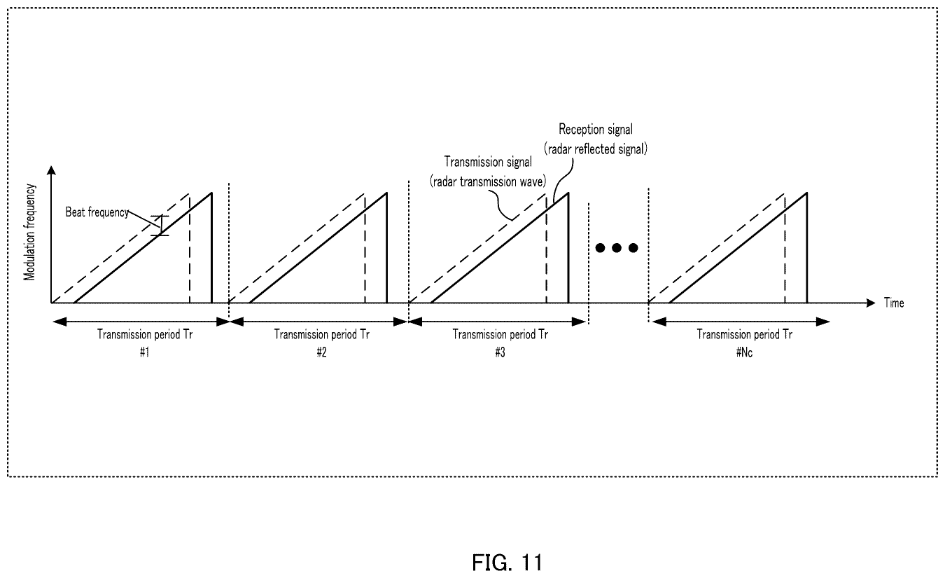

Reception radio 203 includes mixer 204 and low pass filter (LPF) 205. Reception radio 203 mixes, at mixer 204, a chirp signal inputted from radar transmission signal generator 101, which is a transmission signal, with the received reflected wave signal, and passes the resulting mixed signal through LPF 205. As a result, a beat signal having a frequency corresponding to the delay time of the reflected wave signal is acquired. For example, as illustrated in FIG. 11, the difference frequency between the frequency of a transmission chirp signal (transmission frequency-modulated wave) and the frequency of a reception chirp signal (reception frequency-modulated wave) is obtained as a beat frequency.

In each antenna system processor 201-z (where z is any of 1 to Na), signal processor 206 includes analog-to-digital (AD) converter 207, beat frequency analyzer 208, output switch 209, and Doppler analyzers 210.

The signal (for example, beat signal) outputted from LPF 205 is converted into discretely sampled data by AD converter 207 in signal processor 206.

Beat frequency analyzer 208 performs, in each transmission period Tr, FFT processing on N_{data} pieces of discretely sampled data obtained in a defined time range (range gate). Signal processor 206 thus outputs a frequency spectrum in which a peak appears at a beat frequency dependent on the delay time of the reflected wave signal (radar reflected wave). In the FFT processing, for example, beat frequency analyzer 208 may perform multiplication by a window function coefficient such as the Han window or the Hamming window. The use of the window function coefficient can suppress sidelobes around the beat frequency peak.

Here, a beat frequency response outputted from beat frequency analyzer 208 in zth signal processor 206, obtained through the mth chirp pulse transmission, is represented by RFT_{z}(f_{b}, m). Here, f_{b} denotes the beat frequency index and corresponds to an FFT index (bin number). For example, f_{b}=0 to N_{data}/2−1, z=1 to Na, and m=1 to N_{C}. A beat frequency having smaller beat frequency index f_{b} indicates a shorter delay time of the reflected wave signal (for example, a shorter distance to the target object).

In addition, beat frequency index f_{b} can be converted into distance information R(f_{b}) using following Expression 38. Thus, in the following, beat frequency index f_{b} is also referred to as “distance index f_{b}.”

$$[ 38 ]$$

$$R ( {f}_{b} ) = \frac{{C}_{0}}{2 {B}_{w}} {f}_{b} \qquad ( Expression 38 )$$

Here, B_{w} denotes a frequency-modulation bandwidth within the range gate for a chirp signal, and C₀ denotes the speed of light.

Output switch 209 performs selective switching to output the output of beat frequency analyzer 208 for each transmission period to OC_INDEXth Doppler analyzer 210 among Loc Doppler analyzers 210 based on orthogonal code element index OC_INDEX inputted from encoder 107 of phase rotation amount setter 105. For example, output switch 209 selects OC_INDEXth Doppler analyzer 210 given by Expression 9 for mth transmission period Tr.

Signal processor 206 includes Loc Doppler analyzers 210-1 to 210-Loc (in the present embodiment, Loc=2, for example). For example, data is inputted by output switch 209 to nocth Doppler analyzer 210 in each of Loc transmission periods (Loc×Tr). Accordingly, nocth Doppler analyzer 210 performs Doppler analysis for each distance index f_{b} using data of N_{c}ode transmission periods among N_{c} transmission periods (for example, using beat frequency response RFT_{z}(f_{b}, m) inputted from beat frequency analyzer 208). Here, noc denotes the index of a code element, and noc=1, . . . , Loc.

For example, when Ncode is a power of 2, FFT processing is applicable in the Doppler analysis. In this case, the FFT size is Ncode, and a maximum Doppler frequency that is derived from the sampling theorem and in which no aliasing occurs is ±1/(2Loc×Tr). Further, the Doppler frequency interval for Doppler frequency index fₛ is 1/(Ncode×Loc×Tr), and the range of Doppler frequency index fₛ is fₛ=−Ncode/2, . . . , 0, . . . , Ncode/2−1.

The following description will be given of a case where Ncode is a power of 2, as an example. Note that, when Ncode is not a power of 2, zero-padded data is included, for example, to allow FFT processing to be performed, with the data size (FFT size) being equal to a power of 2. In the FFT processing, Doppler analyzer 210 may perform multiplication by a window function coefficient such as the Han window or the Hamming window. The application of a window function can suppress sidelobes around the Doppler frequency peak.

For example, output VFT_{z}^{noc} (f_{b}, fₛ) of Doppler analyzer 210 of zth signal processor 206 is given by following Expression 39. Note that j is the imaginary unit and z=1 to Na.

$$[ 39 ]$$

$${VFT}_{z}^{noc} ( {f}_{b} , {f}_{s} ) = \qquad ( Expression 39 )$$

$${\sum }_{s = 0}^{{N}_{code} - 1} {RFT}_{z} ( {f}_{b} , {L}_{OC} \times s + noc ) exp [ - j \frac{2 π {sf}_{s}}{{N}_{code}} ]$$

The processing in each component of signal processor 206 has been described above.

In FIG. 1, CFAR section 211 performs CFAR processing (for example, adaptive threshold judgement) using the outputs of Loc Doppler analyzers 210 in each of the first to Nath signal processors 206 and extracts distance indices f_{b_cfar} and Doppler frequency indices f_{s_cfar} that provide peak signals.

For example, CFAR section 211 performs two-dimensional CFAR processing with the distance axis and the Doppler frequency axis (corresponding to the relative velocity) or CFAR processing that is a combination of one-dimensional CFAR processing by power addition of outputs VFT_{z}^{noc} (f_{b}, fₛ) of Doppler analyzers 210 in first to Nath signal processors 206, for example, as given by following Expression 40. For example, processing disclosed in NPL 2 may be applied as the two-dimensional CFAR processing or the CFAR processing that is a combination of one-dimensional CFAR processing.

$$[ 40 ]$$

$$PowerFT ( {f}_{b} , {f}_{s} ) = {\sum }_{z = 1}^{{N}_{a}} {\sum }_{noc = 1}^{{L}_{oc}} {\vert {VFT}_{z}^{noc} ( {f}_{b} , {f}_{s} ) \vert}^{2} \qquad ( Expression 40 )$$

CFAR section 211 adaptively configures a threshold and outputs, to coded Doppler demultiplexer 212, distance index f_{b_cfar} and Doppler frequency index f_{s_cfar} that provide a received power greater than the threshold, and received-power information PowerFT(f_{b_cfar}, f_{s_cfar}).

For example, when phase rotation amount φ_{ndm} for applying Doppler shift amount DOP_{ndm} is determined using Expression 5, the intervals between the Doppler shift amounts in the Doppler frequency domain, which are outputted from Doppler analyzers 210, are equal intervals, and ΔFD=Ncode/N_{DM} when intervals ΔFD of the Doppler shift amounts are represented by the intervals of the Doppler frequency indices. Accordingly, in the outputs of Doppler analyzers 210, a peak is detected for each Doppler-shift multiplexed signal at an interval of ΔFD in the Doppler frequency domain. Note that, when phase rotation amount φ_{ndm} is determined using Expression 5, ΔFD may sometimes not be an integer depending on Ncode and N_{DM}. In this case, Expression 59 described below may be used to obtain ΔFD having an integer value. The following describes a reception processing operation using ΔFD having an integer value.

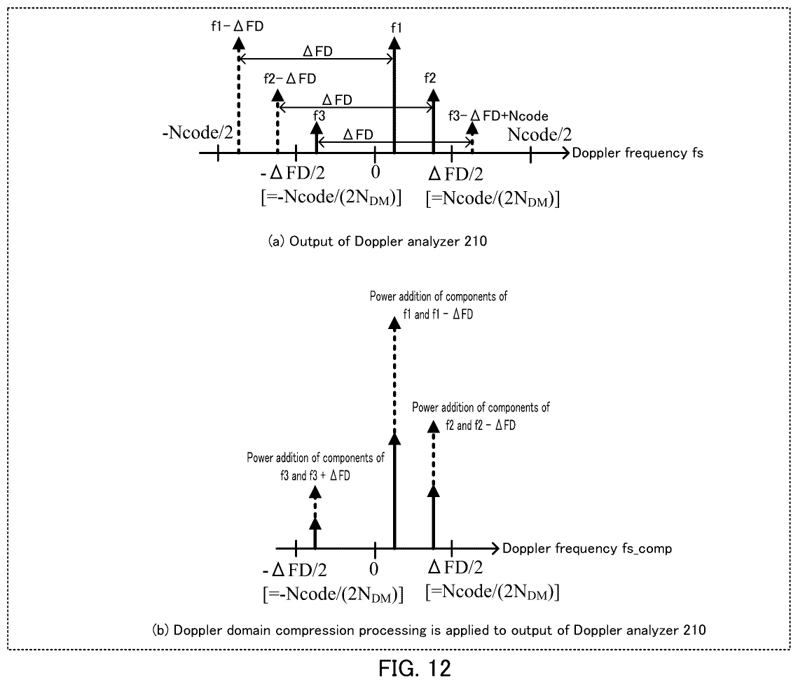

Part (a) in FIG. 12 illustrates an example of the outputs of Doppler analyzers 210 for the distances over which reflected waves from three targets exist in a case where N_{DM}=2. For example, as illustrated at (a) in FIG. 12, when reflected waves from the three targets are observed at Doppler frequency indices f1, f2, and f3, the reflected waves are also observed at respective Doppler frequency indices spaced from f1, f2 and f3 by the interval of ΔFD (for example, f1−ΔFD, f2−ΔFD, and f3−ΔFD+Ncode).

Accordingly, CFAR section 211 may perform, as given by following Expression 41, power addition (referred to as, for example, “Doppler domain compression”) with respect to the outputs of Doppler analyzers 210 while adjusting peak positions of Doppler-shift multiplexed signals to respective ranges resulting from division by the range of interval ΔFD of the Doppler shift amounts. Subsequently, CFAR section 211 may perform CFAR processing (referred to as, for example, “Doppler domain compression CFAR processing”). Here, f_{s_comp}=−ΔFD/2 to −ΔFD/2−1. For example, when ΔFD=Ncode/N_{DM}, then f_{s_comp}=Ncode/(2N_{DM}), . . . , Ncode/(2N_{DM})−1.

$$[ 41 ]$$

$${PowerFT}_{comp} ( {f}_{b} , {f}_{{s}_{comp}} ) = \qquad ( Expression 41 )$$

$${\sum }_{nfd = 1}^{{N}_{DM}} PowerFT ( {f}_{b} , {f}_{{s}_{comp}} + ( nfd - ceil ( \frac{{N}_{DM}}{2} ) - 1 ) \times Δ FD )$$

However, in Expression 41, in the case of

$$[ 42 ]$$

$${f}_{s \_ comp} + ( nfd - ceil ( \frac{{N}_{DM}}{2} ) - 1 ) \times Δ FD < - Ncode / 2 , \qquad ( Expression 42 )$$

the Doppler frequency index to which Ncode is added is used.

Likewise, in Expression 41, in the case of

$$[ 43 ]$$

$${f}_{s \_ comp} + ( nfd - ceil ( \frac{{N}_{DM}}{2} ) - 1 ) \times Δ FD > \frac{Ncode}{2} - 1 , \qquad ( Expression 43 )$$

the Doppler frequency index from which Ncode is further subtracted is used.

It is thus possible to compress the Doppler frequency range for the CFAR processing to 1/N_{DM} to reduce the amount of CFAR processing and to simplify the circuit configuration. In addition, CFAR section 211 is capable of power addition for N_{DM} Doppler-shift multiplexed signals, to improve a signal to noise ratio (SNR) by about (N_{DM})^{1/2}. As a result, the radar sensing performance of radar apparatus 10 can be improved.

Part (b) in FIG. 12 illustrates an example of outputs that are the outputs of Doppler analyzers 210 illustrated at (a) in FIG. 12 to which the Doppler domain compression processing given by Expression 41 is applied. As illustrated at (b) in FIG. 12, in a case where N_{DM}=2, CFAR section 211 adds together the power component for Doppler frequency index f1 and the power component for f1−ΔFD through the Doppler domain compression processing and outputs the result. Likewise, as illustrated at (b) in FIG. 12, CFAR section 211 adds together the power component of Doppler frequency index f2 and the power component of f2−ΔFD and outputs the result. Further, regarding the power component of Doppler frequency index f3, f3−ΔFD is smaller than −Ncode/2. Thus, CFAR section 211 adds together the power component of Doppler frequency index f3 and the power component of f3−ΔFD+Ncode (f3+ΔFD when N_{DM}=2, for example) and outputs the result.

As a result of the Doppler domain compression, the range of Doppler frequency indices f_{s_comp} in the Doppler frequency domain is reduced to the range of from −ΔFD/2 through ΔFD/2−1 (when ΔFD=Ncode/N_{DM}, the range is from −Ncode/(2N_{DM}) through Ncode/(2N_{DM})−1) and the range of the CFAR processing is compressed, resulting in reduction of the computation amount of CFAR processing. In addition, in FIG. 12, for example, because of power addition for the reflected waves from the 3 targets, the SNR of the signal components is improved. Note that the power of noise components is also combined, and thus, improvement in SNR is, for example, about (N_{DM})^{1/2}.

For example, CFAR section 211, which uses the Doppler domain compression CFAR processing, adaptively configures a threshold and outputs, to coded Doppler demultiplexer 212, distance index f_{b_cfar} and Doppler frequency index f_{s_comp_car} that provide a received power greater than the threshold, and received-power information PowerFT(f_{b_cfar}, f_{s_comp_cfar}+(nfd−ceil(N_{DM}/2)−1)×ΔFD (where nfd=1, . . . , N_{DM})) for Doppler frequency indices (f_{s_comp_cfar}+(nfd−ceil(N_{DM}/2)−1)×ΔFD) of N_{DM} Doppler multiplexed signals.

In addition, CFAR section 211 outputs, for example, distance index f_{b_cfar} and Doppler frequency index f_{s_comp_cfar} to Doppler demultiplexer 213.

Note that phase rotation amount φ_{ndm} for applying Doppler shift amount DOP_{ndm} is not limited to that given by Expression 5. CFAR section 211 can apply the Doppler domain compression CFAR processing, for example, when phase rotation amounts φ_{ndm} of Doppler-shift multiplexed signals are such that peaks are detected at constant intervals in the Doppler frequency domain in the outputs from Doppler analyzers 210.

For example, when Δf_{MinInterval}=1/(Tr(N_{DM}+Nᵢₙₜ)L_{OC}) is configured using the equal-interval Doppler shift amount configuration, phase rotation amount φ_{ndm} is configured according to Expression 6, and the Doppler-shift multiplexed signals are detected as peaks at the intervals of ΔFD=Ncode/(N_{DM}+Nᵢₙₜ) in the Doppler frequency domain in the outputs from the Doppler analyzers 210. Also in such a case, CFAR section 211 can apply the Doppler domain compression CFAR processing.

Next, an example of the operation of coded Doppler demultiplexer 212 illustrated in FIG. 1 will be described. For example, coded Doppler demultiplexer 212 demultiplexes signals of the linearly polarized waves (for example, horizontally polarized waves and vertically polarized waves) using both the output of first Doppler analyzer 210 and the output of second Doppler analyzer 210.

The following describes an example of processing performed by coded Doppler demultiplexer 212 when CFAR section 211 uses the Doppler domain compression CFAR processing.

Based on the outputs of CFAR section 211 (e.g., distance indices f_{b_cfar}, Doppler frequency indices f_{s_comp_cfar}, and received-power information PowerFT(f_{b_cfar}, f_{s_comp_cfar}+(nfd−ceil(N_{DM}/2)−1)×ΔFD) for Doppler frequency indices (f_{s_comp_cfar}+(nfd−ceil(N_{DM}/2)−1)×ΔFD (where nfd=1, . . . , N_{DM})) of N_{DM} Doppler multiplexed signals), coded Doppler demultiplexer 212 separates, using the outputs of Doppler analyzers 210, coded-Doppler multiplexed signals transmitted, and distinguishes (for example, also referred to as “judges” or “identifies”) transmission antennas 109 and Doppler frequencies (for example, Doppler velocities or relative velocities).

As described above, when the equal-interval Doppler shift amount configuration including the maximum equal-interval Doppler shift amount configuration is used, encoder 107 in phase rotation amount setter 105 does not set all of N_{DM} numbers N_{DOP_CODE}(1), N_{DOP_CODE}(2), . . . , and N_{DOP_CODE}(N_{DM}) of coded Doppler multiplexing to N_{CM}, for example, but may set at least one of the numbers of coded Doppler multiplexing to a value smaller than N_{CM}. For example, coded Doppler demultiplexer 212 performs (1) code separation processing to detect a coded Doppler multiplexed signal for which the number of coded Doppler multiplexing is set smaller than N_{CM} (for example, detect an unused coded Doppler multiplexed signal that is not used for multiplexing transmission), to perform aliasing judgement. Thereafter, coded Doppler demultiplexer 212 performs (2) Doppler code separation processing on coded Doppler multiplexed signals used for multiplexing transmission based on an aliasing judgement result.

Processing (1) and processing (2) by coded Doppler demultiplexer 212 described above will be described below.

### <(1) Aliasing Judgement Processing (Detection Processing of Detecting Unused Coded Doppler Multiplexed Signal)>

Coded Doppler demultiplexer 212 performs the Doppler aliasing judgement processing, for example, on the assumption that the Doppler range of a target is ±1/(2Tr).

Here, since Doppler analyzer 210 applies the FFT processing to each code element, for example, when Ncode is a power value of 2, the Doppler analyzer performs the FFT processing per (Loc×Tr) periods using the output from beat frequency analyzer 208. Thus, the Doppler range in which the sampling theorem does not cause aliasing in Doppler analyzer 210 is ±1/(2Loc×Tr). Doppler multiplexing is further performed on this Doppler range of ±1/(2Loc×Tr) by using number N_{DM} of Doppler multiplexing. Thus, coded Doppler demultiplexer 212 performs the aliasing judgement processing, assuming the Doppler range of ±1/(2Tr) resulting from multiplication, by Loc×N_{DM}, of the Doppler range of ±1/(2Loc×N_{DM}×Tr) in which aliasing due to Doppler multiplexing does not occur.

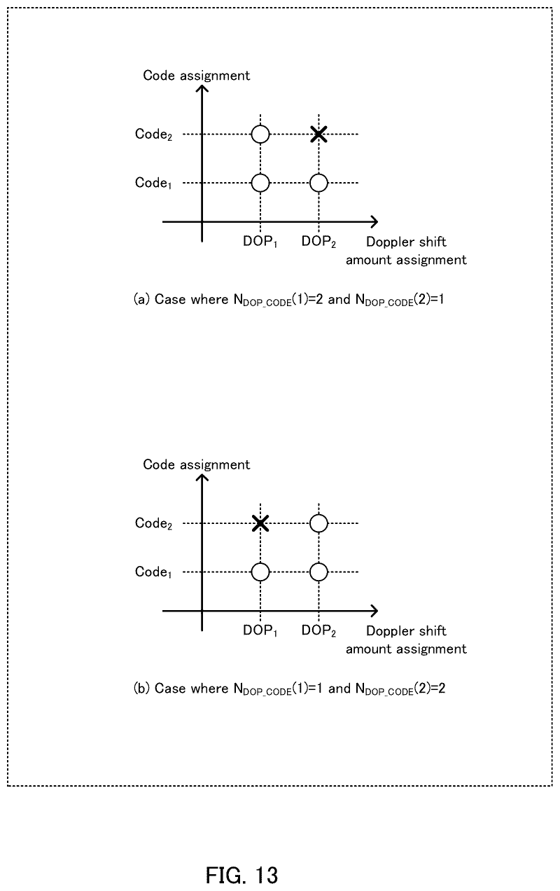

Here, by way of example, a description will be given of a case where Nt is 3, number N_{DM} of Doppler multiplexing is 2, and number N_{CM} of code multiplexing is 2. Here, phase rotation amount φ_{ndm} for applying Doppler shift amount DOP_{ndm} is assigned, for example, as given by Expression 5 that is based on the maximum equal-interval Doppler shift amount configuration. In this case, phase rotation amount (1 for applying Doppler shift amount DOP₁ is 0, and, phase rotation amount φ₂ for applying Doppler shift amount DOP₂ is Rt. In addition, encoder 107 uses two orthogonal codes Code₁={1, 1} and Code₂={j, −j} having a code length Loc of 2. Further, as illustrated at (a) in FIG. 13, N_{DOP_CODE}(1)=2 and N_{DOP_CODE}(2)=1 are used.

In this case, with respect to the Doppler range of 1/(2Loc×N_{DM}×Tr)=±1/(8Tr) in which no aliasing due to the coded Doppler multiplexing occurs, coded Doppler demultiplexer 212 performs the aliasing judgement processing assuming the Doppler range of ±1/(2Tr) resulting from multiplication of the Doppler range of ±1/(2Loc×N_{DM}×Tr)=1/(8Tr) by 4 (=Loc×N_{DM}).

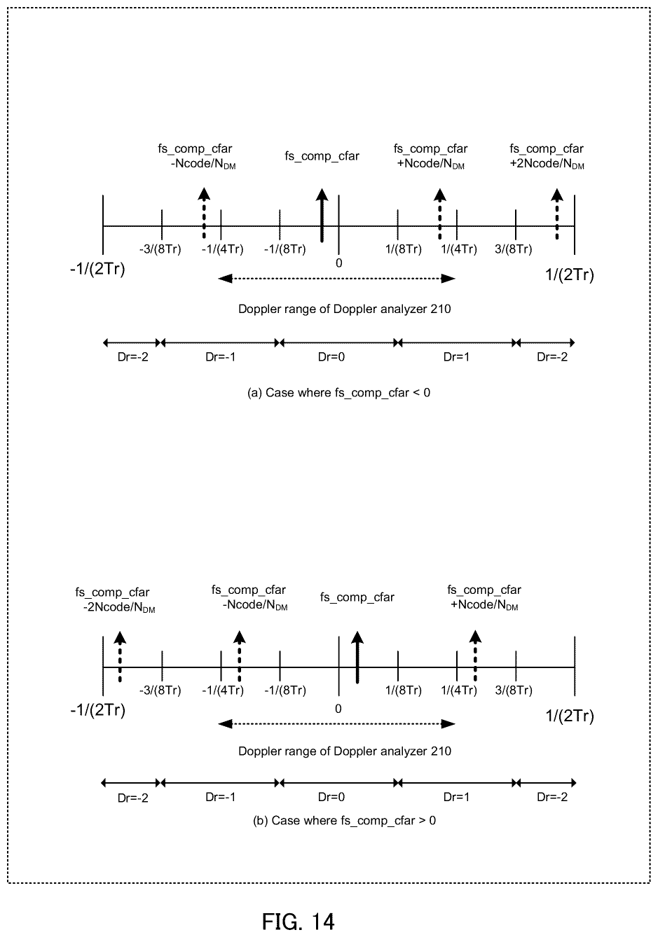

Here, Doppler component VFT_{z}^{noc} (f_{b_cfar}, f_{s_comp_cfar}), which is the output of Doppler analyzer 210 corresponding to distance index f_{b_cfar} and Doppler frequency index f_{s_comp_cfar} extracted in CFAR section 211, may contain a Doppler component including aliasing as illustrated at (a) and (b) in FIG. 14, for example, in the Doppler Range of ±1/(2Tr).

For example, as illustrated in (a) of FIG. 14, when f_{s_comp_cfar}<0, there is a possibility of 4 (=Loc×N_{DM}) Doppler components of f_{s_comp_cfar}−Ncode/N_{DM}, f_{s_comp_cfar}, f_{s_comp_cfar}+Ncode/N_{DM}, and f_{s_comp_car}+2Ncode/N_{DM} in the Doppler range of 1/(2Tr) (the components may also be referred to as f_{s_comp_cfar}−ΔFD, f_{s_comp_cfar}, f_{s_comp_cfar}+ΔFD, and f_{s_comp_cfar}+2ΔFD, respectively, by using ΔFD=Ncode/N_{DM}).

Further, for example, as illustrated at (b) in FIG. 14, there is a possibility of four (Loc×N_{DM}) Doppler components of f_{s_comp_cfar}−2Ncode/N_{DM}, f_{s_comp_cfar}−Ncode/N_{DM}, f_{s_comp_cfar}, and f_{s_comp_cfar}×Ncode/N_{DM} in the case of f_{s_comp_cfar}>0 within the Doppler range of ±1/(2Tr) (the Doppler components may also be expressed using ΔFD=Ncode/N_{DM} as f_{s_comp_cfar}−2ΔFD, f_{s_comp_cfar}−ΔFD, f_{s_comp_cfar}, and f_{s_comp_cfar}+ΔFD). These possible Doppler components (four (=Loc×N_{DM}) components) with respect to f_{s_comp_cfar} are called “Doppler component candidates” with respect to f_{s_comp_cfar}. In the following, Doppler regions in which such four (=Loc×N_{DM}) Doppler component candidates are present are represented using index “Dᵣ” indicating the Doppler aliasing range as illustrated in FIG. 14. Dᵣ is an index indicating the Doppler aliasing range, and for example, an integer value in a range of Dᵣ ∈{−ceil(Loc×N_{DM}/2), . . . , ceil(Loc×N_{DM}/2)−1} is used. In FIG. 14, Dᵣ=−2 to 1. Note that, the region where Dᵣ=0 indicates the region where no Doppler aliasing occurs, and the regions where Dᵣ≠0 indicate the regions where Doppler aliasing occurs. Further, the greater the absolute value of Dᵣ, the more distant the Doppler region is from the Doppler region indicated by Dᵣ=0.

Coded Doppler demultiplexer 212 corrects phase changes corresponding to the four (=Loc×N_{DM}) Doppler components including aliasing within the Doppler range of ±1/(2Tr) as illustrated in FIG. 14, and performs the coded Doppler demultiplexing processing on the coded Doppler multiplexed signal for which the number of coded Doppler multiplexing is set smaller than N_{CM} (for example, the unused coded Doppler multiplexed signal).

Then, based on the received power of components obtained by the coded Doppler demultiplexing processing on the unused coded Doppler multiplexed signal, coded Doppler demultiplexer 212 judges whether or not each of the Doppler component candidates is a true Doppler component.

For example, coded Doppler demultiplexer 212 may detect, among the Doppler component candidates with respect to f_{s_comp_cfar}, a Doppler component having the minimum received power obtained by the coded Doppler demultiplexing processing based on the unused coded Doppler multiplexed signal, to judge that the detected Doppler component is the true Doppler component. For example, coded Doppler demultiplexer 212 may judge that those of the Doppler component candidates with respect to f_{s_comp_cfar} which have received powers different from the minimum received power are false Doppler components.

This aliasing judgement processing can resolve the ambiguity in the Doppler range of ±1/(2Tr). In addition, by this aliasing judgement processing, the range in which a Doppler frequency can be detected without ambiguity can be extended to a range of from −1/(2Tr) to less than 1/(2Tr) as compared with the Doppler range of ±1/(2Loc×N_{DM}×Tr)=±1/(8Tr) in which aliasing due to Doppler multiplexing does not occur.

By the coded Doppler demultiplexing based on the unused coded Doppler multiplexed signal, for example, the phase change of the true Doppler component is corrected and the orthogonality between the coded Doppler multiplexed signals used for multiplexing transmission and the unused coded Doppler multiplexed signal is maintained. Therefore, the coded Doppler multiplexed signal codes used for multiplexing transmission and the unused coded Doppler multiplexed signal become uncorrelated, and the received power becomes as low as a noise level.

On the other hand, the phase changes of false Doppler components are, for example, erroneously corrected and the orthogonality between the coded Doppler multiplexed signals used for multiplexing transmission and the unused coded Doppler multiplexed signal is not maintained. Thus, a correlated component (interference component) is caused between the coded Doppler multiplexed signal codes used for the multiplexing transmission and the unused coded Doppler multiplexed signal, and, for example, a received power greater than a noise level may be detected. Therefore, as described above, coded Doppler demultiplexer 212 may judge that the Doppler component having the minimum received power among the Doppler component candidates with respect to f_{s_comp_cfar} resulting from the coded Doppler demultiplexing based on the unused coded Doppler multiplexed signal is the true Doppler component, and judge that the other Doppler components having the received powers different from the minimum received power are the false Doppler components.

For example, coded Doppler demultiplexer 212 corrects the phase changes corresponding to the Doppler components of the Doppler component candidates with respect to f_{s_comp_cfar} based on the outputs of Doppler analyzers 210 in each antenna system processor 201, and calculates, according to Expression 42, received power PDAR(f_{b_cfar}, f_{s_comp_cfar}, Dᵣ, nuc, nud) after the code separation using the unused coded Doppler multiplexed signal.

Here, nuc and nud represent an index of an orthogonal code serving as the unused coded Doppler multiplexed signal and an index of the Doppler multiplexed signal, respectively. For example, in the case of (b) of FIG. 13, the unused coded Doppler multiplexed signal is indicated by a cross mark in the figure, is assigned the code of Code₂, and is assigned the Doppler shift amount of DOP₁. Accordingly, indices nuc and nud of the orthogonal code to which the unused coded Doppler multiplexed signal is assigned are 2 and 1, respectively.

In the following, a pair of the index of the orthogonal code and the index of the Doppler multiplexed signal that are used for the coded Doppler multiplexed signal is described as “DCI (index of orthogonal code, index of Doppler multiplexed signal).” DCI (nuc, nud) represents, for example, the index of an orthogonal code to which an unused coded Doppler multiplexed signal is assigned and the index of a Doppler multiplexed signal. For example, in the case of (b) in FIG. 13, the unused coded Doppler multiplexed signal is assigned to DCI (2, 1). Similarly, for example, in the case of (a) in FIG. 4, the unused coded Doppler multiplexed signal is assigned to DCI (2, 3) and DCI (2, 4).

$$[ 44 ]$$

$${P}_{DAR} ( {f}_{{b}_{cfar}} , {f}_{{s}_{{comp}_{cfar}}} , {D}_{r} , nuc , nud ) = \qquad ( Expression 42 )$$

$${\sum }_{z = 1}^{{N}_{a}} {\vert {Y}_{z} ( {f}_{{b}_{cfar}} , {f}_{{s}_{{comp}_{cfar}}} , {D}_{r} , nuc , nud ) \vert}^{2}$$

Here, Y_{z}(f_{b_cfar}, f_{s_comp_cfar}, Dᵣ, nuc, nud) is a received signal obtained by correction of the phase changes corresponding to the Doppler components of Doppler component candidates with respect to f_{s_comp_cfar} and separation of the unused coded Doppler multiplexed signal to which DCI (nuc, nud) is assigned. The correction and separation are based on the outputs of Doppler analyzers 210 in zth antenna system processor 201 as given by following Expression 43:

$$[ 45 ]$$

$${Y}_{z} ( {f}_{b \_ cfar} , {f}_{s \_ comp \_ cfar} , {D}_{r} , nuc , nud ) = \qquad ( Expression 43 )$$

$${Code}_{nuc}^{*} \{ α ( {f}_{s \_ comp \_ cfar} , {D}_{r} ) ⊗ {VFTALL}_{z} ( {f}_{b \_ cfar} , {f}_{s \_ comp \_ cfar} , {D}_{r} , nud )$$

In Expressions 42 and 43, in order to separate the unused coded Doppler multiplexed signal to which DCI (nuc, nud) is assigned, the received powers after code separation using unused orthogonal code Code_{nuc} are calculated with respect to outputs VFTALL_{z}(f_{b_cfar}, f_{s_comp_cfar}, Dᵣ, nud) of Doppler analyzers 210 in zth antenna system processor 201, and the sum of such powers is calculated with respect to all the antenna system processors 201. Thus, it is possible to increase the aliasing judgement accuracy even when the received signal level is low. However, instead of Expression 42, the received powers after code separation using the unused coded Doppler multiplexed signal may be calculated with respect to the outputs of Doppler analyzers 210 in some of antenna system processors 201. Even in this case, it is possible to reduce the arithmetic processing amount while maintaining the aliasing judgement accuracy, for example, in a range where the received signal level is sufficiently high.

Note that, in Expressions 42 and 43, Dᵣ is an index indicating the Doppler aliasing range, and takes an integer value in a range of Dᵣ ∈{−ceil(Loc×N_{DM}/2), . . . , ceil(Loc×N_{DM}/2)−1}, for example.

Further, in Expression 43,

operator “⊗” [46]

represents a product between elements of vectors having the same number of elements. For example, for nth order vectors A=[a₁, . . . , aₙ] and B=[b₁, . . . , bₙ], the product between the elements is expressed by following Expression 44:

$$[ 47 ]$$

$$A ⊗ B = [ {a}_{1} , … , {a}_{n} ] ⊗ [ {b}_{1} , … , {b}_{n} ] = [ {a}_{1} {b}_{1} , … , {a}_{n} {b}_{n} ] \qquad ( Expression 44 )$$

Moreover, in Expression 43, superscript “T” represents vector transposition, and superscript “*” (asterisk) represents a complex conjugate operator.

In Expression 43, α(f_{s_comp_cfar}, Dᵣ) represents “Doppler phase correction vector.” Doppler phase correction vector α(f_{s_comp_cfar}, Dᵣ) corrects the Doppler phase rotation caused by a time difference between Doppler analyses of Loc Doppler analyzers 210 within Doppler aliasing range Dᵣ when Doppler frequency index f_{s_comp_cfar} extracted in CFAR section 211 is in an output range (for example, Doppler range) of Doppler analyzers 210 that does not include Doppler aliasing, for example.

For example, Doppler phase correction vector α(f_{s_comp_cfar}, Dᵣ) is expressed by following Expression 45. For example, Doppler phase correction vector α(f_{s_comp_cfar}, Dᵣ) as given by Expression 45 is a vector having, as an element, a Doppler phase correction factor. The Doppler phase correction factor corrects phase rotations of Doppler components having Doppler frequency indices f_{s_comp_cfar} and being within Doppler aliasing range Dᵣ. The phase rotations are caused by the time lags of Tr, 2Tr, . . . , (Loc−1)Tr of the outputs of from output VFT_{z}²(f_{b_cfar}, f_{s_comp_cfar}) of second Doppler analyzer 210 to Locth Doppler analyzer VFT_{z}^{Loc}(f_{b_cfar}, f_{s_comp_cfar}), for example, with reference to the Doppler analysis time for analysis on output VFT_{z}¹(f_{b_cfar}, f_{s_comp_cfar}) of first Doppler analyzer 210. Note that the term of DᵣN_{code}/N_{DM} in Expression 45 can also be expressed as DᵣΔFD by using ΔFD=Ncode/N_{DM}. Therefore, the expression is applicable in the other cases than the case of ΔFD=Ncode/N_{DM}.

$$[ 48 ]$$

$$α ( {f}_{{s}_{{comp}_{cfar}}} , {D}_{r} ) = \qquad ( Expression 45 )$$

$${[ 1 , exp ( - \frac{j 2 π ( {f}_{s \_ comp \_ cfar} + \frac{{D}_{r} {N}_{code}}{{N}_{DM}} )}{{N}_{code}} \times \frac{1}{{L}_{oc}} ) , … , \\ exp ( - \frac{j 2 π ( {f}_{s \_ comp \_ cfar} + \frac{{D}_{r} {N}_{code}}{{N}_{DM}}}{{N}_{code}} \times \frac{( {L}_{oc} - 1 )}{{L}_{oc}} ) ]}^{T}$$

The phase correction by the Doppler phase correction vector α (f_{s_comp_cfar}, Dr) corresponds to correcting the phase change corresponding to the Doppler components in the Doppler component candidates for the f_{s_comp_cfar}.

Further, for example, as given by following Expression 43, VFTALL_{z}(f_{b_cfar}, f_{s_comp_cfar}, Dᵣ, nud) in Expression 46 represents, in a vector format, components of a Doppler multiplexed signal of an unused coded Doppler multiplexed signal to which DCI (nuc, nud) is assigned. The components are extracted within Doppler aliasing range Dᵣ. The unused coded Doppler multiplexed signal corresponds to distance index f_{b_cfar} and Doppler frequency index f_{s_comp_cfar} extracted in CFAR section 211 among outputs VFT_{z}^{noc} (f_{b}, fₛ) of Loc Doppler analyzers 210 in zth antenna system processor 201. Here, noc=1, . . . , Loc and noc takes an integer value in the range of Dᵣ={-ceil(Loc×N_{DM}/2), . . . , ceil(Loc×N_{DM}/2) −1}.

$$[ 49 ]$$

$${VFTALL}_{z} ( {f}_{b \_ cfar} , {f}_{s \_ comp \_ cfar} , {D}_{r} , nud ) = \qquad ( Expression 46 )$$

$$[ {VFT}_{z}^{1} ( {f}_{{b}_{cfar}} , {f}_{{s}_{{comp}_{cfar}}} +$$

$${\frac{{N}_{code} {F}_{R} ( {D}_{r} , nud )}{{N}_{DM}} ) … {VFT}_{z}^{{L}_{oc}} ( {f}_{{b}_{cfar}} , {f}_{{s}_{{comp}_{cfar}}} + \frac{{N}_{code} {F}_{R} ( {D}_{r} , nud )}{{N}_{DM}} ) ]}^{T}$$

In Expression 46, N_{code}F_{R}(Dᵣ, nud)/N_{DM} represents an offset value of the Doppler index of the nudth Doppler multiplexed signal with respect to f_{s_comp_cfar} within Doppler aliasing range Dᵣ. Note that, the term “N_{code}F_{R}(Dᵣ, nud)/N_{DM}” in Expression 46 can also be expressed as F_{R}(Dᵣ, nud)ΔFD using ΔFD=Ncode/N_{DM}. Therefore, the expression is applicable in the other cases than the case of ΔFD=Ncode/N_{DM}. Here, ndm=1 to N_{DM}.

F_{R}(Dᵣ, nud) can be configured in advance when Doppler aliasing range Dᵣ and phase rotation amounts φ₁, φ₂, . . . , and φ_{N_DM} for applying Doppler shift amounts DOP₁, DOP₂, . . . , and DOP_{N_DM} are determined. Therefore, for example, coded Doppler demultiplexer 212 may tabulate the correspondence between, on one hand, Doppler aliasing range Dᵣ and the phase rotation amounts and, on the other hand, F_{R}(Dᵣ, nud) and read F_{R}(Dᵣ, nud) based on Doppler aliasing range Dᵣ and a phase rotation amount. Further, for example, when phase rotation amounts φ₁, φ₂, . . . , and φ_{N_DM} for applying Doppler shift amounts DOP₁, DOP₂, . . . , and DOP_{N_DM} satisfy −π≤φ₁<φ₂< . . . <φ_{N_DM}<π, F_{R}(Dᵣ, nud) can be expressed as in following Expression 47:

$$[ 50 ]$$

$${F}_{R} ( {D}_{r} , nud ) = mod ( nud - 1 - {D}_{r} , {N}_{DM} ) - ceil ( \frac{{N}_{DM}}{2} ) . \qquad ( Expression 47 )$$

For example, in accordance with Expressions 42 and 43, coded Doppler demultiplexer 212 calculates, within each range of Dᵣ ∈{−ceil(Loc×N_{DM}/2), . . . , ceil(Loc×N_{DM}/2)−1}, received power P_{DAR}(f_{b_cfar}, f_{s_comp_cfar}, Dᵣ, nuc, nud) after code separation using the unused coded Doppler multiplexed signal to which DCI (nuc, nud) is assigned.

Then, coded Doppler demultiplexer 212 detects a Dᵣ in which received power P_{DAR}(f_{b_cfar}, f_{s_comp_cfar}, Dᵣ, nuc, nud) is minimized among the ranges of Dᵣ. In the following, Dᵣ in which received power P_{DAR}(f_{b_cfar}, f_{s_comp_cfar}, Dᵣ, nuc, nud) is minimized among the ranges of Dᵣ as given by following Expression 48 is referred to as “Dᵣₘᵢₙ”:

$$[ 51 ]$$

$${D}_{rmin} = \{ arg {D}_{r} \vert {min}_{{D}_{r}} {P}_{DAR} ( {f}_{b \_ cfar} , {f}_{s \_ comp \_ cfar} , {D}_{r} , nuc , nud ) \} \qquad ( Expression 48 )$$

Note that when there are a plurality of unused coded Doppler multiplexed signals, coded Doppler demultiplexer 212 may use received power Pall_{DAR}(f_{b_cfar}, f_{s_comp_cfar}, Dᵣ) after code separation using all unused orthogonal codes as given by following Expression 49, instead of received power P_{DAR}(f_{b_cfar}, f_{s_comp_cfar}, Dᵣ, nuc, nud):

$$[ 52 ]$$

$${Pall}_{DAR} ( {f}_{b \_ cfar} , {f}_{s \_ comp \_ cfar} , {D}_{r} ) = {\sum }_{nuc , nud} {P}_{DAR} ( {f}_{b \_ cfar} , {f}_{s \_ comp \_ cfar} , {D}_{r} , nuc , nud ) . \qquad ( Expression 49 )$$

Obtaining the received power after code separation using all the unused orthogonal codes makes it possible to increase the accuracy of the aliasing judgement by the aliasing processing even when the reception signal level is low.

For example, coded Doppler demultiplexer 212 calculates Pall_{DAR}(f_{b_cfar}, f_{s_comp_cfar}, Dᵣ) in each range of Dᵣ ∈{−ceil(Loc×N_{DM}/2), . . . , ceil(Loc×N_{DM}/2)−1}, and detects Dᵣ (in other words, Dᵣₘᵢₙ) in which Pall_{DAR}(f_{b_cfar}, f_{s_comp_cfar}, Dᵣ) is minimized. For example, when Expression 49 is used, Dᵣ which provides the minimum received power among the ranges of Dᵣ is represented as “Dᵣₘᵢₙ” as given by following Expression 50:

$$[ 53 ]$$

$${D}_{rmin} = \{ arg {D}_{r} \vert {min}_{{D}_{r}} {Pall}_{DAR} ( {f}_{b \_ cfar} , {f}_{s \_ comp \_ cfar} , {D}_{r} ) \} . \qquad ( Expression 50 )$$

Further, coded Doppler demultiplexer 212 may perform processing for judging (in other words, measuring) the accuracy of the aliasing judgement, for example, by comparing minimum received power Pall_{DAR}(f_{b_cfar}, f_{s_comp_cfar}, Dᵣₘᵢₙ) after code separation using the unused coded Doppler multiplexed signal to which DCI (nuc, nud) is assigned, on the one hand, and received power PowerFT_comp(f_{b_cfar}, f_{s_comp_cfar}) of Expression 41 obtained in CFAR section 211 by performing power addition while adjusting peak positions of Doppler-shift multiplexed signals, on the other hand. In this case, coded Doppler demultiplexer 212 may judge the accuracy of the aliasing judgement in accordance with following Expressions 51 and 52, for example:

$$[ 54 ]$$

$${Pall}_{DAR} ( {f}_{b \_ cfar} , {f}_{s \_ comp \_ cfar} , {D}_{rmin} ) < {Threshold}_{DR} \times PowerFT\_comp ( {f}_{b \_ cfar} , {f}_{s \_ comp \_ cfar} ) . \qquad ( Expression 51 )$$

$$[ 55 ]$$

$${Pall}_{DAR} ( {f}_{b \_ cfar} , {f}_{s \_ comp \_ cfar} , {D}_{rmin} ) \geq {Threshold}_{DR} \times PowerFT\_comp ( {f}_{b \_ cfar} , {f}_{s \_ comp \_ cfar} ) . \qquad ( Expression 52 )$$

For example, when minimum received power Pall_{DAR}(f_{b_cfar}, f_{s_comp_cfar}, D_{rMin}) after code separation using the unused coded Doppler multiplexed signal to which DCI (nuc, nud) is assigned is smaller than the value obtained by multiplying, by predetermined value Threshold_{DR}, PowerFT_comp(f_{b}, and f_{s_comp_cfar}) for distance index f_{b_cfar} and Doppler frequency index f_{s_comp_cfar} extracted in CFAR section 211 (for example, Expression 51), coded Doppler demultiplexer 212 judges that the aliasing judgement is sufficiently accurate. In this case, radar apparatus 10 may perform, for example, subsequent processing (e.g., code separation processing).

On the other hand, for example, when minimum received power Pall_{DAR}(f_{b_cfar}, f_{s_comp_cfar}, Dᵣₘᵢₙ) after code separation using the unused coded Doppler multiplexed signal to which DCI (nuc, nud) is assigned is equal to or larger than the value obtained by multiplying PowerFT_comp(f_{b}, f_{s_comp_cfar}) by Threshold_{DR} (for example, Expression 52), coded Doppler demultiplexer 212 judges that the accuracy of the aliasing judgement is not sufficient and the reliability of the aliasing judgement is low (for example, noise component). In this case, for example, radar apparatus 10 may not perform subsequent processing (e.g., code separation processing).

Such processing makes it possible to reduce a judgement error in aliasing judgement and to remove a noise component. Note that, predetermined value Threshold_{DR} may, for example, be set within a range of from 0 to less than 1. By way of example, considering inclusion of a noise component, Threshold_{DR} may be set in a range of approximately from 0.1 to 0.5.

The operation example of the aliasing processing has been described above.

### <(2) Doppler Code Separation Processing on Coded Doppler Multiplexed Signal Used for Multiplexing Transmission>

Coded Doppler demultiplexer 212 performs coded Doppler demultiplexing processing on a coded Doppler multiplexed signal used for multiplexing transmission based on an aliasing judgement result.

For example, as given by following Expression 53, coded Doppler demultiplexer 212 applies Expression 43 based on Dᵣₘᵢₙ that is a result of aliasing judgement in aliasing judgement processing, so as to separate and receive the coded Doppler multiplexed signal to which DCI (ncm, ndm) used for multiplexing transmission is assigned. For example, coded Doppler demultiplexer 212 performs the separation processing using following Expression 53 to separate and receive the coded Doppler multiplexed signal to which DCI (ncm, ndm) used for the multiplexing transmission is assigned. Since by the aliasing judgement processing it is possible to judge an index (Dᵣₜᵣᵤₑ) that is a true Doppler aliasing range within the Doppler range of from −1/(2Tr) to less than 1/(2Tr) (for example, it is possible to judge an index such that Dᵣₘᵢₙ=Dᵣₜᵣᵤₑ), it becomes possible for coded Doppler demultiplexer 212 to set, to zero, the correlation value between the orthogonal codes used for code multiplexing in the Doppler range of from −1/(2Tr) to less than 1/(2Tr), so as to perform the separation processing in which the interference between the code multiplexed signals is suppressed.

$$[ 56 ]$$

$${Y}_{z} ( {f}_{b \_ cfar} , {f}_{s \_ comp \_ cfar} , {D}_{rmin} , ncm , ndm ) = {Code}_{ncm}^{*} \{ α ( {f}_{s \_ comp \_ cfar} , {D}_{rmin} ) ⊗ {VFTALL}_{z} ( {f}_{b \_ cfar} , {f}_{s \_ comp \_ cfar} , {D}_{rmin} , ndm ) . \qquad ( Expression 53 )$$

Here, Y_{z}(f_{b_cfar}, f_{s_comp_cfar}, Dᵣₘᵢₙ, ncm, ndm) is an output (for example, coded Doppler demultiplexing result) resulting from code separation of the code multiplexed signal using orthogonal code Code_{ncm} with respect to ndmth coded Doppler multiplexed signal VFTALL_{z}(f_{b_cfar}, f_{s_comp_cfar}, Dᵣₘᵢₙ, ndm) in Doppler range Dᵣₘᵢₙ among the outputs of distance indices f_{b_cfar} and Doppler frequency indices f_{s_comp_cfar} of Doppler analyzers 210 in zth antenna system processor 201. It is possible to separate the coded Doppler multiplexed signal to which DCI (ncm, ndm) used for the multiplexing transmission is assigned. Note that z=1 to Na, and ncm=1 to N_{CM}.

Through the code separation processing as described above, radar apparatus 10 can separate and receive the coded Doppler multiplexed signal to which DCI (ncm, ndm) used for the multiplexing transmission is assigned. The separation and reception are based on the result of the aliasing judgement performed by Doppler analyzers 210 assuming a Doppler range of ±1/(2Tr) that is greater by a factor of Loc than the Doppler range of ±1/(2Loc×Tr) in which no aliasing occurs.

Further, since the coded Doppler multiplexed signal to which DCI (ncm, ndm) is assigned is transmitted from transmission antenna Tx #[ncm, ndm], it is also possible to judge transmission antenna 109. For example, radar apparatus 10 can separate and receive the coded Doppler multiplexed signal which is transmitted from transmission antenna Tx #[ncm, ndm] and to which DCI (ncm, ndm) is assigned.

In addition, for example, during coded Doppler demultiplexing processing, radar apparatus 10 performs, on the outputs of Doppler analyzers 210 for each code element, Doppler phase correction, for example, based on Doppler phase correction vector α(f_{s_comp_cfar}, Dᵣ) taking into consideration Doppler aliasing. Such phase correction corresponds to correcting phase changes corresponding to Doppler components among the Doppler component candidates with respect to f_{s_comp_cfar}. Mutual interference between code multiplexed signals can thus be reduced, for example, as low as a noise level. For example, radar apparatus 10 can reduce inter-code interference to suppress an effect on degradation of the detection performance of radar apparatus 10.

The foregoing description has been given of an example of the operation of coded Doppler demultiplexer 212.

In FIG. 1, Doppler demultiplexers 213 include, for example, Doppler demultiplexers 213-1 to 213-Loc corresponding respectively to the outputs of Loc Doppler analyzers 210. In the exemplary embodiment illustrated in FIG. 1, Loc=2, and first Doppler demultiplexer 213 (or Doppler demultiplexer 213-1) and second Doppler demultiplexer 213 (or Doppler demultiplexer 213-2) may be provided.

First Doppler demultiplexer 213 outputs, to direction estimator 214, the output of first Doppler analyzer 210 (or referred to as Doppler analyzer 210-1) for distance index f_{b_cfar} and Doppler frequency index f_{s_comp_cfar} inputted from CFAR section 211. At this time, first Doppler demultiplexer 213 may use, for example, Dᵣₘᵢₙ that is a Doppler aliasing judgement result inputted from coded Doppler demultiplexer 212.

For example, in the example illustrated in FIG. 1, first Doppler demultiplexer 213 outputs output VFT_{z}¹(f_{b_cfar}, f_{s_comp_cfar}+(N_{code}F_{R}(Dᵣₘᵢₙ, ndm__{BF})/N_{DM})) of first Doppler analyzer 210 (Doppler analyzer 210-1) to direction estimator 214. Here, ndm_B_{F} is any one of 1 to N_{DM}, and a plurality of transmission antennas 109 to which the ndm_B_{F}th Doppler multiplexed signal is assigned are a combination of transmission antennas 109 that satisfies the condition of the adjacent arrangement described above, for example.

For example, first Doppler demultiplexer 213 demultiplexes a circularly polarized signal using the output of first Doppler analyzer 210. Thus, first Doppler demultiplexer 213 obtains a reception signal of a reflected wave of a transmission signal that is circularly polarized. Note that z=1 to Na.

Further, in FIG. 1, second Doppler demultiplexer 213 outputs, to direction estimator 214, the output of second Doppler analyzer 210 (or referred to as Doppler analyzer 210-2) for distance index f_{b_cfar} and Doppler frequency index f_{s_comp_cfar} inputted from CFAR section 211. At this time, second Doppler demultiplexer 213 may use, for example, Dᵣₘᵢₙ that is a Doppler aliasing judgement result inputted from coded Doppler demultiplexer 212.

For example, in the example illustrated in FIG. 1, second Doppler demultiplexer 213 outputs output VFT_{z}²(f_{b_cfar}, f_{s_comp_cfar}+(N_{code}F_{R}(Dᵣₘᵢₙ, ndm__{BF})/N_{DM})) of second Doppler analyzer 210 (Doppler analyzer 210-2) to direction estimator 214. Here, ndm__{BF} is any one of 1 to N_{DM}, and a plurality of transmission antennas 109 to which the ndm__{BF}-th Doppler multiplexed signal is assigned are a combination of transmission antennas 109 that satisfies the condition of the adjacent arrangement described above, for example.

For example, second Doppler demultiplexer 213 demultiplexes a circularly polarized signal using the output of second Doppler analyzer 210. Thus, second Doppler demultiplexer 213 obtains a reception signal of a reflected wave of a transmission signal that is circularly polarized. Note that z=1 to Na.

In addition, differently from the output of first Doppler demultiplexer 213, which is the reception signal of the reflected wave of the transmission signal that is circularly polarized, second Doppler demultiplexer 213 treats a reception signal of a reflected wave corresponding to a transmission signal that is circularly polarized in a rotation direction different from the rotation direction of the circular polarization corresponding to the output of first Doppler demultiplexer 213. For example, when the circular polarization corresponding to the output of first Doppler demultiplexer 213 is a left-handed circular polarization, the circular polarization corresponding to the output of second Doppler demultiplexer 213 is a right-handed circular polarization. Further, for example, when the circular polarization corresponding to the output of first Doppler demultiplexer 213 is a right-handed circular polarization, the circular polarization corresponding to the output of second Doppler demultiplexer 213 is a left-handed circular polarization.

Hereinafter, the circular polarization corresponding to the output of first Doppler demultiplexer 213 is referred to as “circular polarization of forward rotation” as a reference rotation of the circular polarization. The circular polarization corresponding to the output of second Doppler demultiplexer 213 is in the reverse rotation of the circular polarization of the forward rotation and is thus referred to as “circular polarization of reverse rotation.”

In FIG. 1, based on Doppler aliasing judgement result Dᵣₘᵢₙ for distance index f_{b_cfar} and Doppler frequency index f_{s_comp_cfar} inputted from coded Doppler demultiplexer 212, direction estimator 214 performs direction estimation processing for estimation of the direction of a target (hereinafter, referred to as “direction estimation processing with respect to linear polarization”) based on separated received signal Y_{z}(f_{b_car}, f_{s_comp_cfar}, Dᵣₘᵢₙ, ncm, ndm) of the coded Doppler multiplexed signal to which DCI (ncm, ndm) is assigned and which is transmitted from transmission antenna Tx #[ncm, ndm].

Further, direction estimator 214 performs the target direction estimation processing (hereinafter, referred to as “direction estimation processing with respect to forward circular polarization”) based on the output from first Doppler analyzer 210 (in FIG. 1, Doppler analyzer 210-1) input from first Doppler demultiplexer 213.

Further, direction estimator 214 performs the target direction estimation processing (hereinafter, referred to as “direction estimation processing with respect to reverse circular polarization”) based on the output from second Doppler analyzer 210 (in FIG. 1, Doppler analyzer 210-2) input from second Doppler demultiplexer 213.

The direction estimation processing in direction estimator 214 may include, for example, the direction estimation processing with respect to linear polarization, direction estimation processing with respect to forward circular polarization, and direction estimation processing with respect to reverse circular polarization. Hereinafter, each types of direction estimation processing will be described.

<Direction Estimation Processing with Respect to Linear Polarization>

For example, direction estimator 214 generates, based on the outputs of coded Doppler demultiplexer 212, virtual reception array correlation vector h(f_{b_car}, f_{s_comp_cfar}) given by following Expression 54 and performs the direction estimation processing.

Virtual reception array correlation vector h(f_{b_car}, f_{s_comp_cfar}) includes Nt×Na elements, the number of which is the product of number Nt of transmission antennas and number Na of reception antennas.

$$[ 57 ]$$

$$( Expression 54 )$$

$$h ( {f}_{b \_ cfar} , {f}_{s \_ comp \_ cfar} ) = [ \begin{matrix}{Y}_{1} ( {f}_{b \_ cfar} , {f}_{s \_ comp \_ cfar} , {D}_{rmin} , 1 , 1 ) \\ {Y}_{2} ( {f}_{b \_ cfar} , {f}_{s \_ comp \_ cfar} , {D}_{rmin} , 1 , 1 ) \\ ⋮ \\ {Y}_{Na} ( {f}_{b \_ cfar} , {f}_{s \_ comp \_ cfar} , {D}_{rmin} , 1 , 1 ) \\ ⋮ \\ \begin{matrix}{Y}_{1} ( {f}_{b \_ cfar} , {f}_{s \_ comp \_ cfar} , {D}_{rmin} , \\ {N}_{DOP \_ CODE ( 1 )} , 1 )\end{matrix} \\ \begin{matrix}{Y}_{2} ( {f}_{b \_ cfar} , {f}_{s \_ comp \_ cfar} , {D}_{rmin} , \\ {N}_{DOP \_ CODE ( 1 )} , 1 )\end{matrix} \\ ⋮ \\ \begin{matrix}{Y}_{Na} ( {f}_{b \_ cfar} , {f}_{s \_ comp \_ cfar} , {D}_{rmin} , \\ {N}_{DOP \_ CODE ( 1 )} , 1 )\end{matrix} \\ ⋮ \\ \begin{matrix}{Y}_{1} ( {f}_{b \_ cfar} , {f}_{s \_ comp \_ cfar} , \\ {D}_{rmin} , 1 , {N}_{DM} )\end{matrix} \\ \begin{matrix}{Y}_{2} ( {f}_{b \_ cfar} , {f}_{s \_ comp \_ cfar} , \\ {D}_{rmin} , 1 , {N}_{DM} )\end{matrix} \\ ⋮ \\ \begin{matrix}{Y}_{Na} ( {f}_{b \_ cfar} , {f}_{s \_ comp \_ cfar} , \\ {D}_{rmin} , 1 , {N}_{DM} )\end{matrix} \\ ⋮ \\ \begin{matrix}{Y}_{1} ( {f}_{b \_ cfar} , {f}_{s \_ comp \_ cfar} , {D}_{rmin} , \\ {N}_{DOP \_ CODE ( {N}_{DM} )} , {N}_{DM} )\end{matrix} \\ \begin{matrix}{Y}_{2} ( {f}_{b \_ cfar} , {f}_{s \_ comp \_ cfar} , {D}_{rmin} , \\ {N}_{DOP \_ CODE ( {N}_{DM} )} , {N}_{DM} )\end{matrix} \\ ⋮ \\ \begin{matrix}{Y}_{Na} ( {f}_{b \_ cfar} , {f}_{s \_ comp \_ cfar} , {D}_{rmin} , \\ {N}_{DOP \_ CODE ( {N}_{DM} )} , {N}_{DM} )\end{matrix}\end{matrix} ]$$

Based on phase differences between reception antennas 202, direction estimator 214 performs a process of performing direction estimation on the reflected wave signals from a target using virtual reception array correlation vector h(f_{b_cfar}, f_{s_comp_cfar}).

Here, virtual reception array correlation vector h(f_{b_cfar}, f_{s_comp_cfar}) includes reflected wave reception signals of signals transmitted from differently linearly polarized antennas (e.g., vertically polarized antennas and horizontally polarized antennas). Therefore, direction estimator 214 may extract, from virtual reception array correlation vector h(f_{b_cfar}, f_{s_comp_cfar}), elements that are combinations of the polarization of a predetermined transmission antenna 109 and the polarization of reception antenna 202, and perform the direction estimation processing using the virtual reception array correlation vector composed of the extracted elements. It is thus possible to obtain a direction estimation result per polarization of predetermined transmission antenna 109 and polarization of reception antenna 202.

<Direction Estimation Processing with Respect to Forward Circular Polarization>

Direction estimator 214 generates forward-circularly-polarized virtual reception array correlation vector h_{c1}(f_{b_cfar}, f_{s_comp_cfar}) as given by following Expression 55 based on the output of first Doppler analyzer 210 input from first Doppler demultiplexer 213, and performs the direction estimation processing on the target with respect to the forward circular polarization.

Here, forward-circularly-polarized virtual reception array correlation vector h_{c1}(f_{b_cfar}, f_{s_comp_cfar}) includes a reflected wave reception signal that is based on the output of first Doppler analyzer 210 (e.g., VFT_{z}¹(f_{b_cfar}, f_{s_comp_cfar}+(N_{code}F_{R}(Dᵣₘᵢₙ, ndm__{BF})/N_{DM}))) and that is of a circularly polarized and transmitted signal that is transmitted using code multiplexing by using the same Doppler multiplexing and transmitted with beams by adjacent transmission antennas 109 of different linear polarizations. For example, when there are N_{BF} beam transmission antennas (e.g., in the case of ndm__{BF}=1 to N_{BF}), forward-circularly-polarized virtual reception array correlation vector h_{c1}(f_{b_cfar}, f_{s_comp_cfar}) contains N_{BF}×Na elements. Based on the phase differences between reception antennas 202, direction estimator 214 may perform a process of performing direction estimation on reflected wave signals from a target using forward-circularly-polarized virtual reception array correlation vector h_{c1}(f_{b_cfar} and f_{s_comp_cfar}).

$$[ 58 ]$$

$${h}_{c 1} ( {f}_{b \_ cfar} , {f}_{s \_ comp \_ cfar} ) = [ \begin{matrix}\begin{matrix}{VFT}_{1}^{1} ( {f}_{b \_ cfar} , {f}_{s \_ comp \_ cfar} + \\ \frac{{N}_{code} {F}_{R} ( {D}_{rmin} , 1 )}{{N}_{DM}} )\end{matrix} \\ \begin{matrix}{VFT}_{2}^{1} ( {f}_{b \_ cfar} , {f}_{s \_ comp \_ cfar} + \\ \frac{{N}_{code} {F}_{R} ( {D}_{rmin} , 1 )}{{N}_{DM}} )\end{matrix} \\ ⋮ \\ \begin{matrix}{VFT}_{Na}^{1} ( {f}_{b \_ cfar} , {f}_{s \_ comp \_ cfar} + \\ \frac{{N}_{code} {F}_{R} ( {D}_{rmin} , 1 )}{{N}_{DM}} )\end{matrix} \\ \begin{matrix}{VFT}_{1}^{1} ( {f}_{b \_ cfar} , {f}_{s \_ comp \_ cfar} + \\ \frac{{N}_{code} {F}_{R} ( {D}_{rmin} , 2 )}{{N}_{DM}} )\end{matrix} \\ \begin{matrix}{VFT}_{2}^{1} ( {f}_{b \_ cfar} , {f}_{s \_ comp \_ cfar} + \\ \frac{{N}_{code} {F}_{R} ( {D}_{rmin} , 2 )}{{N}_{DM}} )\end{matrix} \\ ⋮ \\ \begin{matrix}{VFT}_{Na}^{1} ( {f}_{b \_ cfar} , {f}_{s \_ comp \_ cfar} + \\ \frac{{N}_{code} {F}_{R} ( {D}_{rmin} , 2 )}{{N}_{DM}} )\end{matrix} \\ ⋮ \\ \begin{matrix}{VFT}_{1}^{1} ( {f}_{b \_ cfar} , {f}_{s \_ comp \_ cfar} + \\ \frac{{N}_{code} {F}_{R} ( {D}_{rmin} , {N}_{BF} )}{{N}_{DM}} )\end{matrix} \\ \begin{matrix}{VFT}_{2}^{1} ( {f}_{b \_ cfar} , {f}_{s \_ comp \_ cfar} + \\ \frac{{N}_{code} {F}_{R} ( {D}_{rmin} , {N}_{BF} )}{{N}_{DM}} )\end{matrix} \\ ⋮ \\ \begin{matrix}{VFT}_{Na}^{1} ( {f}_{b \_ cfar} , {f}_{s \_ comp \_ cfar} + \\ \frac{{N}_{code} {F}_{R} ( {D}_{rmin} , {N}_{BF} )}{{N}_{DM}} )\end{matrix}\end{matrix} ] \qquad ( Expression 55 )$$

<Direction Estimation Processing with Respect to Reverse Circular Polarization>

Direction estimator 214 performs the direction estimation processing on the target with respect to the reverse circular polarization based on the output of second Doppler analyzer 210 input from second Doppler demultiplexer 213. For example, direction estimator 214 generates reverse-circularly-polarized virtual reception array correlation vector h_{c2}(f_{b_cfar} and f_{s_comp_cfar} as given by following Expression 56, and performs the direction estimation processing on the target with respect to the reverse circular polarization.

Here, reverse-circularly-polarized virtual reception array correlation vector h_{c2}(f_{b_cfar}, f_{s_comp_cfar}) includes a reflected wave reception signal that is based on the output of second Doppler analyzer 210 (e.g., VFT_{z}²(f_{b_cfar}, f_{s_comp_cfar}+(N_{code}F_{R}(Dᵣₘᵢₙ, ndm__{BF})/N_{DM}))) and that is of a circularly polarized and transmitted signal that is transmitted using code multiplexing by using the same Doppler multiplexing and transmitted with beams by adjacent transmission antennas 109 of different linear polarizations. For example, when there are N_{BF} beam transmission antennas (for example, in the case of ndm__{BF} 1 to N_{BF}), reverse-circularly-polarized virtual reception array correlation vector h_{c2}(f_{b_cfar}, f_{s_comp_cfar}) includes N_{BF}×Na elements.

Based on the phase differences between reception antennas 202, direction estimator 214 performs direction estimation on the reflected wave signals from the target using reverse-circularly-polarized virtual reception array correlation vector h_{c2}(f_{b_cfar} and f_{s_comp_cfar}).

$$[ 59 ]$$

$${h}_{c 2} ( {f}_{b \_ cfar} , {f}_{s \_ comp \_ cfar} ) = [ \begin{matrix}\begin{matrix}{VFT}_{1}^{2} ( {f}_{b \_ cfar} , {f}_{s \_ comp \_ cfar} + \\ \frac{{N}_{code} {F}_{R} ( {D}_{rmin} , 1 )}{{N}_{DM}} )\end{matrix} \\ \begin{matrix}{VFT}_{2}^{2} ( {f}_{b \_ cfar} , {f}_{s \_ comp \_ cfar} + \\ \frac{{N}_{code} {F}_{R} ( {D}_{rmin} , 1 )}{{N}_{DM}} )\end{matrix} \\ ⋮ \\ \begin{matrix}{VFT}_{Na}^{2} ( {f}_{b \_ cfar} , {f}_{s \_ comp \_ cfar} + \\ \frac{{N}_{code} {F}_{R} ( {D}_{rmin} , 1 )}{{N}_{DM}} )\end{matrix} \\ \begin{matrix}{VFT}_{1}^{2} ( {f}_{b \_ cfar} , {f}_{s \_ comp \_ cfar} + \\ \frac{{N}_{code} {F}_{R} ( {D}_{rmin} , 2 )}{{N}_{DM}} )\end{matrix} \\ \begin{matrix}{VFT}_{2}^{2} ( {f}_{b \_ cfar} , {f}_{s \_ comp \_ cfar} + \\ \frac{{N}_{code} {F}_{R} ( {D}_{rmin} , 2 )}{{N}_{DM}} )\end{matrix} \\ ⋮ \\ \begin{matrix}{VFT}_{Na}^{2} ( {f}_{b \_ cfar} , {f}_{s \_ comp \_ cfar} + \\ \frac{{N}_{code} {F}_{R} ( {D}_{rmin} , 2 )}{{N}_{DM}} )\end{matrix} \\ ⋮ \\ \begin{matrix}{VFT}_{1}^{2} ( {f}_{b \_ cfar} , {f}_{s \_ comp \_ cfar} + \\ \frac{{N}_{code} {F}_{R} ( {D}_{rmin} , {N}_{BF} )}{{N}_{DM}} )\end{matrix} \\ \begin{matrix}{VFT}_{2}^{2} ( {f}_{b \_ cfar} , {f}_{s \_ comp \_ cfar} + \\ \frac{{N}_{code} {F}_{R} ( {D}_{rmin} , {N}_{BF} )}{{N}_{DM}} )\end{matrix} \\ ⋮ \\ \begin{matrix}{VFT}_{Na}^{2} ( {f}_{b \_ cfar} , {f}_{s \_ comp \_ cfar} + \\ \frac{{N}_{code} {F}_{R} ( {D}_{rmin} , {N}_{BF} )}{{N}_{DM}} )\end{matrix}\end{matrix} ] \qquad ( Expression 56 )$$

### Antenna Arrangement Example 1

An example of the direction estimation processing with respect to linear polarization, direction estimation processing with respect to forward circular polarization, and direction estimation processing with respect to reverse circular polarization in direction estimator 214 will be described below using an antenna arrangement example.

For example, a description will be given of a case where number Nt of transmission antennas used for multiplexing transmission is 4, number N_{DM} of Doppler multiplexing is 2, number N_{CM} of code multiplexing is 2, orthogonal code sequences Code₁={1, 1} and Code₂={j, −j} with code length Loc=2 are configured, and numbers N_{DOP_CODE}(1) and N_{DOP_CODE}(2) of coded Doppler multiplexing are 2 and 2, respectively. Note that number N_{BF} of beam transmission antennas=2, and ndm__{BF}=1 and ndm__{BF}=2 are used as indices of Doppler multiplexed signals used for the beam transmission antennas.

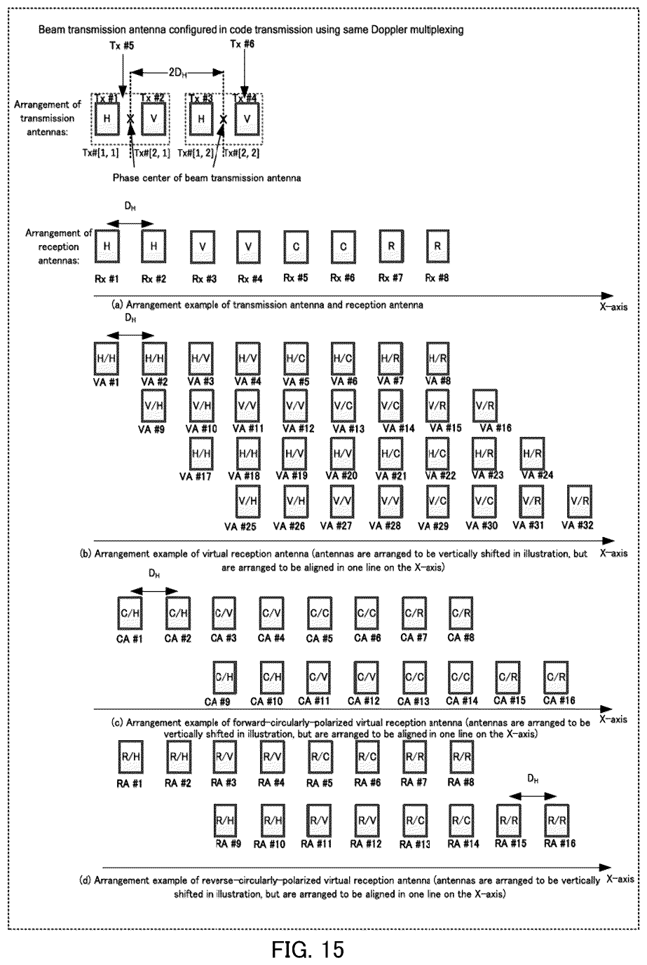

In FIG. 15, for example, in radar apparatus 10, four transmission antennas 109 (Tx #1, Tx #2, Tx #3 and Tx #4) disposed horizontally are, in order from the left, transmission antenna Tx #[1, 1] of horizontal polarization (denoted as “H”), transmission antenna Tx #[2, 1] of vertical polarization (denoted as “V”), transmission antenna Tx #[1, 2] of horizontal polarization, and transmission antenna Tx #[2, 2] of vertical polarization.

In FIG. 15, left two adjacent transmission antennas Tx #1 (Tx #[1, 1]) and Tx #2 (Tx #[2, 1]) of four transmission antennas 109 perform code multiplexing transmission on a radar transmission signal using the same Doppler multiplexing (Doppler shift amount=DOP₁). Therefore, in FIG. 15, a beam transmission antenna is formed by Tx #1 and Tx #2, and a circularly polarized wave is transmitted. In addition, for transmission antennas Tx #1 (Tx #[1, 1]) and Tx #2 (Tx #[2, 1]), a forward-circularly-polarized wave or a reverse-circularly-polarized wave may be switched and transmitted at each transmission period depending on the phase difference between the codes at the time of code multiplexing transmission.

Similarly, in FIG. 15, right two adjacent transmission antennas Tx #3 (Tx #[1, 2]) and Tx #4 (Tx #[2, 2]) of four transmission antennas 109 perform code multiplexing transmission on a radar transmission signal using the same Doppler multiplexing (Doppler shift amount=DOP₂). Therefore, in FIG. 15, a beam transmission antenna is formed by Tx #3 and Tx #4, and a circularly polarized wave is transmitted. In addition, for transmission antennas Tx #1 (Tx #[1, 2]) and Tx #2 (Tx #[2, 2]), a forward-circularly-polarized wave or a reverse-circularly-polarized wave may be switched and transmitted at each transmission period depending on the phase difference between the codes at the time of code multiplexing transmission.

In FIG. 15, number N_{BF} of beam transmission antennas is 2. The beam transmission antenna based on Tx #1 and Tx #2 in FIG. 15 may be referred to as “Tx #5” hereinafter. Beam transmission antenna by Tx #3 and Tx #4 in FIG. 15 may also be referred to as “Tx #6.” For example, Tx #5 and Tx #6 can be treated equivalently as antennas in which transmission is performed at each transmission period while the forward circular polarization or the reverse circular polarization is switched.

Note that, a description is given here of a case where Tx #5 and Tx #6 use a code for transmitting a circularly polarized wave in the same rotation direction of forward rotation or reverse rotation for each transmission period, but the present disclosure is not limited thereto, and Tx #5 and Tx #6 may use circularly polarized waves in different rotation directions.

As illustrated in FIG. 15, number Na of reception antennas is eight (e.g., Rx #1 to Rx #8) and the antennas include antennas of four different polarizations. In the example illustrated in FIG. 15, Rx #1 and Rx #2 use reception antennas of horizontal polarization (H), Rx #3 and Rx #4 use reception antennas of vertical polarization (V), Rx #5 and Rx #6 use reception antennas of forward circular polarization (C), and Rx #7 and Rx #8 use reception antennas of reverse circular polarization (R).

Note that number Na of reception antennas is not limited to eight, and may be another number, for example. Also, the types of polarization used for reception antennas 202 are not limited to four types, and may be three types, two types, or one type. In addition to the horizontal polarization and the vertical polarization, obliquely inclined linear polarization, for example, a polarization inclined at ±450 direction may be used.

For example, when a radar transmission signal is transmitted from adjacent Tx #1 (Tx #[1, 1]) and Tx #2 (Tx #[2, 1]) at an equal power, the midpoint position between Tx #1 and Tx #2 serves as the phase center of beam transmission antenna Tx #5 (the cross mark illustrated at (a) in FIG. 15). Similarly, for example, when a radar transmission signal is transmitted from adjacent Tx #3 (Tx #[1, 2]) and Tx #4 (Tx #[2, 2]) at an equal power, the midpoint position between Tx #3 and Tx #4 serves as the phase center of beam transmission antenna Tx #6 (the cross mark illustrated at (a) in FIG. 15).

Note that, when the radar transmission signal is not transmitted at an equal power from transmission antennas 109 constituting the beam transmission antenna, transmission at a position dependent on the ratio of transmission powers of respective transmission antennas 109 constituting the beam transmission antenna (the position of the center of gravity of the transmission powers from the respective transmission antennas) that serves as the phase center of the sub-array can be treated as transmission by the beam transmission antenna.

Arrangement of VA #1 to VA #32 of virtual reception antennas (or IMV O virtual antennas) as illustrated at (b) in FIG. 15 is formed by the arrangement of transmission antennas Tx #1 to Tx #4 (e.g., Nt transmission antennas 109) and reception antennas Rx #1 to Rx #8 (e.g., Na reception antennas 202) as illustrated at (b) in FIG. 15.

Further, in (a) of FIG. 15, the arrangement of CA #1 to CA #16 of the forward-circularly-polarized virtual reception antennas as illustrated in (c) of FIG. 15 is formed by the arrangement of forward-circularly-polarized beam transmission antennas Tx #5 and Tx #6 (for example, N_{BF} transmission antennas) and reception antennas Rx #1 to Rx #8. The arrangement of CA #1 to CA #16 of the forward-circularly-polarized virtual reception antennas is also expressed, for example, as VA #33 to VA #48.

Further, in (a) of FIG. 15, the arrangement of RA #1 to RA #16 of the reverse-circularly-polarized virtual reception antennas as illustrated in (d) of FIG. 15 is formed by the arrangement of reverse-circularly-polarized beam transmission antennas Tx #5 and Tx #6 (for example, N_{BF} transmission antennas) and reception antennas Rx #1 to Rx #8, and the arrangement of RA #1 to RA #16 of the reverse-circularly-polarized virtual reception antennas is also expressed as VA #33 to VA #48, for example. The arrangement of RA #1 to RA #16 of the reverse-circularly-polarized virtual reception antennas is the same as the arrangement of CA #1 to CA #16 of the forward-circularly-polarized virtual reception antennas.

Here, the arrangement of the virtual reception antennas (the virtual reception array) may be expressed by following Expression 57, for example, based on the positions of transmission antennas 109 constituting the transmission array antenna (e.g., the positions of feeding points) and the positions of reception antennas 202 constituting the reception array antenna (e.g., the positions of feeding points):

$$[ 60 ]$$

$$( Expression 57 )$$

$$\{ \begin{matrix}{X}_{V \_ \# k} = ( {X}_{T \_ \# [ ceil ( k / Na ) ]} - {X}_{T \_ \#1} ) + ( {X}_{R \_ \# [ mod ( k - 1 , Na ) + 1 ]} - {X}_{R \_ \#1} ) \\ {Y}_{V \_ \# k} = ( {Y}_{T \_ \# [ ceil ( k / Na ) ]} - {Y}_{T \_ \#1} ) + ( {Y}_{R \_ \# [ mod ( k - 1 , Na ) + 1 ]} - {Y}_{R \_ \#1} )\end{matrix} .$$

Here, the position coordinates of transmission antennas 109 (e.g., Tx #n) constituting the transmission array antenna are represented by (X_{T_#n}, Y_{T_#n}) (e.g., n=1 to Nt+N_{BF}), the position coordinates of reception antennas 202 (e.g., Rx #m) constituting the reception array antenna are represented by (X_{R_#m}, Y_{R_#m}) (e.g., m=1 to Na), and the position coordinates of virtual antennas VA #k constituting the virtual reception array antenna are represented by (X_{V_#k}, Y_{V_#k}) (e.g., k=1 to (Nt+N_{BF})×Na).

Note that, VA #I is represented as the position reference (0, 0) of the virtual reception array, for example, in Expression 57.

Part (b) in FIG. 15 illustrates an exemplary virtual reception antenna arrangement using the arrangement of Tx #1 to #4 and Rx #1 to #8 illustrated in (a) of FIG. 15. The virtual reception antennas include 32 antenna elements, which are illustrated as VA #1 to VA #32, respectively.

Note that the combination of the transmission antenna polarization (e.g., H or V) and the reception antenna polarization (e.g., H, V, C, or R) in each virtual reception antenna is different for each antenna, and is thus referred to as “(transmission antenna polarization/reception antenna polarization).” For example, a virtual reception antenna in the case of horizontally polarized transmission and horizontally polarized reception is described as “H/H.” The same applies to illustration in (c) and (d) of FIG. 15. Also, the following descriptions are given in accordance with the illustrations.

Since the arrangement of Tx #1 to #4 and Rx #1 to #8 in (a) of FIG. 15 is one-dimensional arrangement on the X-axis (laterally in FIG. 15), the virtual reception antennas are also arranged on the X-axis. Note that, since the arrangement includes overlap on the X-axis, (b) of FIG. 15 illustrates the antennas shifted in the vertical direction are illustrated. However, the antennas are arranged one-dimensionally at positions on the X-axis. The same applies to the illustrations of (c) and (d) of FIG. 15. Also, the following descriptions are given in accordance with the illustrations.

Part (c) of FIG. 15 illustrates a virtual reception antenna arrangement using beam transmission antennas Tx #5 and #6 and Rx #1 to #8 for forward-circularly-polarized transmission of beams. The virtual receive antennas have an array arrangement of 16 antenna elements (e.g., CA #1 to CA #16). Note that CA #1 to CA #16 correspond to VA #33 to VA #48, respectively.

Further, (d) of FIG. 15 illustrates a virtual reception antenna arrangement using beam transmission antennas Tx #5 and #6 and Rx #1 to #8 for reverse-circularly-polarized transmission of beams. The virtual reception antenna have an antenna arrangement of 16 antenna elements (for example, RA #1 to RA #16) the same as that of (c) of FIG. 15. Note that RA #1 to RA #16 correspond to VA #33 to VA #48, respectively.

In this way, radar apparatus 10 can perform transmission using more polarizations by the virtual reception antenna arrangement using the beam transmission antennas. Further, by combining the polarization of transmission antenna 109 and the polarization of reception antenna 202, it is possible to obtain a reception signal not only by a combination of transmission and reception antennas of the same polarization but also by a combination of orthogonal polarizations (also referred to as “cross polarization”) (for example, a combination of horizontal polarization and vertical polarization, or a combination of left-handed circular polarization and right-handed circular polarization). In radar apparatus 10, the detection performance or the identification performance can be improved by utilizing the change in the reception characteristics of reflected waves of a target due to the combination of the transmission and reception polarizations.

<Direction Estimation Processing with Respect to Linear Polarization>

For example, when the direction estimation processing is performed using the horizontally polarized antennas (H) for both transmission and reception, direction estimator 214 extracts four virtual reception antennas including VA #1, VA #2, VA #17, and VA #18 to perform the direction estimation processing.

Virtual reception array correlation vector h(f_{b_cfar}, f_{s_comp_cfar}) is a column vector, and the first to the Nt×Nath elements included in the column vector represent reception signals from virtual antennas VA #1 to VA #(Nt×Na). For example, direction estimator 214 performs the arrival direction estimation using a partial array correlation vector obtained by extracting the first, second, 17th, and 18th elements of virtual reception array correlation vector h(f_{b_cfar}, f_{s_comp_cfar}) corresponding to reception signals of VA #1, VA #2, VA #17, and VA #18. The extracted partial array correlation vector is denoted as h_{sub}(f_{b_cfar}, f_{s_comp_cfar}). The number of dimensions of h_{sub}(f_{b_cfar}, f_{s_comp_cfar}) is N_{sub}.

For example, direction estimator 214 calculates a spatial profile, with azimuth direction θ in direction estimation evaluation function value P_{H} (θ, f_{b_cfar}, f_{s_comp_cfar}) being variable within a defined angular range. Direction estimator 214 extracts a predetermined number of local maximum peaks in the calculated spatial profile in descending order and outputs the azimuth directions of the local maximum peaks as direction-of-arrival estimation values (for example, positioning outputs).

Note that, there are various methods with direction estimation evaluation function value P_{H} (θ, f_{b_cfar}, f_{s_comp_cfar}) depending on direction-of-arrival estimation algorithms. For example, an estimation method using an array antenna, as disclosed in NPL 3, may be used.

For example, the beamformer method can be expressed as following Expression 58. In addition, techniques such as Capon, MUSIC, and the like are also applicable.

$$[ 61 ]$$

$${P}_{H} ( {θ}_{u} , {f}_{b \_ cfar} , {f}_{s \_ comp \_ cfar} ) = {\vert {a}_{sub}^{H} ( {θ}_{u} ) {D}_{cal} {h}_{s u b} ( {f}_{b \_ cfar} , {f}_{s \_ comp \_ cfar} ) \vert}^{2} \qquad ( Expression 58 )$$

Here, in Expression 58, superscript H denotes a Hermitian transpose operator. In addition, a_{sub}(θᵤ) represents a direction vector of extracted partial virtual reception array VA #1, VA #2, VA #17, VA #18 with respect to an incoming wave of azimuth direction θᵤ. For example, when the virtual reception antennas including VAs #1, #2, #17, and #18 are linearly arranged at regular spacings D_{H}, the direction vector of virtual reception array VA #1, VA #2, VA #17, VA #18 can be expressed by following Expression 59:

$$[ 62 ]$$

$${a}_{s u b} ( {θ}_{u} ) = [ \begin{matrix}1 \\ exp [ - j 2 π {D}_{H} sin {θ}_{H} / λ ] \\ exp [ - j 4 π {D}_{H} sin {θ}_{H} / λ ] \\ exp [ - j 6 π {D}_{H} sin {θ}_{H} / λ ]\end{matrix} ] . \qquad ( Expression 59 )$$

Azimuth direction θᵤ is a vector that is changed at azimuth interval β₁ in an azimuth range over which direction-of-arrival estimation is performed. For example, θᵤ may be configured as follows:

$${θ}_{u} = θ min + u {β}_{1} , u = 0 , … , NU ; and$$

$$NU = floor [ ( θ max - θ min ) / {β}_{1} ] + 1 .$$

Here, floor(x) is a function that returns the largest integer value not greater than real number x.

In Expression 58, D_{cal} is a N_{sub}th order matrix including an array correcting coefficient for correcting the phase and amplitude deviations between the antennas of partial virtual reception array VA #1, #2, #17, #18 and a coefficient for reducing the influence of inter-element coupling between the antennas. If the coupling between antennas in the virtual reception array is negligible, D_{cal} is a diagonal matrix with diagonal components including an array correction coefficient for correcting phase deviations and amplitude deviations between the transmission array antennas and between the reception array antennas.

Further, for example, when the direction estimation processing using the vertically polarized antennas for both the transmission and reception is performed, direction estimator 214 extracts four virtual reception antennas including VA #11, VA #12, VA #27, and VA #28 to perform the same direction estimation processing as the above-described processing.

Further, for example, direction estimator 214 may perform direction estimation processing using cross polarization. For example, when direction estimation processing using a vertically polarized antenna for transmission and a horizontally polarized antenna for reception is performed, direction estimator 214 extracts four virtual reception antennas including VA #9, VA #10, VA #25, VA #26, to perform the direction estimation processing similar to the above-described processing.

The combination of the polarized antenna for transmission and the polarized antenna for reception is not limited to the above-described combinations, and different combinations of the transmission and reception polarized antennas may be made.

For example, the direction estimation processing is not limited to the direction estimation processing using the virtual reception array in which the combination of the transmission and reception polarized antennas is of the same type, direction estimator 214 may perform the direction estimation processing using the virtual reception array in which the combination of the transmission and reception polarized antennas is of a different type. For example, direction estimator 214 may extract all the virtual reception antennas including VA #1 to VA #32 that are obtained from the output of coded Doppler demultiplexer 212, to perform the direction estimation processing similar to the processing described above. Direction estimator 214 performs the direction estimation processing using a reception signal including a combination of different types of polarizations (e.g., H/V, H/C, or the like) to obtain a direction estimation result that is less dependent on the polarization. Further, since direction estimator 214 performs the direction estimation processing using all the virtual reception antennas, the reception SNR is improved and the detection performance in radar apparatus 10 can be improved. Further, since the direction estimation processing using the maximum aperture length of the available virtual reception antennas is performed, the angular resolution is also improved.

For example, direction estimator 214 may perform the direction estimation processing using the polarized antennas of the same type for the transmission and reception as described above, and the direction estimation processing combining the polarizations of the different types, and may use both of the direction estimation results as the direction estimation processing result. As a result, a direction estimation processing result highly dependent on the polarization and a direction estimation processing result less dependent on the polarization are obtained. The result of such direction estimation processing may be input to a target object identification processor not illustrated in the figures, and target object identification processing may be performed.

<Direction Estimation Processing with Respect to Forward Circular Polarization>

For example, when the direction estimation processing using the forward-circularly-polarized antennas (C) is performed for both transmission and reception, direction estimator 214 extracts four virtual reception antennas including CA #5, CA #6, CA #13, and CA #14 to perform the direction estimation processing.

Forward-circularly-polarized virtual reception array correlation vector h_{c1}(f_{b_car}, f_{s_comp_cfar}) is a column vector, and the first element to the N_{BF}×Nath elements included in this column vector represent reception signals of virtual antennas VA #(Nt×Na+1) to VA #(Nt+N_{BF})×Na or reception signals of CA #1 to CA #(N_{BF}×Na). For example, direction estimator 214 performs direction-of-arrival estimation using a partial array correlation vector obtained by extracting the fifth, sixth, thirteenth, and fourteenth elements of forward-circularly-polarized virtual reception array correlation vector h_{c1}(f_{b_cfar}, f_{s_comp_cfar}) corresponding to reception signals of CA #5, CA #6, CA #13, and CA #14. The extracted partial array correlation vector is denoted as h_{c1sub}(f_{b_cfar} (f_{s_comp_cfar}). The number of dimensions of h_{c1sub}(f_{b_cfar} and f_{s_comp_cfar}) is denoted by N_{c1sub}.

For example, direction estimator 214 calculates a spatial profile, with azimuth direction θ in direction estimation evaluation function value P_{Hc1}(θ, f_{b_cfar}, f_{s_comp_cfar}) being variable within a defined angular range. Direction estimator 214 extracts a predetermined number of local maximum peaks in the calculated spatial profile in descending order and outputs the azimuth directions of the local maximum peaks as direction-of-arrival estimation values (for example, positioning outputs).

Note that, there are various methods with direction estimation evaluation function value P_{Hc1} (θ, f_{b_cfar}, f_{s_comp_cfar}) depending on direction-of-arrival estimation algorithms. For example, an estimation method using an array antenna, as disclosed in NPL 3, may be used.

For example, the beamformer method can be expressed as following Expression 60. In addition, techniques such as Capon, MUSIC, and the like are also applicable.

$$[ 63 ]$$

$${P}_{Hc 1} ( {θ}_{u} , {f}_{b \_ cfar} , {f}_{s \_ comp \_ cfar} ) = {\vert {a}_{c 1 sub}^{H} ( {θ}_{u} ) {D}_{c 1 cal} {h}_{c 1 sub} ( {f}_{b \_ cfar} , {f}_{s \_ comp \_ cfar} ) \vert}^{2} \qquad ( Expression 60 )$$

In addition, a_{c1sub}(θᵤ) represents direction vectors of extracted partial virtual reception array of CA #5, CA #6, CA #13, and CA #14 with respect to an incoming wave in azimuth direction θᵤ.

Also, D_{c1cal} is a N_{c1sub}th order matrix including an array correcting coefficient for correcting phase and amplitude deviations between antennas of partial virtual reception array of CA #5, CA #6, CA #13, and CA #14 and a coefficient for reducing the influence of inter-element coupling between the antennas. If the coupling between antennas in the virtual reception array is negligible, D_{c1cal} is a diagonal matrix with diagonal components including an array correction coefficient for correcting phase deviations and amplitude deviations between the transmission array antennas and between the reception array antennas.

Further, for example, direction estimator 214 may perform direction estimation processing using cross polarization. For example, when direction estimation processing using a forward-circularly-polarized antenna for transmission and a reverse-circularly-polarized antenna for reception is performed, direction estimator 214 extracts four virtual reception antennas including CA #7, CA #8, CA #15, CA #16, to perform the direction estimation processing similar to the above-described processing.

For example, the direction estimation processing is not limited to the direction estimation processing using the virtual reception array in which the combination of the transmission and reception polarized antennas is of the same type, direction estimator 214 may perform the direction estimation processing using the virtual reception array in which the combination of the transmission and reception polarized antennas is a different type. For example, direction estimator 214 may extract all the virtual reception antennas including CA #1 to CA #16 that are obtained from the output of first Doppler demultiplexer 213, to perform the direction estimation processing similar to the processing described above. Direction estimator 214 performs the direction estimation processing using a reception signal including a combination of different types of polarizations (e.g., C/H, C/V, or the like) to obtain a direction estimation result that is less dependent on the polarization. Further, since direction estimator 214 performs the direction estimation processing using all the virtual reception antennas, the reception SNR is improved and the detection performance in radar apparatus 10 can be improved. Further, since the direction estimation processing using the maximum aperture length of the available virtual reception antennas is performed, the angular resolution is also improved.

For example, direction estimator 214 may perform the direction estimation processing using the same type of polarized antennas for the transmission and reception as described above and the direction estimation processing combining different types of polarization, and both of the direction estimation results may be used as the direction estimation processing result. As a result, a direction estimation processing result highly dependent on the polarization and a direction estimation processing result less dependent on the polarization are obtained. The result of such direction estimation processing may be input to a target object identification processor not illustrated in the figures, and target object identification processing may be performed.

<Direction Estimation Processing with Respect to Reverse Circular Polarization>

For example, when the direction estimation processing using a reverse-circularly-polarized antenna is performed for both the transmission and reception, direction estimator 214 extracts four virtual reception antennas including RA #7, RA #8, RA #15, RA #16 to perform the direction estimation processing.

Reverse-circularly-polarized virtual reception array correlation vector h_{c2}(f_{b_cfar}, f_{s_comp_cfar}) is a column vector, and the first element to the N_{BF}×Nath elements included in this column vector represent reception signals of virtual antennas VA #(Nt×Na+1) to VA #(Nt+N_{BF})×Na or reception signals of RA #1 to RA #(N_{BF}×Na). For example, direction estimator 214 performs the direction-of-arrival estimation by using a partial array correlation vector obtained by extracting the seventh, eighth, fifteenth, and sixteenth elements of reverse-circularly-polarized virtual reception array correlation vectors h_{c2}(f_{b_cfar} and f_{s_comp_cfar}) corresponding to the reception signals of RA #7, RA #8, RA #15, and RA #16. The extracted partial array correlation vector is denoted as h_{c2sub}(f_{b_cfar} (f_{s_comp_cfar}). The number of dimensions of h_{c2sub}(f_{b_cfar} and f_{s_comp_cfar}) is denoted by N_{c2sub}.

For example, direction estimator 214 calculates a spatial profile, with azimuth direction θ in direction estimation evaluation function value P_{Hc2}(θ, f_{b_cfar}, f_{s_comp_cfar}) being variable within a defined angular range. Direction estimator 214 extracts a predetermined number of local maximum peaks in the calculated spatial profile in descending order and outputs the azimuth directions of the local maximum peaks as direction-of-arrival estimation values (for example, positioning outputs).

Note that, there are various methods with direction estimation evaluation function value P_{Hc2} (θ, f_{b_cfar}, f_{s_comp_cfar}) depending on direction-of-arrival estimation algorithms. For example, an estimation method using an array antenna, as disclosed in NPL 3, may be used.

For example, the beamformer method can be expressed as following Expression 61. In addition, techniques such as Capon, MUSIC, and the like are also applicable.

$$[ 64 ]$$

$${P}_{Hc 2} ( {θ}_{u} , {f}_{b \_ cfar} , {f}_{s \_ comp \_ cfar} ) = {\vert {a}_{c 2 sub}^{H} ( {θ}_{u} ) {D}_{c 2 cal} {h}_{c 2 sub} ( {f}_{b \_ cfar} , {f}_{s \_ comp \_ cfar} ) \vert}^{2} \qquad ( Expression 61 )$$

In addition, a_{c2sub}(θᵤ) represents direction vectors of extracted partial virtual reception array RA #7, RA #8, RA #15, RA #16 with respect to an incoming wave in azimuth direction θᵤ.

Also, D_{c2cal} is a N_{c2sub}th order matrix including an array correcting coefficient for correcting phase and amplitude deviations between antennas of partial virtual reception array RA #7, RA #8, RA #15, RA #16 and a coefficient for reducing the influence of inter-element coupling between the antennas. If the coupling between antennas in the virtual reception array is negligible, D_{c2cal} is a diagonal matrix with diagonal components including an array correction coefficient for correcting phase deviations and amplitude deviations between the transmission array antennas and between the reception array antennas.

Further, for example, direction estimator 214 may perform direction estimation processing using cross polarization. For example, when direction estimation processing using a reverse-circularly-polarized antenna for transmission and a forward-circularly-polarized antenna for reception is performed, direction estimator 214 extracts four virtual reception antennas including RA #5, RA #6, RA #13, RA #14, to perform the direction estimation processing similar to the above-described processing.

For example, the direction estimation processing is not limited to the direction estimation processing using the virtual reception array in which the combination of the transmission and reception polarized antennas is of the same type, direction estimator 214 may perform the direction estimation processing using the virtual reception array in which the combination of the transmission and reception polarized antennas is a different type. For example, direction estimator 214 may extract all the virtual reception antennas including RA #1 to RA #16 that are obtained from the output of second Doppler demultiplexer 213, to perform the direction estimation processing similar to the processing described above. Direction estimator 214 performs the direction estimation processing using a reception signal including a combination of different types of polarizations (e.g., R/H, R/V, or the like) to obtain a direction estimation result that is less dependent on the polarization. Further, since direction estimator 214 performs the direction estimation processing using all the virtual reception antennas, the reception SNR is improved and the detection performance in radar apparatus 10 can be improved. Further, since the direction estimation processing using the maximum aperture length of the available virtual reception antennas is performed, the angular resolution is also improved.

For example, direction estimator 214 may perform the direction estimation processing using the same type of polarized antennas for the transmission and reception as described above and the direction estimation processing combining different types of polarization, and both of the direction estimation results may be used as the direction estimation processing result. As a result, a direction estimation processing result highly dependent on the polarization and a direction estimation processing result less dependent on the polarization are obtained. The result of such direction estimation processing may be input to a target object identification processor not illustrated in the figures, and target object identification processing may be performed.

Examples of the direction estimation processing with respect to the reverse circular polarization have been described above.

Further, direction estimator 214 may perform direction estimation processing using the outputs of first and second Doppler demultiplexers 213, for example.

For example, when a forward-circularly-polarized antenna (e.g., C/C) is used for both transmission and reception or a reverse-circularly-polarized antenna (e.g., R/R) is used for both transmission and reception, direction estimator 214 extracts four virtual reception antennas including CA #5, CA #6, CA #13, and CA #14 from the output of first Doppler demultiplexer 213, extracts four virtual reception antennas including RA #7, RA #8, RA #15, and RA #16 from the output of second Doppler demultiplexer 213, so as to perform direction estimation using respective extracted partial array correlation vectors (h_{c1sub}(f_{b_cfar}, f_{s_comp_cfar}), h_{c2sub}(f_{b_cfar}, and f_{s_comp_cfar}).

For example, direction estimator 214 calculates a spatial profile, with azimuth direction θ in direction estimation evaluation function value P_{Hc12}(θ, f_{b_cfar}, f_{s_comp_cfar}) being variable within a defined angular range. Direction estimator 214 extracts a predetermined number of local maximum peaks in the calculated spatial profile in descending order and outputs the azimuth directions of the local maximum peaks as direction-of-arrival estimation values (for example, positioning outputs).

Note that, there are various methods with direction estimation evaluation function value P_{Hc12} (θ, f_{b_cfar}, f_{s_comp_cfar}) depending on direction-of-arrival estimation algorithms. For example, an estimation method using an array antenna, as disclosed in NPL 3, may be used.

For example, the beamformer method can be expressed as following Expression 62. In addition, techniques such as Capon, MUSIC, and the like are also applicable.

$$[ 65 ]$$

$$( Expression 62 )$$

$${P}_{Hc 12} ( {θ}_{u} , {f}_{b \_ cfar} , {f}_{s \_ comp \_ cfar} ) = {\vert {a}_{c 1 sub}^{H} ( {θ}_{u} ) {D}_{c 1 cal} {h}_{c 1 sub} ( {f}_{b \_ cfar} , {f}_{s \_ comp \_ cfar} ) \vert}^{2} + {\vert {a}_{c 2 sub}^{H} ( {θ}_{u} ) {D}_{c 2 cal} {h}_{c 2 sub} ( {f}_{b \_ cfar} , {f}_{s \_ comp \_ cfar} ) \vert}^{2}$$

Further, for example, when the combination (for example, C/R and R/C) of circularly polarized antennas which applies the cross polarization for transmission and reception is used, direction estimator 214 performs the same direction estimation processing by extracting four virtual reception antennas including CA #7, CA #8, CA #15, and CA #16 from the output of first Doppler demultiplexer 213, extracting four virtual reception antennas including RA #5, RA #6, RA #13, and RA #14 from the output of second Doppler demultiplexer 213, and using respective extracted partial array correlation vectors (h_{c1sub}(f_{b_cfar}, f_{s_comp_cfar}) and h_{c2sub}(f_{b_cfar}, f_{s_comp_cfar})).

As described above, when the direction estimation processing is performed using the outputs of first and second Doppler demultiplexers 213, direction estimator 214 can use more virtual antennas, improve the reception SNR, and improve the target-object detection performance in radar apparatus 10.

Further, direction estimator 214 may perform the direction estimation processing using the output of coded Doppler demultiplexer 212 and the output of one or both of first and second Doppler demultiplexers 213.

For example, direction estimator 214 extracts all virtual reception antennas including VA #1 to #32 obtained from the output of coded Doppler demultiplexer 212, extracts all virtual reception antennas including CA #1 to CA #16 obtained from the output of the first Doppler demultiplexer, and extracts all virtual reception antennas including RA #1 to RA #16 obtained from the output of second Doppler demultiplexer 213, so as to perform the direction estimation processing using the extracted partial array correlation vectors (h_{sub}(f_{b_cfar}, f_{s_comp_cfar}), h_{c1sub}(f_{b_cfar}, f_{s_comp_cfar}), and h_{c2sub}(f_{b_cfar}, f_{s_comp_cfar})).

For example, direction estimator 214 calculates a spatial profile, with azimuth direction θ in direction estimation evaluation function value P_{Hall} (θ, f_{b_cfar}, f_{s_comp_cfar}) being variable within a defined angular range. Direction estimator 214 extracts a predetermined number of local maximum peaks in the calculated spatial profile in descending order and outputs the azimuth directions of the local maximum peaks as direction-of-arrival estimation values (for example, positioning outputs).

Direction estimation evaluation function values P_{Hall} (θ, f_{b_cfar} and f_{s_comp_cfar}) can be obtained by various methods according to the direction-of-arrival estimation algorithm. For example, an estimation method using an array antenna, as disclosed in NPL 3, may be used.

For example, the beamformer method can be expressed as following Expression 63. In addition, techniques such as Capon, MUSIC, and the like are also applicable.

$$[ 66 ]$$

$${P}_{Hall} ( {θ}_{u} , {f}_{{b}_{-} cfar} , {f}_{{s}_{-} {comp}_{-} cfar} ) = {\vert {a}_{sub}^{H} ( {θ}_{u} ) {D}_{cal} {h}_{sub} ( {f}_{{b}_{-} cfar} , {f}_{{s}_{-} {comp}_{-} cfar} ) \vert}^{2} + {\vert {a}_{c 1 sub}^{H} ( {θ}_{u} ) {D}_{c 1 cal} {h}_{c 1 sub} ( {f}_{{b}_{-} cfar} , {f}_{{s}_{-} {comp}_{-} cfar} ) \vert}^{2} + {\vert {a}_{c 2 sub}^{H} ( {θ}_{u} ) {D}_{c 2 cal} {h}_{c 2 sub} ( {f}_{{b}_{-} cfar} , {f}_{{s}_{-} {comp}_{-} cfar} ) \vert}^{2} \qquad ( Expression 63 )$$

In the case as described above, direction estimator 214 performs the direction estimation processing using a reception signal including a combination of different types of polarizations to obtain a direction estimation result that is less dependent on the polarization. Further, since direction estimator 214 performs the direction estimation processing using all the virtual reception antennas, the reception SNR is improved and the detection performance in radar apparatus 10 can be improved. Further, since the direction estimation processing using the maximum aperture length of the available virtual reception antennas is performed, the angular resolution is also improved. More virtual antennas can be used, the reception SNR can be improved, and the target detection performance can be improved.

Here, for example, conventional methods use eight transmission antennas to configure two transmission MIMO for each of the four polarizations of horizontal polarization, vertical polarization, forward circular polarization, and reverse circular polarization. On the other hand, in the present embodiment, four transmission antennas 109 can achieve configuration of two transmission MIMO for each of the four polarizations, and thus the number of transmission antennas can be reduced. Further, in the present embodiment, since code multiplexing is performed on a Doppler multiplexed signal, the transmission time can be shortened. For example, compared with the case where four transmission antennas are switched in a time division manner, the effect of halving the transmission time is also obtained.

Further, direction estimator 214 may perform the direction estimation processing using a reception signal including a combination of different types of polarization. In this case, a direction estimation result that is less dependent on the polarization is obtained, and the reception SNR can be improved by performing the direction estimation processing using more virtual antennas. Thus, the detection performance of radar apparatus 10 can be improved. Further, since the direction estimation processing using the maximum aperture length of the available virtual reception antenna is performed, the angular resolution is also improved. For example, when the direction estimation processing is performed using all virtual reception antennas, up to (Nt×Na+2×N_{BF}×Na) virtual reception antennas can be utilized, and more than Nt×Na virtual reception antennas can be utilized.

Further, for example, direction estimator 214 may perform the direction estimation processing using the polarized antennas of the same type for the transmission and reception as described above, and the direction estimation processing combining the polarizations of the different types, and may use both of the direction estimation results as the direction estimation processing result. As a result, a direction estimation processing result highly dependent on the polarization and a direction estimation processing result less dependent on the polarization are obtained. The result of such direction estimation processing may be input to a target object identification processor not illustrated in the figures, and target object identification processing may be performed.

For example, direction estimator 214 may output not only the direction estimation result per combination of polarizations but also a positioning result, which includes distance information based on distance index f_{b_cfar} and Doppler velocity information of the target based on the Doppler frequency judgement result for the target (result of Doppler aliasing judgement processing by coded Doppler demultiplexer 212).

Note that, for example, when the phase rotation amount is determined using Expression 5, the Doppler frequency information can be calculated in the extended range as given by following Expression 64 using Dᵣₘᵢₙ that is the result of the Doppler aliasing judgement processing by coded Doppler demultiplexer 212:

$$[ 67 ]$$

$${f}_{out} = {f}_{{s}_{-} {comp}_{-} cfar} + \frac{{D}_{r min} {N}_{code}}{{N}_{DM}} . \qquad ( Expression 64 )$$

Further, for example, when the phase rotation amount is determined using Expression 6, the Doppler frequency information can be calculated in the extended range as given by following Expression 65 using Dᵣₘᵢₙ that is the result of the Doppler aliasing judgement processing:

$$[ 68 ]$$

$${f}_{out} = {f}_{{s}_{{comp}_{cfαr}}} + \frac{{D}_{r min} {N}_{code}}{{N}_{DM} + {N}_{int}} . \qquad ( Expression 65 )$$

Note that, the Doppler frequency information may be converted into the relative velocity component and then outputted. Following Expression 66 may be used to convert Doppler frequency index fₒᵤₜ to relative velocity component v_{d}(fₒᵤₜ) using Dᵣₘᵢₙ that is the result of the Doppler aliasing judgement for a target. Here, λ is the wavelength of the carrier frequency of an RF signal outputted from a transmission radio (not illustrated) (when a chirp signal is used, the wavelength at the center frequency of the chirp signal is used). Further, Δ_{f} denotes the Doppler frequency interval in FFT processing performed in Doppler analyzer 210. For example, in the present embodiment, Δ_{f}=1/{N_{code}×Loc×Tᵣ}.

$$[ 69 ]$$

$${v}_{d} ( {f}_{out} ) = \frac{λ}{2} {f}_{out} {Δ}_{f} \qquad ( Expression 66 )$$

Note that, in the above-described antenna arrangement example, an arrangement example using four types of polarization reception antennas has been described, but the present disclosure is not limited thereto, and, for example, two types of polarization reception antennas may be used. In this case, two types of polarization reception antennas, for example, from among the circular polarizations (right-handed polarization and left-handed polarization) or a different linear polarization (for example, horizontal or vertical polarization) are included.

Alternatively, a single type of polarization reception antenna may be used. In this case, a single type of polarization reception antennas, for example, from among the circular polarizations (right-handed polarization and left-handed polarization) or a different linear polarization (for example, horizontal or vertical polarization) is included.

Hereinafter, an arrangement example in which two types of polarization of reception antenna 202 are used and an arrangement example in which a single type of polarization of reception antenna 202 is used will be described.

### Antenna Arrangement Example 2

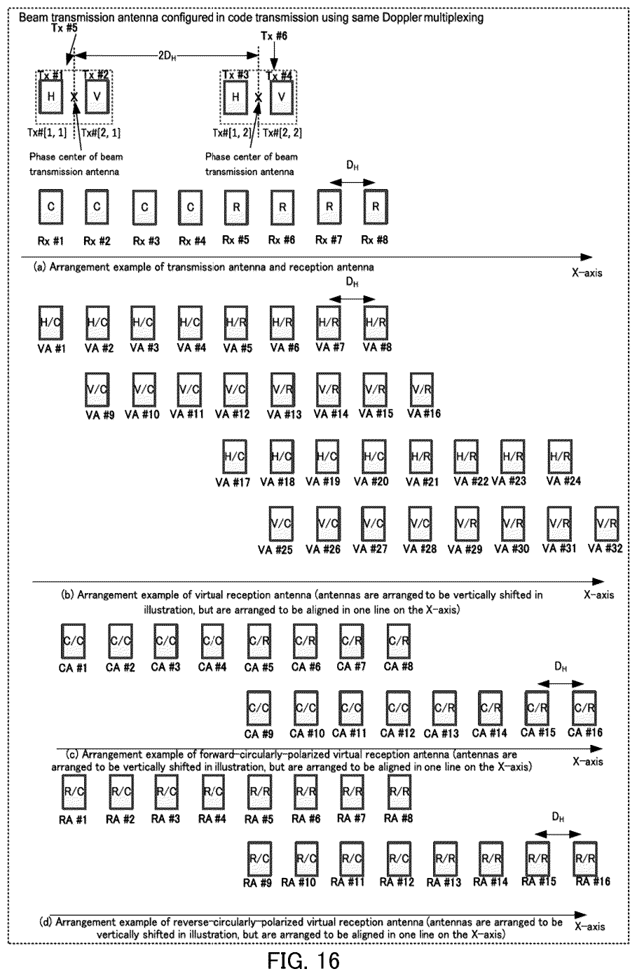

FIG. 16 illustrates an antenna arrangement example in which two types of polarization of reception antenna 202 are used (for example, C and R).

Arrangement of VA #1 to VA #32 of virtual reception antennas (or MIMO virtual antennas) as illustrated at (b) in FIG. 16 is formed by the arrangement of transmission antennas Tx #1 to Tx #4 (e.g., Nt transmission antennas 109) and reception antennas Rx #1 to Rx #8 (e.g., Na reception antennas) as illustrated at (a) in FIG. 16.

Further, in (a) of FIG. 16, the arrangement of CA #1 to CA #16 of the forward-circularly-polarized virtual reception antennas as illustrated in (c) of FIG. 16 is formed by the arrangement of forward-circularly-polarized beam transmission antennas Tx #5 and Tx #6 (for example, N_{BF} transmission antennas) and reception antennas Rx #1 to Rx #8. The arrangement of CA #1 to CA #16 of the forward-circularly-polarized virtual reception antennas is also expressed, for example, as VA #33 to VA #48.

In (a) of FIG. 16, the arrangement of RA #1 to RA #16 of the reverse-circularly-polarized virtual reception antennas as illustrated in (d) of FIG. 16 is formed by the arrangement of reverse-circularly-polarized beam transmission antennas Tx #5 and Tx #6 (for example, N_{BF} transmission antennas) and reception antennas Rx #1 to Rx #8. The arrangement of RA #1 to RA #16 of the reverse-circularly-polarized virtual reception antennas is also represented, for example, as VA #33 to VA #48. The arrangement of RA #1 to RA #16 of the reverse-circularly-polarized virtual reception antennas is the same as the arrangement of CA #1 to CA #16 of the forward-circularly-polarized virtual reception antennas.

Note that since (b) to (d) in FIG. 16 include the arrangement overlap in the X-axis (lateral direction in FIG. 16), the antennas shifted in the vertical direction are illustrated in (b) to (d) of FIG. 16. However, the antennas are arranged one-dimensionally at positions on the X-axis. In addition, the combination of the transmission antenna polarization and the reception antenna polarization in each virtual reception antenna is different for each antenna, and is thus referred to as “(transmission antenna polarization/reception antenna polarization).” For example, a virtual reception antenna in the case of horizontally polarized transmission and forward-circularly-polarized reception is described as “H/C.”

Further, with reference to (a) of FIG. 16, a description has been given of an exemplary case in which reception antennas 202 include a forward-circularly-polarized antenna and a reverse-circularly-polarized antenna, but the types and combination of the polarized antennas included in reception antennas 202 are not limited to this, and other types and combinations of polarized antennas may be applied.

### Antenna Arrangement Example 3

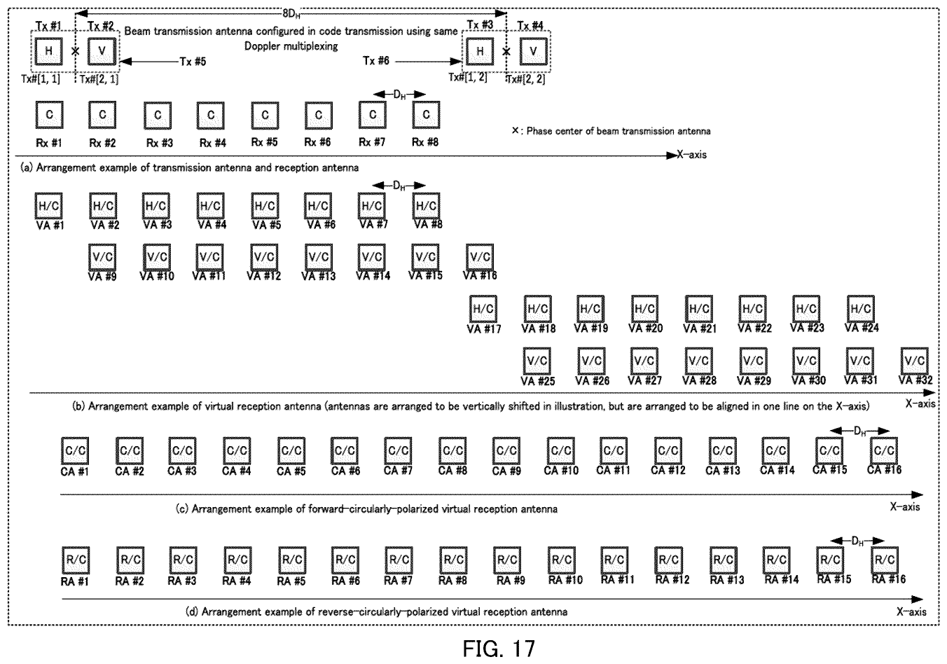

FIG. 17 illustrates an antenna arrangement example in which a single type of polarization of reception antenna 202 is used (for example, C).

Arrangement of VA #1 to VA #32 of virtual reception antennas (or MIMO virtual antennas) as illustrated at (b) in FIG. 17 is constituted by the arrangement of transmission antennas Tx #1 to Tx #4 (e.g., Nt transmission antennas 109) and reception antennas Rx #1 to Rx #8 (e.g., Na reception antennas) as illustrated at (a) in FIG. 17.

Further, in (a) of FIG. 17, the arrangement of CA #1 to CA #16 of the forward-circularly-polarized virtual reception antennas as illustrated in (c) of FIG. 17 is formed by the arrangement of forward-circularly-polarized beam transmission antennas Tx #5 and Tx #6 (for example, N_{BF} transmission antennas) and reception antennas Rx #1 to Rx #8. The arrangement of CA #1 to CA #16 of the forward-circularly-polarized virtual reception antennas is also expressed, for example, as VA #33 to VA #48.

In (a) of FIG. 17, the arrangement of RA #1 to RA #16 of the reverse-circularly-polarized virtual reception antennas as illustrated in (d) of FIG. 17 is formed by the arrangement of reverse-circularly-polarized beam transmission antennas Tx #5 and Tx #6 (for example, N_{BF} transmission antennas) and reception antennas Rx #1 to Rx #8. The arrangement of RA #1 to RA #16 of the reverse-circularly-polarized virtual reception antennas is also represented, for example, as VA #33 to VA #48. The arrangement of RA #1 to RA #16 of the reverse-circularly-polarized virtual reception antennas is the same as the arrangement of CA #1 to CA #16 of the forward-circularly-polarized virtual reception antennas.

Note that since (b) in FIG. 17 includes the arrangement overlap in the X-axis (lateral direction in FIG. 17), the antennas shifted in the vertical direction are illustrated in (b) of FIG. 17. However, the antennas are arranged one-dimensionally at positions on the X-axis. In addition, the combination of the transmission antenna polarization and the reception antenna polarization in each virtual reception antenna is different for each antenna, and is thus referred to as “(transmission antenna polarization/reception antenna polarization).” For example, a virtual reception antenna in the case of horizontally polarized transmission and vertically polarized reception is described as “H/V”

Note that, with reference to (a) of FIG. 17, a description has been given of an exemplary case in which reception antennas 202 include a forward-circularly-polarized antenna, but the type of polarized antennas included in reception antennas 202 is not limited to this, and other types of polarized antennas may be applied.

Here, antenna arrangement examples 1 to 3 described above are examples in which virtual reception antennas of the same polarization between the transmission and reception antennas are arranged at uniform spacings D_{H} (for example, D_{H}=0.5-wavelength spacings). However, the present disclosure is not limited to such an arrangement, and the arrangement of the virtual reception antennas of the same polarization between the transmission and reception antennas may partly include a spacing D_{H} (for example, D_{H}=0.5-wavelength spacing). An antenna arrangement example achieving such an arrangement will be described below.

### Antenna Arrangement Example 4

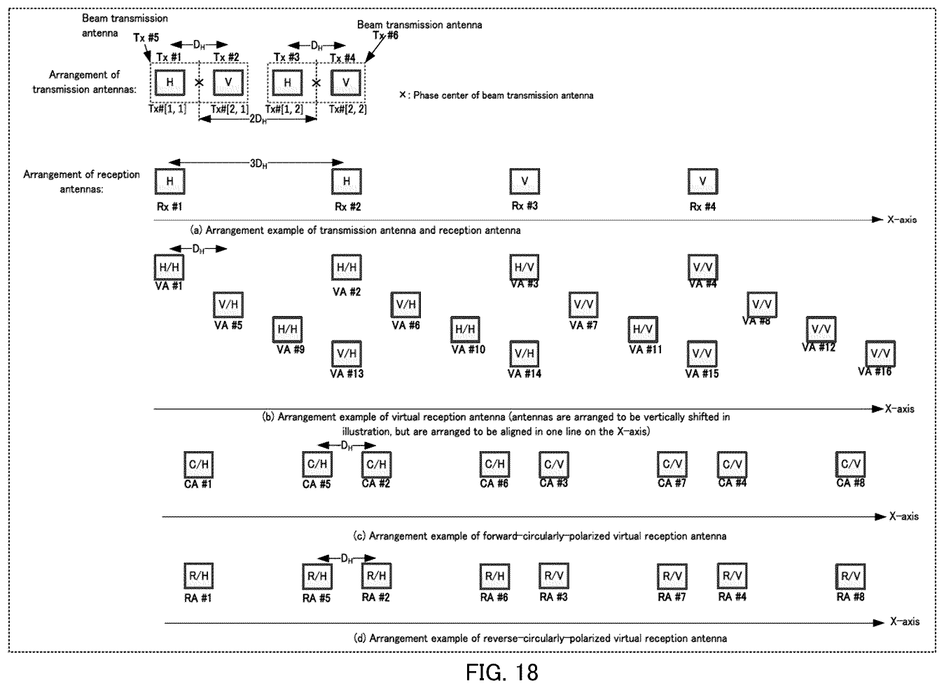

FIG. 18 illustrates an arrangement in which the arrangement of the virtual reception antennas of the same polarization between the transmission and reception antennas partly includes spacing D_{H} (e.g., D_{H}=0.5-wavelength spacing).

Arrangement of VA #1 to VA #16 of virtual reception antennas (or MIMO virtual antennas) as illustrated at (b) in FIG. 18 is constituted by the arrangement of transmission antennas Tx #1 to Tx #4 (e.g., Nt transmission antennas 109) and reception antennas Rx #1 to Rx #4 (e.g., Na reception antennas) as illustrated at (a) in FIG. 18.

Further, in (a) of FIG. 18, the arrangement of CA #1 to CA #8 of the forward-circularly-polarized virtual reception antennas as illustrated in (c) of FIG. 18 is formed by the arrangement of forward-circularly-polarized beam transmission antennas Tx #5 and Tx #6 (for example, N_{BF} transmission antennas) and reception antennas Rx #1 to Rx #8. The arrangement of CA #1 to CA8 # of the forward-circularly-polarized virtual reception antennas is also expressed, for example, as VA #17 to VA #24.

In (a) of FIG. 18, the arrangement of RA #1 to RA #8 of the reverse-circularly-polarized virtual reception antennas as illustrated in (d) of FIG. 18 is formed by the arrangement of reverse-circularly-polarized beam transmission antennas Tx #5 and Tx #6 (for example, N_{BF} transmission antennas) and reception antennas Rx #1 to Rx #8. The arrangement of RA #1 to RA #8 of the reverse-circularly-polarized virtual reception antennas is also represented, for example, as VA #17 to VA #24. The arrangement of RA #1 to RA #8 of the reverse-circularly-polarized virtual reception antennas are the same as the arrangement of CA #1 to CA #8 of the forward-circularly-polarized virtual reception antennas.

Note that since (b) in FIG. 18 include the arrangement overlap in the X-axis (lateral direction in FIG. 18), the antennas shifted in the vertical direction are illustrated in (b) of FIG. 18. However, the antennas are arranged one-dimensionally at positions on the X-axis. In addition, the combination of the transmission antenna polarization and the reception antenna polarization in each virtual reception antenna is different for each antenna, and is thus referred to as “(transmission antenna polarization/reception antenna polarization).” For example, a virtual reception antenna in the case of horizontally polarized transmission and vertically polarized reception is described as “H/V”

As illustrated in (a) of FIG. 18, the spacing between beam transmission antennas Tx #5 and Tx #6 is set to a spacing of 2D_{H} (for example, 1 wavelength in the case of D_{H}=0.5-wavelength spacing), and the spacing between reception antennas Rx #1 to Rx #4 is set to a spacing of 3D_{H} (for example, 1.5 wavelengths in the case of D_{H}=0.5-wavelengths spacing). As a result, a virtual reception antenna arrangement including spacing D_{H} and spacing 2D_{H} is obtained for the forward-circularly-polarized virtual reception antenna arrangement illustrated in (c) of FIG. 18 and the reverse-circularly-polarized virtual reception antenna arrangement illustrated in (d) of FIG. 18. Thus, the direction estimation for the forward circular polarization and the reverse circular polarization is by a virtual reception antenna arrangement including the spacing of 2D and thus including the spacing of D_{H} while increasing the aperture length, and, therefore, by the arrangement capable of suppressing grating lobes while increasing the angular resolution.

In antenna arrangement example 4, beam transmission antennas Tx #5 and Tx #6 transmit the beam by using a plurality of transmission antennas 109, and thus have a spacing equal to or greater than about 1 wavelength. Therefore, the antenna arrangement in which a difference between, on one hand, the spacing between the beam transmission antennas and, on the other hand, the spacing between reception antennas 202 is the spacing of D_{H} makes it possible to obtain the virtual reception antenna arrangement including the spacing of D_{H} and a wider spacing than the spacing of D_{H} for the forward-circularly-polarized virtual reception antenna arrangement and the reverse-circularly-polarized virtual reception antenna arrangement. Accordingly, in the direction estimation for the forward circular polarization and the reverse circular polarization, the aperture length is increased and the spacing of D_{H} is included, and, therefore, the angular resolution can be improved and the grating lobe can be suppressed.

In the above-described arrangement example, the virtual reception antennas are arranged one-dimensionally in the horizontal direction, for example, but the present disclosure is not limited to such an arrangement, and transmission/reception antennas arranged in a two-dimensional plane including the horizontal direction and the vertical direction may be used. By using such an arrangement, for example, a two-dimensional direction estimation result in the horizontal direction and the vertical direction can be obtained by the direction estimation processing on the target object.

Further, D_{H} is not limited to 0.5 wavelengths, and may be set to, for example, about 0.45 wavelengths to 0.8 wavelengths (for example, any value in the range of from 0.45λ to 0.8λ).

The antenna arrangement example has been described above.

As described above, in the present embodiment, in each transmission period, radar apparatus 10 performs multiplexing transmission of a radar transmission signal from the plurality of transmission antennas 109, the radar transmission signal being given a phase rotation amount (for example, a phase rotation amount corresponding to a orthogonal code sequence) providing a difference in phase by 90° or −90° between a horizontally polarized antenna and a vertically polarized antenna, which are at least one set of adjacent transmission antennas 109 among the plurality of transmission antennas 109.

Thus, the reception signal for each transmission period corresponding to the signal transmitted from the at least one set of adjacent transmission antennas 109 can be regarded as the reception signal corresponding to the radar transmission signal transmitted with circular polarization (for example, a forward circular polarization or a reverse circular polarization) different from the linear polarization (for example, a horizontal polarization or a vertical polarization) corresponding to each of transmission antennas 109. Thus, radar apparatus 10 can perform multiplexing transmission using circular polarization in addition to linear polarization by using a plurality of transmission antennas 109 that are, for example, linearly polarized antennas.

Therefore, according to the present embodiment, for example, even when four types of polarized waves of the left-handed circularly polarized wave and the right-handed circularly polarized wave in addition to the vertically polarized wave and the horizontally polarized wave are transmitted, it is possible to suppress an increase in the number of transmission antennas 109 to be used and improve the detection accuracy of the target object in radar apparatus 10.

Note that the codes, Code₁ and Code₂, used in the present embodiment represent codes in a case where the phase difference between the transmission antennas 109 are corrected in advance. Therefore, the phase difference between the feeding points of transmission antennas 109 is the phase difference between the code elements of the codes, Code₁ and Code₂, applied to transmission antennas 109. Here, when radar apparatus 10 performs transmission using Code₁={OC₁(1), OC₁(2)}, Code₂={OC₂(1), OC₂(2)}, the phase differences between the code elements are given by angle [OC₂(1)]-angle[OC₁(1)] and angle [OC₂(2)]-angle[OC₁(2)]. Therefore, in the present embodiment, when radar apparatus 10 uses the same Doppler multiplexed signal and transmits it from two transmission antennas 109 using, for example, Code₁={1, 1} and Code₂={j, −j} as an orthogonal code sequence having a code length Loc of 2 and N_{CM}=2, the phase difference between the feeding points of two transmission antennas 109 is angle [OC₂(1)]-angle[OC₁(1)]=900 and angle [OC₂(2)]-angle[OC₁(2)]=−90°, and the phase difference between the feeding points of two transmission antennas 109 is 90° or −90° for each transmission period.

Similarly, in the present embodiment, when radar apparatus 10 uses the same Doppler multiplexed signal from two transmission antennas 109 and transmits it using, for example, Code₁={A, B}, Code₂={−j×A, j×B} as an orthogonal code sequence having a code length Loc of 2 and N_{CM} of 2, the phase difference between the feeding points of two transmission antennas 109 is angle [OC₂(1)]-angle[OC₁(1)]=−90° and angle [OC₂(2)]-angle[OC₁(2)]=90°, and the phase difference between the feeding points of two transmission antennas 109 is 90° or −90° for each transmission period.

Similarly, in the present embodiment, when radar apparatus 10 uses the same Doppler multiplexed signal and transmits it from two transmission antennas 109 using, for example, Code₁={A, B}, Code₂={exp(jξ)×A, −exp(jξ)×B} as an orthogonal code sequence having a code length Loc of 2 and N_{CM}=2, the phase difference between the feeding points of two transmission antennas 109 is angle [OC₂(1)]-angle[OC₁(1)]=ξ and angle [OC₂(2)]-angle[OC₁(2)]=−ξ, and the phase difference between the feeding points of the two transmission antennas at each transmission period is ξ or −ξ. Here, for example, it is possible to use a range of from π/6 to 5π/6 radians (=30° to 150°) for ξ. The same applies to Variation 1 and Variation 2 below.

### Variation 1 of Embodiment 1

In Embodiment 1, number N_{DM} of Doppler multiplexing may be set to 1, and MIMO multiplexing transmission may be performed using code multiplexing without using Doppler multiplexing.

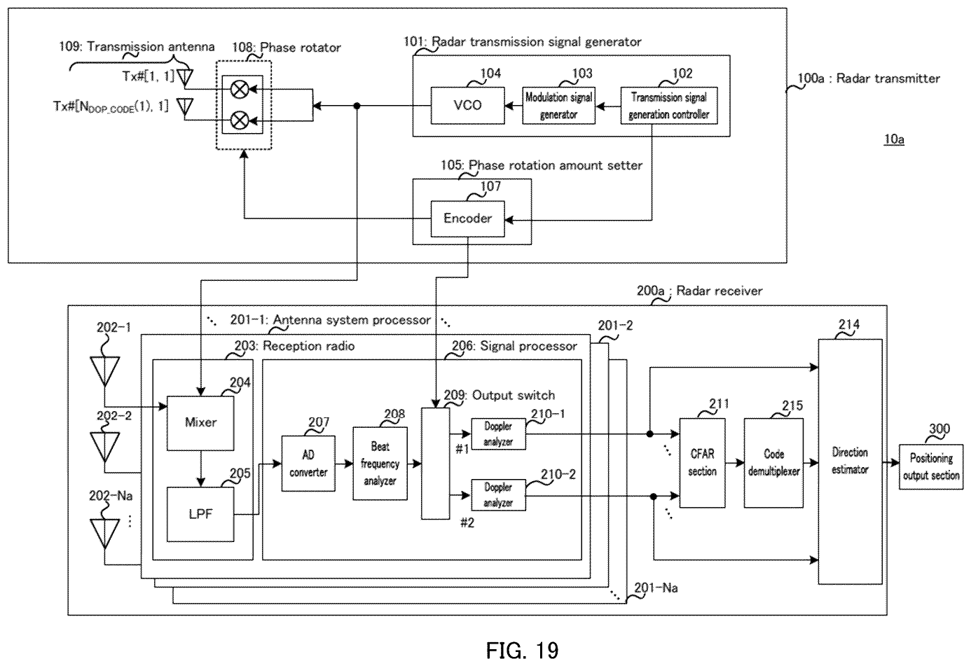

FIG. 19 illustrates an exemplary configuration of radar apparatus 10a according to Variation 1 of Embodiment 1. The configuration in Variation 1 of Embodiment 1 does not use Doppler multiplexing and thus does not include components in the configuration of radar apparatus 10 of FIG. 1 which are relevant to the Doppler multiplexing transmission and reception operations (for example, Doppler shift setter 106 and coded Doppler demultiplexer 212) but includes code demultiplexer 215 instead of coded Doppler demultiplexer 212.

In the example of FIG. 19, in radar apparatus 10a, number N_{DM} of Doppler multiplexing is set to 1, and code multiplexing is performed with a code having a code length of 2. Thus, in FIG. 19, the configuration is such that number Nt of transmission antennas is 2. Transmission antennas 109 may perform code multiplexing transmission as in Embodiment 1, for example, by using differently linearly polarized antennas (for example, horizontal polarization and vertically polarized antennas). As a result, in radar apparatus 10a, transmission of the reception signals of the forward circular polarization and the reverse circular polarization becomes possible in addition to the reception signals of the linearly polarized antennas (for example, horizontal polarization and vertically polarized antennas) and, thus, the reception signals of the forward-circularly-polarized wave and the reverse-circularly-polarized wave can be obtained.

In this case, radar apparatus 10a is configured with differently linearly polarized antennas (for example, horizontal polarization and vertically polarized antennas) and beam transmission antennas with a forward circular polarization and a reverse circular polarization, and is configured with one transmission antenna for each polarization. When a plurality of Na reception antennas 202 are provided, a Single In Multiple Output (SIMO) configuration is achieved in which 1×Na virtual reception antennas are obtained for each polarization.

Hereinafter, exemplary operations of the components of radar apparatus 10a illustrated in FIG. 19 will be described.

In radar apparatus 10a illustrated in FIG. 19, the operation of radar transmitter 100a is the same as the operation of Embodiment 1 when number N_{DM} of Doppler multiplexing is 1, phase rotation amount φ₁ to which first Doppler shift amount DOP₁ is applied is 0, N_{DOP_CODE}(1)=N_{CM}=2, and number Nt of transmission antennas is 2. Therefore, the explanation of the operation is omitted.

Next, an exemplary operation of radar receiver 200a of radar apparatus 10a illustrated in FIG. 19 will be described.

Since the operations of the components from reception antenna 202 to antenna system processor 201 are the same as those of Embodiment 1, the description of the operations is omitted.

CFAR section 211 performs an operation to be performed when the Doppler domain compression CFAR processing is not used because Doppler multiplexing transmission is not performed (for example, number N_{DM} of Doppler multiplexing=1).

Code demultiplexer 215 separates a code-multiplexed and transmitted signal using distance index f_{b_cfar} and Doppler frequency index f_{s_cfar} that are the output of CFAR section 211 (the output when the Doppler domain compression CFAR processing is not used), and, the output of Doppler analyzer 210. Code demultiplexer 215 outputs the separated reception signal of the code-multiplexed signal to direction estimator 214.

For example, code demultiplexer 215 performs demultiplexing reception of the code multiplexed signal by multiplying the code multiplexed signal by the complex conjugate of the code used for multiplexing transmission as given by following Expression 67. Demultiplexed reception signal Y_{z}(f_{b_cfar}, f_{s_cfar}, ncm) of the code-multiplexed signal is outputted to direction estimator 214.

$${Y}_{z} ( {f}_{{b}_{-} cfar} , {f}_{{s}_{-} cfar} , ncm ) = {Code}_{ncm}^{*} \{ α ( {f}_{{s}_{-} cfar} ) ⊗ {VFTALL}_{z} ( {f}_{{b}_{-} cfar} , {f}_{{s}_{-} cfar} ) \} \qquad ( Expression 67 )$$

Here, Y_{z}(f_{b_cfar}, f_{s_cfar}, ncm) are outputs obtained by demultiplexing the code-multiplexed signal from VFTALL_{z}(f_{b_cfar}, f_{s_cfar}) which are the outputs of Doppler analyzers 210 in zth antenna system processor 201 for distance index f_{b_cfar} and Doppler frequency index f_{s_cfar} using orthogonal code Code_{ncm} at the time of transmission. Note that z=1 to Na, and ncm=1 to N_{CM}.

Here, Doppler phase correction vector α(f_{s_cfar}) is expressed by following Expression 68. Doppler phase correction vector α (f_{s_cfar}) given by Expression 68 is a vector having, as elements, a Doppler phase correction factor for correcting a phase rotation of a Doppler component at Doppler frequency index f_{s_cfar} caused by a time lag of Tᵣ in output VFT_{z}²(f_{b_cfar}, f_{s_comp_cfar}) of second Doppler analyzer 210 with reference to the Doppler analysis time for output VFT_{z}¹(f_{b_cfar}, f_{s_comp_cfar}) of first Doppler analyzer 210, for example.

$$[ 71 ]$$

$$α ( {f}_{{s}_{-} cfar} ) = {[ 1 , exp ( - \frac{j 2 π {f}_{{s}_{-} cfar}}{{N}_{code}} \times \frac{1}{{L}_{oc}} ) ]}^{T} \qquad ( Expression 68 )$$

In addition, VFTALL_{z}(f_{b_cfar}, f_{s_cfar}) given by Expression 67 is, for example, components extracted based on distance index f_{b_cfar} and Doppler frequency index f_{s_cfar} extracted by CFAR section 211, from among outputs VFT_{z}^{noc} (f_{b}, fₛ) from two Doppler analyzers 210 in zth antenna system processor 201 are values expressed in a vector format as given by following Expression 69. Note that, noc=1, 2.

$$[ 72 ]$$

$$\begin{matrix}{VFTALL}_{z} ( {f}_{{b}_{-} cfar} , {f}_{{s}_{-} cfar} ) = {[ {VFT}_{z}^{1} ( {f}_{{b}_{-} cfar} , {f}_{{s}_{-} cfar} ) {VFT}_{z}^{2} ( {f}_{{b}_{-} cfar} , {f}_{{s}_{-} cfar} ) ]}^{T} & ( Expression 69 )\end{matrix}$$

In FIG. 19, direction estimator 214 performs target direction estimation processing (hereinafter, referred to as direction estimation processing with respect to linear polarization) based on separated reception signal Y_{z}(f_{b_cfar}, f_{s_cfar}, ncm) of the code multiplexed signal for distance index f_{b_cfar} and Doppler frequency index f_{s_cfar} inputted from code demultiplexer 215.

Further, direction estimator 214 performs the target direction estimation processing (hereinafter, referred to as direction estimation processing with respect to a forward circular polarization) based on an output from first Doppler analyzer 210 (in FIG. 19, Doppler analyzer 210-1).

Further, direction estimator 214 performs the target direction estimation processing (hereinafter, referred to as direction estimation processing with respect to a reverse circular polarization) based on an output from second Doppler analyzer 210 (in FIG. 19, Doppler analyzer 210-2).

The direction estimation processing in direction estimator 214 may include, for example, the direction estimation processing with respect to linear polarization, direction estimation processing with respect to forward circular polarization, and direction estimation processing with respect to reverse circular polarization. Hereinafter, each types of direction estimation processing will be described.

<Direction Estimation Processing with Respect to Linear Polarization>

For example, direction estimator 214 generates virtual reception array correlation vector h(f_{b_cfar}, f_{s_cfar}) as illustrated in following Expression 70 based on the outputs of code demultiplexer 215 to perform the direction estimation processing.

Virtual reception array correlation vector h(f_{b_car}, f_{s_cfar}) includes Nt×Na elements that are the product of number Nt of transmission antennas and number Na of reception antennas.

$$[ 73 ]$$

$$h ( {f}_{{b}_{-} cfar} , {f}_{{s}_{-} cfar} ) = [ \begin{matrix}{Y}_{1} ( {f}_{{b}_{-} cfar} , {f}_{{s}_{-} cfar} , 1 ) \\ {Y}_{2} ( {f}_{{b}_{-} cfar} , {f}_{{s}_{-} cfar} , 1 ) \\ ⋮ \\ {Y}_{Na} ( {f}_{{b}_{-} cfar} , {f}_{{s}_{-} cfar} , 1 ) \\ {Y}_{1} ( {f}_{{b}_{-} cfar} , {f}_{{s}_{-} cfar} , 2 ) \\ {Y}_{2} ( {f}_{{b}_{-} cfar} , {f}_{{s}_{-} cfar} , 2 ) \\ ⋮ \\ {Y}_{Na} ( {f}_{{b}_{-} cfar} , {f}_{{s}_{-} cfar} , 2 )\end{matrix} ] \qquad ( Expression 70 )$$

Based on phase differences between reception antennas 202, direction estimator 214 performs the direction estimation processing on the reflected wave signals from a target using virtual reception array correlation vector h(f_{b_cfar}, f_{s_cfar}).

Here, virtual reception array correlation vector h(f_{b_cfar}, f_{s_car}) includes reflected wave reception signals of signals transmitted from differently linearly polarized antennas (e.g., vertically polarized antennas and horizontally polarized antennas). Therefore, direction estimator 214 may extract, from virtual reception array correlation vector h(f_{b_cfar}, f_{s_cfar}), an element that is a combination of the polarization of predetermined transmission antenna 109 and the polarization of reception antenna 202, and perform the direction estimation processing using the virtual reception array correlation vector including the extracted element. It is thus possible to obtain the direction estimation result per polarizations of predetermined transmission antenna 109 and reception antenna 202.

<Direction Estimation Processing with Respect to Forward Circular Polarization>

Direction estimator 214 generates forward-circularly-polarized virtual reception array correlation vector h_{c1}(f_{b_cfar}, f_{s_cfar}) as given by following Expression 71 based on the output of first Doppler analyzer 210, and performs direction estimation processing on the target with respect to the forward circular polarization.

Here, forward-circularly-polarized virtual reception array correlation vector h_{c1}(f_{b_cfar}, f_{s_comp_cfar}) includes a reflected wave reception signal that is based on the output of first Doppler analyzer 210 (e.g., VFT_{z}¹(f_{b_cfar}, f_{s_cfar})) and that is of a signal code-multiplexed and transmitted with beams by differently-linearly-polarized adjacent transmission antennas 109 and circularly polarized. For example, when there are one beam transmission antenna, forward-circularly-polarized virtual reception array correlation vector h_{c1}(f_{b_car}, f_{s_cfar}) contains 1×Na elements. Based on the phase differences between reception antennas 202, direction estimator 214 performs direction estimation on the reflected wave signals from the target using forward-circularly-polarized virtual reception array correlation vector h_{c1}(f_{b_cfar} and f_{s_cfar}).

$$[ 74 ]$$

$${h}_{c 1} ( {f}_{{b}_{-} cfar} , {f}_{{s}_{-} cfar} ) = [ \begin{matrix}{VFT}_{1}^{1} ( {f}_{{b}_{-} cfar} , {f}_{{s}_{-} cfar} ) \\ {VFT}_{2}^{1} ( {f}_{{b}_{-} cfar} , {f}_{{s}_{-} cfar} ) \\ ⋮ \\ {VFT}_{{N}_{a}}^{1} ( {f}_{{b}_{-} cfar} , {f}_{{s}_{-} cfar} )\end{matrix} ] \qquad ( Expression 71 )$$

<Direction Estimation Processing with Respect to Reverse Circular Polarization>

Direction estimator 214 performs direction estimation processing on the target with respect to the reverse circular polarization based on the output of second Doppler analyzer 210. Direction estimator 214 generates, for example, reverse-circularly-polarized virtual reception array correlation vector h_{c2}(f_{b_cfar}, f_{s_cfar}) as given by following Expression 72, and performs direction estimation processing on the target with respect to the reverse circular polarization.

Here, reverse-circularly-polarized virtual reception array correlation vector h_{c2}(f_{b_cfar}, f_{s_cfar}) includes a reflected wave reception signal that is based on an output (e.g., VFT_{z}²(f_{b_cfar}, f_{s_cfar})) of second Doppler analyzer 210 and that is of a signal code-multiplexed and transmitted by differently-linearly-polarized adjacent transmission antennas 109 and circularly polarized. For example, when there is one beam transmission antenna, reverse-circularly-polarized virtual reception array correlation vector h_{c2}(f_{b_cfar}, f_{s_cfar}) includes 1×Na elements.

Direction estimator 214 performs direction estimation based on the phase difference between reception antennas 202 on the reflected wave signal from the target using reverse-circularly-polarized virtual reception array correlation vector h_{c2}(f_{b_cfar}, f_{s_cfar}).

$$[ 75 ]$$

$${h}_{c 2} ( {f}_{{b}_{-} cfar} , {f}_{{s}_{-} cfar} ) = [ \begin{matrix}{VFT}_{1}^{2} ( {f}_{{b}_{-} cfar} , {f}_{{s}_{-} cfar} ) \\ {VFT}_{2}^{2} ( {f}_{{b}_{-} cfar} , {f}_{{s}_{-} cfar} ) \\ ⋮ \\ {VFT}_{{N}_{a}}^{2} ( {f}_{{b}_{-} cfar} , {f}_{{s}_{-} cfar} )\end{matrix} ] \qquad ( Expression 72 )$$

The direction estimation processing with respect to linear polarization using virtual reception array correlation vector h(f_{b_cfar}, f_{s_cfar}) in direction estimator 214, the direction estimation processing with respect to forward circular polarization using forward-circularly-polarized virtual reception array correlation vector h_{c1}(f_{b_cfar}, f_{s_cfar}), and the direction estimation processing with respect to reverse circular polarization using reverse-circularly-polarized virtual reception array correlation vector h_{c2}(f_{b_cfar}, f_{s_cfar}) are the same as those in Embodiment 1, and therefore, the operation thereof will not be described.

Direction estimator 214 may perform direction estimation processing using a reception signal including a combination of different types of polarization. In this case, a direction estimation result less dependent on the polarization is obtained. Further, by performing the direction estimation processing using more virtual antennas, the reception SNR can be improved, and the detecting performance in radar apparatus 10a can be improved. Further, since the direction estimation processing using the maximum aperture length of the available virtual reception antennas is performed, the angular resolution is also improved. For example, when the direction estimation processing is performed using all the virtual reception antennas, it is possible to use up to (Nt×Na+2×N_{BF}×Na)=4Na virtual reception antennas since Nt=2 and N_{BF}=1, and more virtual reception antennas than 2Na (=Nt×Na) can be used.

Further, direction estimator 214 may perform the direction estimation processing using the polarized antennas of the same type between the transmission and reception as described above, and the direction estimation processing in which different types of polarization are combined between the transmission and the reception, and both of the direction estimation results may be used as the direction estimation processing result. As a result, a direction estimation processing result highly dependent on the polarization and a direction estimation processing result less dependent on the polarization are obtained. The result of such direction estimation processing may be input to a target object identification processor not illustrated in the figures, and target object identification processing may be performed.

In order to configure single-transmission SIMO for each of four types of polarized waves (differently linearly polarized antennas (for example, vertically polarized antennas and horizontally polarized antennas) and forward/reverse circular polarizations), four transmission antennas are used in the conventional methods. On the other hand, in the configuration of FIG. 19, two transmission antennas 109 can achieve configuration of single transmission SIMO for each of the four polarizations, and thus the number of transmission antennas can be reduced. In addition, since radar apparatus 10a performs code multiplexing transmission, transmission time can be shortened. For example, compared with the case where four transmission antennas 109 are switched in a time division manner, the effect of halving the transmission time is also obtained.

In addition, the configuration has a smaller number of transmission antennas than that of Embodiment 1, but the same effect as that of Embodiment 1 can be obtained. Hereinafter, a specific example of the antenna arrangement will be described.

### Antenna Arrangement Example 5

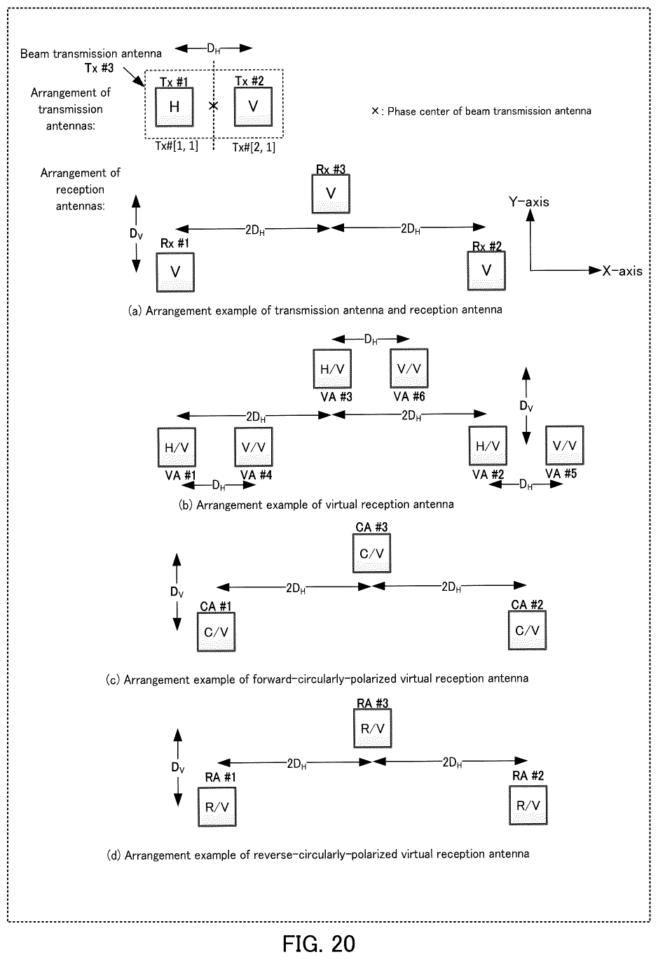

FIG. 20 illustrates an antenna arrangement example in which a single type of polarization of reception antenna 202 is used (for example, V). Arrangement of VA #1 to VA #6 of virtual reception antennas (or MIMO virtual antennas) as illustrated at (b) in FIG. 20 is constituted by the arrangement of transmission antennas Tx #1 to Tx #2 (e.g., Nt transmission antennas 109) and reception antennas Rx #1 to Rx #3 (e.g., Na reception antennas) as illustrated at (a) in FIG. 20. Further, in (a) of FIG. 20, the arrangement of CA #1 to CA #3 of the forward-circularly-polarized virtual reception antennas as illustrated in (c) of FIG. 20 is formed by the arrangement of forward-circularly-polarized beam transmission antenna Tx #3 (for example, N_{BF} transmission antennas) and reception antennas Rx #1 to Rx #3. The arrangement of CA #1 to CA #3 of the forward-circularly-polarized virtual reception antennas is also expressed, for example, as VA #7 to VA #9.

In (a) of FIG. 20, the arrangement of RA #1 to RA #3 of the reverse-circularly-polarized virtual reception antennas as illustrated in (d) of FIG. 20 is formed by the arrangement of reverse-circularly-polarized beam transmission antennas Tx #3 (for example, N_{BF} transmission antennas) and reception antennas Rx #1 to Rx #3. The arrangement of RA #1 to RA #3 of the reverse-circularly-polarized virtual reception antennas is also referred to as VA #7 to VA #9. The arrangement of RA #1 to RA #3 of the reverse-circularly-polarized virtual reception antennas is the same as the arrangement of CA #1 to CA #3 of the forward-circularly-polarized virtual reception antennas.

In addition, the combination of the transmission antenna polarization and the reception antenna polarization in each virtual reception antenna is different for each antenna, and is thus referred to as “(transmission antenna polarization/reception antenna polarization).” For example, a virtual reception antenna in the case of horizontally polarized transmission and vertically polarized reception is described as “H/V”

Note that, with reference to (a) of FIG. 20, a description has been given of an exemplary case in which reception antennas 202 include a vertically polarized antenna, but the type of polarized antennas included in reception antennas 202 is not limited to this, and other types of polarized antennas may be applied. For example, a horizontally polarized antenna or a circularly polarized antenna may also be applied. Alternatively, a plurality of types of polarized antennas may be applied to any of Rx #1 to Rx #3.

Here, in the arrangement illustrated in (a) of FIG. 20, reception antennas Rx #1, Rx #3, and Rx #2 (adjacent reception antennas 202) are arranged in the X-axis direction (for example, the horizontal direction) at an antenna spacing of 2D_{H} with respect to an antenna spacing of D_{H} of transmission antennas Tx #1 and Tx #2 of the different linear polarizations constituting beam transmission antenna Tx #3, and a part of reception antennas Rx #1, Rx #3, Rx #2 is arranged with an offset of an antenna spacing of Dᵥ in the Y-axis direction (for example, the vertical direction) with respect to the other antennas. With such an arrangement, the following effects can be obtained.

For example, the arrangement of reception antennas 202 as illustrated in (a) of FIG. 20 includes Rx #3 that is arranged to be offset by a spacing of D_{V} in the Y-axis direction (for example, the vertical direction) perpendicular to reception antennas Rx #1 and Rx #2 arranged in a line in the X-axis direction (for example, the horizontal direction) and, thus, two-dimensional direction estimation in the X-axis direction and the Y-axis direction (for example, a vertical direction and a horizontal direction) can be performed. For example, by setting D_{V} to a half-wavelength spacing, generation of the grating lobe can be suppressed in angle measurement processing in the range of 90° in the vertical direction.

Note that D_{V} is not limited to the half-wavelength spacing, and may be set to a spacing shorter than the wavelength (λ) of the radar transmission signal. For example, each D_{V} may be set to approximately 0.45λ to 0.8λ (e.g., any value in the range of from 0.45λ to 0.8λ). Note that λ represents the wavelength of the carrier frequency of the radar transmission signal. For example, when a chirp signal is used as the radar transmission signal, λ is the wavelength of the center frequency in the frequency sweep band of the chirp signal.

Further, since transmission antennas Tx #1 and Tx #2 are arranged at an antenna spacing of D_{H} in a line in the X-axis direction as illustrated in (a) of FIG. 20, the antenna spacings between VA #1 and VA #4, VA #2 and VA #5, and VA #3 and VA #6 are D_{H} as illustrated in the arrangement of the virtual reception antenna illustrated in (b) of FIG. 20.

Further, reception antennas Rx #1, Rx #3, and Rx #2 are arranged in the X-axis direction (e.g., the horizontal direction) at the antenna spacing of 2D_{H} as illustrated in (a) of FIG. 20, a difference between, on one hand, the spacing between transmission antennas Tx #1 and Tx #2 (e.g., D_{H}) and, on the other had, the spacing between reception antennas 202 is the spacing of D_{H}, and the virtual reception antenna arrangement includes the spacing of D_{H}. For example, as illustrated in the arrangement of the virtual reception antennas illustrated in (b) of FIG. 20, the antenna spacings between VA #1, VA #4, VA #3, VA #6, VA #2 and VA #5 are D_{H} (however, VA #3 and VA #6 are offset in the Y-axis direction (for example, the vertical direction) by the spacing of D_{V}).

For example, by setting D_{H} to the half-wavelength spacing, generation of a grating lobe can be suppressed in angle measurement processing in the range of ±90° in the horizontal direction. In addition, since the antennas are arranged at equal antenna spacings of D_{H}, sidelobe suppression in the angle measuring process can be achieved, and the performance of detecting a plurality of target objects can be improved.

Note that D_{H} is not limited to the half-wavelength spacing, and may be set to a spacing shorter than the wavelength (λ) of the radar transmission signal. For example, each D_{H} may be set to approximately 0.45λ to 0.8λ (e.g., any value in the range of from 0.45λ to 0.8λ). Note that λ represents the wavelength of the carrier frequency of the radar transmission signal. For example, when a chirp signal is used as the radar transmission signal, λ is the wavelength of the center frequency in the frequency sweep band of the chirp signal. The same applies to the following arrangement example.

Further, when radar apparatus 10a extracts an element that is a combination of the polarization of predetermined transmission antenna 109 and the polarization of reception antenna 202 and performs the direction estimation processing using the virtual reception array correlation vector composed of the extracted element in the direction estimation processing with respect to the linear polarization by direction estimator 214, the direction estimation processing is performed using virtual reception antennas VA #1, VA #2, and VA3, and the direction estimation result depending on the transmission and reception characteristics between cross-polarized antennas is obtained, for example, when the combination of the horizontally polarized transmission antenna and the vertically polarized antenna is used as the combination of the cross polarization.

Further, for example, when a combination of a vertically polarized transmission antenna and a vertically polarized antenna is used as a combination of the same type of polarization, radar apparatus 10a performs direction estimation processing using virtual reception antennas VA #4, VA #5, and VA #6, and can obtain a direction estimation result dependent on the transmission and reception characteristics of the same type of polarization. By using the direction estimation results of the former and the latter combinations of transmission antennas and reception antennas, it is possible to improve detection and identification performance.

When radar apparatus 10a extracts an element that is a combination of the polarization of predetermined transmission antenna 109 and the polarization of reception antenna 202 and performs the direction estimation processing using the virtual reception array correlation vector composed of the extracted element, the element spacing in the X-axis direction (for example, the horizontal direction) is the antenna spacing of 2D_{H}, which is one wavelength, when the antenna spacing D_{H} is a half wavelength. Thus, a grating lobe is generated in the angle measurement processing within the range of 900 in the horizontal direction.

Therefore, when the sensing angle range assumed by radar apparatus 10a is wider than the angle at which the grating lobes are generated, the radar apparatus is more likely to erroneously detect, as a target (target object), a false peak caused by the grating lobes within the sensing angle range, and the detection performance of radar apparatus 10a may deteriorate.

However, direction estimator 214 can suppress the grating lobe by performing the direction estimation processing using a reception signal including a combination of different types of polarization. Direction estimator 214 performs direction estimation processing using, for example, virtual reception antennas VA #1 to VA #6 as a reception signal including a combination of different types of polarization. As a result, an arrangement is achieved which includes the element spacing of an antenna spacing of D_{H} in the X-axis direction (for example, the horizontal direction), and the grating lobe can be suppressed in the angle measurement processing within the range of 90° in the horizontal direction.

Further, since direction estimator 214 performs the direction estimation processing using the maximum aperture length of the available virtual reception antennas, the angular resolution is also improved. Further, since direction estimator 214 performs the direction estimation processing using all of the available virtual reception antennas, the reception SNR is also improved.

Further, direction estimator 214 performs direction estimation processing using CA #1, CA #2, and CA #3 in the direction estimation processing with respect to the forward circular polarization. Similarly, direction estimator 214 performs direction estimation processing using RA #1, RA #2, and RA #3 in the direction estimation processing with respect to the reverse circular polarization. As a result, a combination of a forward- or reverse-circularly-polarized transmission antenna and a vertically polarized antenna is used and, thus, a direction estimation result dependent on the transmission and reception characteristics of the polarizations can be obtained, and the detection and identification performance can be improved.

Note that, when the antenna spacing D_{H} is a half wavelength in the direction estimation processing using CA #1, CA #2, and CA #3 or the direction estimation processing using RA #1, RA #2, and RA #3, the element spacing in the X-axis direction (for example, the horizontal direction) is the antenna spacing 2D_{H}, which is one wavelength. Thus, the grating lobes are generated in the angle measurement processing within the range of 90° in the horizontal direction. However, direction estimator 214 can suppress the grating lobes by performing the direction estimation processing using the reception signals including the combinations of the different types of polarizations.

Direction estimator 214 performs direction estimation processing using, for example, virtual reception antennas VA #1 to VA #6, CA #1, CA #2, CA #3, RA #1, RA #2, RA #3 as reception signals including combinations of different types of polarizations. As a result, an arrangement is achieved which includes the element spacing of an antenna spacing of D_{H} in the X-axis direction (for example, the horizontal direction), and the grating lobe can be suppressed in the angle measurement processing within the range of 90° in the horizontal direction. Further, since direction estimator 214 performs the direction estimation processing using the maximum aperture length of the available virtual reception antennas, the angular resolution is also improved. In addition, since the direction estimation processing is performed using all of the available virtual reception antennas, the reception SNR is also improved.

### Variation 2 of Embodiment 1

Although the configuration of FIG. 19 in Variation 1 of Embodiment 1 illustrates a configuration in which number Nt of transmission antennas is 2, and single transmission SIMO is configured for each of the four types of polarizations (differently linearly polarized antennas (for example, vertically polarized antennas and horizontally polarized antennas) and forward/reverse circular polarizations), a MIMO configuration can be configured for each of the four types of polarizations by combined use of time division multiplexing and by switching transmission antennas 109 that perform code multiplexing in a time division manner.

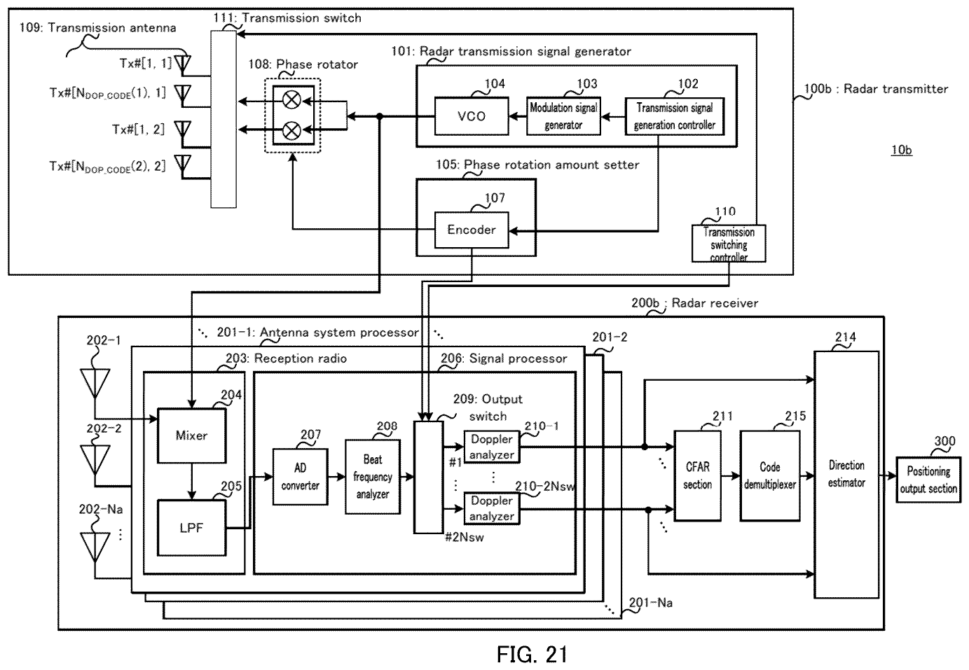

For example, FIG. 21 illustrates a configuration example of radar apparatus 10b according to Variation 2 of Embodiment 1. Regarding radar apparatus 10b, for example, a configuration example is illustrated in which number Nt of transmission antennas is 4, the pair of two transmission antennas 109 for code multiplexing is switched in a time division manner, and two transmission MIMO is configured for each of the four types of polarizations.

In radar apparatus 10b illustrated in FIG. 21, transmission switching controller 110 and transmission switch 111 are added to the configuration of radar apparatus 10a illustrated in FIG. 19.

The operation of radar apparatus 10b illustrated in FIG. 21 that differs from the configuration of radar apparatus 10a illustrated in FIG. 19 will be mainly described below.

Operations of the components of radar transmission signal generator 101, phase rotation amount setter 105, and phase rotator 108 in radar transmitter 100b of radar apparatus 10b illustrated in FIG. 21 are the same as those of Embodiment 1 when number N_{DM} of Doppler multiplexing is 1, phase rotation amount φ₁=0, N_{DOP_CODE}(1)=N_{CM} for applying first Doppler shift amount DOP₁ is 2, and number Nt transmission antenna is 2, and thus the operations thereof will not be described.

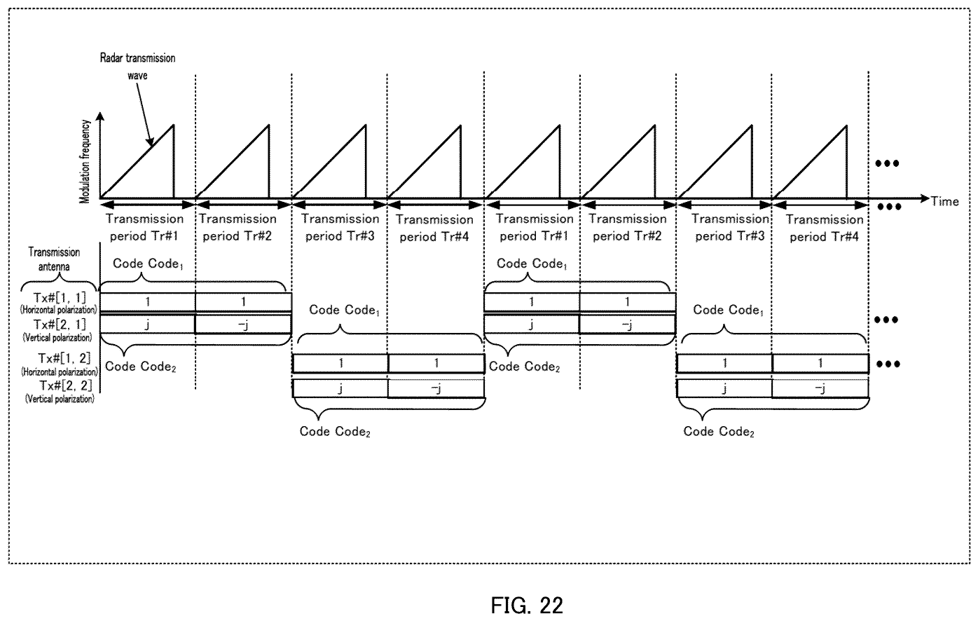

Transmission switching controller 110 performs a control of switching two transmission antennas 109 to which transmission switch 111 performs output at every predetermined number of transmission periods. For example, as illustrated in FIG. 22, transmission switching controller 110 performs a control of switching two transmission antennas 109 to which transmission switch 111 performs output every two transmission periods, which are the transmission periods of a code length Loc of 2 assigned by encoder 107. FIG. 22 illustrates an example in which the codes, Code₁=[1 1] and Code₂=[j−j] are assigned by encoder 107.

Here, two transmission antennas 109 serving as units for switching are a pair of transmission antennas 109 adjacently arranged and differently linearly polarized (for example, horizontal polarization and vertical polarization). Transmission switching controller 110 performs an operation of switching the pair of them every two transmission periods.

Hereinafter, the number of pairs of transmission antennas 109 that adjacently arranged and that are to be linearly polarized are referred to as “N_{sw}.” In addition, in Nt transmission antennas 109, a pair of transmission antennas 109 which performs transmission first is referred to as a “first transmission pair,” and a pair of transmission antennas 109 to be switched in subsequent two transmission periods is referred to as a “second transmission pair.” Hereinafter, when Nt/2 transmission pairs are included with respect to Nt transmission antennas 109, the transmission pairs are represented by index “nsw” of the transmission pairs representing the transmission pairs. Here, nsw=1 to Nt/2. Further, transmission switching controller 110 outputs index nsw of the transmission pair to output switch 209 at each transmission period.

Further, in FIGS. 21 and 22, transmission antenna 109 of the nswth transmission pair which emits the output of phase rotator PROT #[1, 1] into the space is referred to as “transmission antenna Tx #[1, nsw]. Further, transmission antenna 109 which emits the output of phase rotator PROT #[ndop_code(1), 1]=PROT #[2, 1] into space is referred to as “transmission antenna Tx #[ndop_code(ndm), nsw]=Tx #[2, nsw].” In FIGS. 21 and 22, Nt is 4, and Tx #[1, 1], Tx #[ndop_code(1), 1] (=Tx #[2, 1]), Tx #[1, 2], and Tx #[ndop_code(1), 2] (=Tx #[2, 2]) are assigned for four transmission antennas 109. In addition, ndop_code(1)=2.

Transmission switch 111 performs an operation of switching these pairs every two transmission periods by using, as pairs, adjacently arranged and differently linearly polarized transmission antennas under the control of transmission switching controller 110 described above. For example, as illustrated in FIG. 22, radar apparatus 10b performs time-division multiplexing transmission of a radar transmission signal from each of a plurality of pairs of transmission antennas 109.

Next, an exemplary operation of radar receiver 200b of radar apparatus 10b illustrated in FIG. 21 will be described.

Since the operations of the components from reception antenna 202 to antenna system processor 201 are the same as those of Embodiment 1, the description of the operations is omitted.

Output switch 209 performs selective switching to output the output of beat frequency analyzer 208 for each transmission period to (nsw−1)×Loc+OC_INDEXth Doppler analyzer 210 among LocXN_{sw} Doppler analyzers 210 (in FIG. 21, Loc=2) based on orthogonal code element index OC_INDEX input from encoder 107 of phase rotation amount setter 105 and index nsw of the transmission pair to which transmission switching controller 110 performs input. For example, output switch 209 selects Doppler analyzer 210 given by following Expression 73 for mth transmission period Tr. Here, Loc=2.

$$[ 76 ]$$

$$mod ( m - 1 , Loc \times Nsw ) + 1 \qquad ( Expression 73 )$$

Signal processor 206 includes Loc×N_{sw} Doppler analyzers 210-1 to 210-Loc×N_{sw}. For example, data is inputted by output switch 209 to ncswth Doppler analyzer 210 in each of Loc×N_{sw} transmission periods (Loc×N_{sw}×Tr). Here, ncsw=1, . . . , Loc×N_{sw}. Accordingly, ncswth Doppler analyzer 210 performs Doppler analysis for each distance index f_{b} using data ofNcsub (=Nc/(Loc×N_{sw})) transmission periods among N_{c} transmission periods (for example, using beat frequency response RFT_{z}(f_{b}, m) inputted from beat frequency analyzer 208). Note that N_{c} is set to an integer multiple of (Loc×N_{sw}).

For example, when Ncsub is a power of 2, FFT processing is applicable in the Doppler analysis. In this case, the FFT size is Ncsub, and a maximum Doppler frequency that is derived from the sampling theorem and in which no aliasing occurs is ±1/(2Loc×N_{sw}×Tr). Further, the Doppler frequency interval for Doppler frequency index fₛ is 1/(Loc×N_{sw}×Ncsub×Tr), and the range of Doppler frequency index fₛ is fₛ=−Ncsub/2, . . . , 0, . . . , Ncsub/2−1. Ncsw=1 to (Loc×N_{sw}).

For example, outputs VFT_{z}^{ncsw} (f_{b}, fₛ) of Doppler analyzers 210 of zth signal processor 206 are given by an expression in which Ncode is replaced with Ncsub, Loc is replaced with (Loc×N_{sw}), and noc is replaced with ncsw in Expression 39. The other operations are the same as those in Embodiment 1.

In FIG. 21, CFAR section 211 performs CFAR processing (for example, adaptive threshold judgement) using the outputs of (Loc×N_{sw}) Doppler analyzers 210 in each of the first to Nath signal processors 206 and extracts distance indices f_{b_cfar} and Doppler frequency indices f_{s_cfar} that provide peak signals.

For example, CFAR section 211 performs two-dimensional CFAR processing with the distance axis and the Doppler frequency axis (corresponding to the relative velocity) or CFAR processing that is a combination of one-dimensional CFAR processing using PowerFT(f_{b}, fₛ) obtained by power addition of outputs VFT_{z}¹(f_{b}, fₛ) to VFT_{z}^{Nsw×Loc}(f_{b}, fₛ) of first to N_{sw}×Locth Doppler analyzers 210 in first to Nath signal processors 206 as illustrated in following Expression 74.

CFAR section 211 adaptively configures a threshold value, and outputs distance index f_{b_cfar}, Doppler frequency index f_{s_cfar}, and received power data PowerFT (f_{b_car}, f_{s_cfar}) having a received power greater than the threshold value to coded demultiplexer 215. Note that CFAR section 211 performs an operation when the Doppler domain compression CFAR processing is not used because Doppler multiplexing is not performed (number N_{DM} of Doppler multiplexing=1).

$$[ 77 ]$$

$$PowerFT ( {f}_{b} , {f}_{s} ) = {\sum }_{ncsw = 1}^{{L}_{oc} \times {N}_{sw}} {\sum }_{z = 1}^{{N}_{a}} {\vert {VFT}_{z}^{ncsw} ( {f}_{b} , {f}_{s} ) \vert}^{2} \qquad ( Expression 74 )$$

Code demultiplexer 215 separates a code-multiplexed and transmitted signal using distance index f_{b_cfar} and Doppler frequency index f_{s_cfar} that are the output of CFAR section 211 (the output when the Doppler domain compression CFAR processing is not used), and, the output of Doppler analyzer 210. Code demultiplexer 215 outputs the separated reception signal of the code-multiplexed signal to direction estimator 214.

For example, code demultiplexer 215 performs demultiplexing reception of the code multiplexed signal by multiplying the code multiplexed signal by the complex conjugate of the code used for multiplexing transmission as given by following Expression 75. Demultiplexed reception signal Y_{z}(f_{b_cfar}, f_{s_cfar}, ncm, nsw) of the code-multiplexed signal is outputted to direction estimator 214.

$$[ 78 ]$$

$${Y}_{z} ( {f}_{{b}_{-} cfar} , {f}_{{s}_{-} cfar} , ncm , nsw ) = {Code}_{ncm}^{*} \{ α ( {f}_{{s}_{-} cfar} , n s w ) ⊗ {VFTALL}_{z} ( {f}_{{b}_{-} cfar} , {f}_{{s}_{-} cfar} , n s w ) \} \qquad ( Expression 75 )$$

Here, Y_{z}(f_{b_cfar}, f_{s_cfar}, ncm, nsw) are outputs obtained by demultiplexing the code-multiplexed signal from VFTALL_{z}(f_{b_cfar}, f_{s_cfar}, nsw) which are the outputs of Doppler analyzers 210 in zth antenna system processor 201 for distance index f_{b_cfar} and Doppler frequency index f_{s_cfar} using orthogonal code Code_{ncm} at the time of transmission when the transmission is performed by the nswth pair of transmission antennas 109. Note that z=1 to Na, ncm=1 to N_{CM}, and nsw=1 to N_{SW}.

Here, Doppler phase correction vector α(f_{s_cfar}) is expressed by following Expression 76. Doppler phase correction vector α(f_{s_cfar}) given by Expression 76 is a vector having, as elements, a Doppler phase correction factor for correcting a phase rotation of a Doppler component at Doppler frequency index f_{s_cfar} caused by a time lag of (ncsw−1)×Tr/(Loc×N_{SW}) in output VFT_{z}^{ncsw} (f_{b_cfar}, f_{s_cfar}) of ncswth Doppler analyzer 210 with reference to the Doppler analysis time for output VFT_{z}¹(f_{b_cfar}, f_{s_cfar}) of first Doppler analyzer 210, for example.

$$[ 79 ]$$

$$α ( {f}_{{s}_{-} cfar} , nsw ) = {[ exp ( - \frac{j 2 π ( {f}_{{s}_{-} cfar} )}{{N}_{csub}} \times \frac{2 ( nsw - 1 )}{{L}_{oc} \times {N}_{sw}} ) , exp ( - \frac{j 2 π ( {f}_{{s}_{-} cfar} )}{{N}_{csub}} \times \frac{2 ( nsw - 1 ) + 1}{{L}_{oc} \times {N}_{sw}} ) ]}^{T} \qquad ( Expression 76 )$$

In addition, VFTALL_{z}(f_{b_car}, f_{s_cfar}, nsw) given by Expression 75 is, for example, components extracted based on distance index f_{b_cfar} and Doppler frequency index f_{s_cfar} extracted by CFAR section 211, from among outputs VFT_{z}^{new} (f_{b}, fₛ) from two Doppler analyzers 210 in zth antenna system processor 201 are values expressed in a vector format as given by following Expression 77. Note that, noc=1, 2.

$$[ 80 ]$$

$${VFTALL}_{z} ( {f}_{{b}_{-} cfar} , {f}_{{s}_{-} cfar} , nsw ) = {[ {VFT}_{z}^{2 ( nsw - 1 ) + 1} ( {f}_{{b}_{-} cfar} , {f}_{{s}_{-} cfar} ) {VFT}_{z}^{2 ( nsw - 1 ) + 2} ( {f}_{{b}_{-} cfar} , {f}_{{s}_{-} cfar} ) ]}^{T} \qquad ( Expression 77 )$$

In FIG. 21, direction estimator 214 performs target direction estimation processing (hereinafter, referred to as direction estimation processing with respect to linear polarization) based on separated reception signal Y_{z}(f_{b_cfar}, f_{s_cfar}, ncm, nsw) of the code multiplexed signal for distance index f_{b_cfar} and Doppler frequency index f_{s_cfar} inputted from code demultiplexer 215.

Further, direction estimator 214 performs a target direction estimation processing (hereinafter, referred to as direction estimation processing with respect to forward circular polarization) using outputs from among the outputs of first to 2N_{sw}th Doppler analyzers 210 (in FIG. 21, Doppler analyzers 210-1 to 2N_{sw}) which are reception signals of forward-circularly-polarized transmissions.

Further, direction estimator 214 performs a target direction estimation processing (hereinafter, referred to as direction estimation processing with respect to reverse circular polarization) using outputs from among the outputs of first to 2N_{sw}th Doppler analyzers 210 (in FIG. 21, Doppler analyzers 210-1 to 2N_{sw}) which are reception signals of reverse-circularly-polarized transmissions.

The direction estimation processing in direction estimator 214 may include the direction estimation processing with respect to linear polarization, direction estimation processing with respect to forward circular polarization, and direction estimation processing with respect to reverse circular polarization. Hereinafter, the operation of each direction estimation processing will be described.

<Direction Estimation Processing with Respect to Linear Polarization>

For example, direction estimator 214 generates virtual reception array correlation vector h(f_{b_cfar}, f_{s_cfar}) as illustrated in following Expression 78 based on the outputs of code demultiplexer 215 to perform the direction estimation processing.

Virtual reception array correlation vector h(f_{b_cfar}, f_{s_cfar}) includes Nt×Na elements that are the product of number Nt of transmission antennas and number Na of reception antennas.

$$[ 81 ]$$

$$h ( {f}_{b \_ cfar} , {f}_{s \_ cfar} ) = [ \begin{matrix}{hsw}_{1} ( {f}_{b \_ cfar} , {f}_{s \_ cfar} ) \\ {hsw}_{2} ( {f}_{b \_ cfar} , {f}_{s \_ cfar} ) \\ ⋮ \\ {hsw}_{{N}_{sw}} ( {f}_{b \_ cfar} , {f}_{s \_ cfar} )\end{matrix} ] \qquad ( Expression 78 )$$

Here, hsw_{nsw}(f_{b_cfar}, f_{s_cfar}) is a reception vector of a reception signal that is code-separated when transmitted by transmission antennas 109 that form the nswth transmission pair, and includes 2Na elements that are products of the number (=2) of transmission antennas and number Na of reception antennas, as given by following Expression 79:

$$[ 82 ]$$

$$h {sw}_{nsw} ( {f}_{b \_ cfar} , {f}_{s \_ cfar} ) = [ \begin{matrix}{Y}_{1} ( {f}_{b \_ cfar} , {f}_{s \_ cfar} , 1 , nsw ) \\ {Y}_{2} ( {f}_{b \_ cfar} , {f}_{s \_ cfar} , 1 , nsw ) \\ ⋮ \\ {Y}_{Na} ( {f}_{b \_ cfar} , {f}_{s \_ cfar} , 1 , nsw ) \\ {Y}_{1} ( {f}_{b \_ cfar} , {f}_{s \_ cfar} , 2 , nsw ) \\ {Y}_{2} ( {f}_{b \_ cfar} , {f}_{s \_ cfar} , 2 , nsw ) \\ ⋮ \\ {Y}_{Na} ( {f}_{b \_ cfar} , {f}_{s \_ cfar} , 2 , nsw )\end{matrix} ] . \qquad ( Expression 79 )$$

Based on phase differences between reception antennas 202, direction estimator 214 performs the direction estimation processing on the reflected wave signals from a target using virtual reception array correlation vector h (f_{b_cfar}, f_{s_cfar}).

Here, virtual reception array correlation vector h(f_{b_cfar}, f_{s_cfar}) includes reflected wave reception signals of signals transmitted from differently linearly polarized antennas (e.g., vertically polarized antennas and horizontally polarized antennas). Therefore, direction estimator 214 may extract, from virtual reception array correlation vector h(f_{b_cfar}, f_{s_cfar}), an element that is a combination of the polarization of predetermined transmission antenna 109 and the polarization of reception antenna 202, and perform the direction estimation processing using the virtual reception array correlation vector including the extracted element. It is thus possible to obtain a direction estimation result per polarization of predetermined transmission antenna 109 and polarization of reception antenna 202.

<Direction Estimation Processing with Respect to Forward Circular Polarization>

Direction estimator 214 generates forward-circularly-polarized virtual reception array correlation vector h_{c1}(f_{b_cfar}, f_{s_cfar}) by using an output of the outputs of first to 2N_{sw}th Doppler analyzers 210 which is an output being a reception signal for a forward-circularly-polarized transmission, and performs direction estimation processing on the target with respect to the forward circular polarization.

Here, forward-circularly-polarized virtual reception array correlation vector h_{c1}(f_{b_cfar}, f_{s_cfar}) includes N_{sw}×Na elements. Based on phase differences between reception antennas 202, direction estimator 214 performs the direction estimation processing on the reflected wave signals from a target using forward-circularly-polarized virtual reception array correlation vector h_{c1}(f_{b_cfar}, f_{s_cfar}).

For example, when Tx #[1, 1] is a horizontally polarized antenna, Tx #[2, 1] is a vertically polarized antenna, Tx #[1, 2] is a horizontally polarized antenna, and Tx #[2,2] is a vertically polarized antenna as illustrated in FIG. 22, and Code₁=[1, 1] and Code₂=[j−j] are used in code multiplexing, forward-circularly-polarized virtual reception array correlation vector h_{c1}(f_{b_cfar}, f_{s_cfar}) can be expressed by following Expression 80:

$$[ 83 ]$$

$${h}_{c 1} ( {f}_{b \_ cfar} , {f}_{s \_ cfar} ) = [ \begin{matrix}{VFT}_{1}^{1} ( {f}_{b \_ cfar} , {f}_{s \_ cfar} ) \\ {VFT}_{2}^{1} ( {f}_{b \_ cfar} , {f}_{s \_ cfar} ) \\ ⋮ \\ {VFT}_{Na}^{1} ( {f}_{b \_ cfar} , {f}_{s \_ cfar} ) \\ {VFT}_{1}^{3} ( {f}_{b \_ cfar} , {f}_{s \_ cfar} ) \\ {VFT}_{2}^{3} ( {f}_{b \_ cfar} , {f}_{s \_ cfar} ) \\ ⋮ \\ {VFT}_{Na}^{3} ( {f}_{b \_ cfar} , {f}_{s \_ cfar} )\end{matrix} ] . \qquad ( Expression 80 )$$

<Direction Estimation Processing with Respect to Reverse Circular Polarization>

Direction estimator 214 generates reverse-circularly-polarized virtual reception array correlation vector h_{c2}(f_{b_cfar}, f_{s_cfar}) by using an output of the outputs of first to 2N_{sw}th Doppler analyzers 210 which is a reception signal for reverse-circularly-polarized transmission, and performs the direction estimation processing on the target with respect to the reverse circular polarization.

Here, reverse-circularly-polarized virtual reception array correlation vector h_{c2}(f_{b_cfar}, f_{s_cfar}) includes N_{sw} Na elements. Direction estimator 214 performs direction estimation processing based on the phase differences between the respective reception antennas 202 on the reflected wave signals from the targets using reverse-circularly-polarized virtual reception array correlation vector h_{c2}(f_{b_cfar}, f_{s_cfar}).

For example, when Tx #[1, 1] is a horizontally polarized antenna, Tx #[2, 1] is a vertically polarized antenna, Tx #[1, 2] is a horizontally polarized antenna, and Tx #[2,2] is a vertically polarized antenna as illustrated in FIG. 22, and Code₁=[1, 1] and Code₂=[j−j] are used in code multiplexing, reverse-circularly-polarized virtual reception array correlation vector h_{c2}(f_{b_cfar}, f_{s_cfar}) can be expressed by following Expression 81:

$$[ 84 ]$$

$${h}_{c 2} ( {f}_{b \_ cfar} , {f}_{s \_ cfar} ) = [ \begin{matrix}{VFT}_{1}^{2} ( {f}_{b \_ cfar} , {f}_{s \_ cfar} ) \\ {VFT}_{2}^{2} ( {f}_{b \_ cfar} , {f}_{s \_ cfar} ) \\ ⋮ \\ {VFT}_{{N}_{a}}^{2} ( {f}_{b \_ cfar} , {f}_{s \_ cfar} ) \\ {VFT}_{1}^{4} ( {f}_{b \_ cfar} , {f}_{s \_ cfar} ) \\ {VFT}_{2}^{4} ( {f}_{b \_ cfar} , {f}_{s \_ cfar} ) \\ ⋮ \\ {VFT}_{{N}_{a}}^{4} ( {f}_{b \_ cfar} , {f}_{s \_ cfar} )\end{matrix} ] . \qquad ( Expression 81 )$$

The direction estimation processing with respect to linear polarization using virtual reception array correlation vector h(f_{b_cfar}, f_{s_cfar}) in direction estimator 214, the direction estimation processing with respect to forward circular polarization using forward-circularly-polarized virtual reception array correlation vector h_{c1}(f_{b_cfar}, f_{s_cfar}), and the direction estimation processing with respect to reverse circular polarization using reverse-circularly-polarized virtual reception array correlation vector h_{c2}(f_{b_cfar}, f_{s_cfar}) are the same as those in Embodiment 1, and therefore, the operation thereof will not be described.

Direction estimator 214 may perform direction estimation processing using a reception signal including a combination of different types of polarization. In this case, a direction estimation result less dependent on the polarization is obtained. Further, by performing the direction estimation processing using more virtual antennas, the reception SNR can be improved, and the detecting performance of radar apparatus 10b can be improved. Further, since the direction estimation processing using the maximum aperture length of the available virtual reception antennas is performed, the angular resolution is also improved. For example, when the direction estimation processing is performed using all virtual reception antennas, up to (Nt×Na+2×N_{BF}×Na) virtual reception antennas can be utilized, and more than Nt×Na virtual reception antennas can be utilized.

Further, direction estimator 214 may perform the direction estimation processing using the polarized antennas of the same type for the transmission and reception as described above, and the direction estimation processing combining the polarizations of the different types, and may use both of the direction estimation results as the direction estimation processing result. As a result, a direction estimation processing result highly dependent on the polarization and a direction estimation processing result less dependent on the polarization are obtained. The result of such direction estimation processing may be input to a target object identification processor not illustrated in the figures, and target object identification processing may be performed.

As described above, in Variation 2 of Embodiment 1, the pairs of adjacent differently linearly polarized antennas (for example, horizontally (H) and vertically (V) polarized antennas) have different phases by 90° and perform code multiplexing using orthogonal codes (for example, orthogonal codes [0°, 90° ] and [0°, −90° ]) having the orthogonal relation. When there are a plurality of such paired transmission antennas 109, radar apparatus 10b performs time-division multiplexing transmission by switching the transmission time for each pair.

Such an operation makes it possible to obtain reception signals of reflected waves not only by transmission from differently linearly polarized antennas but also by transmission by two types of circular polarization (for example, right-handed and left-handed circular polarizations having rotation directions opposite to each other), so as to improve the target detection performance or the target identification performance.

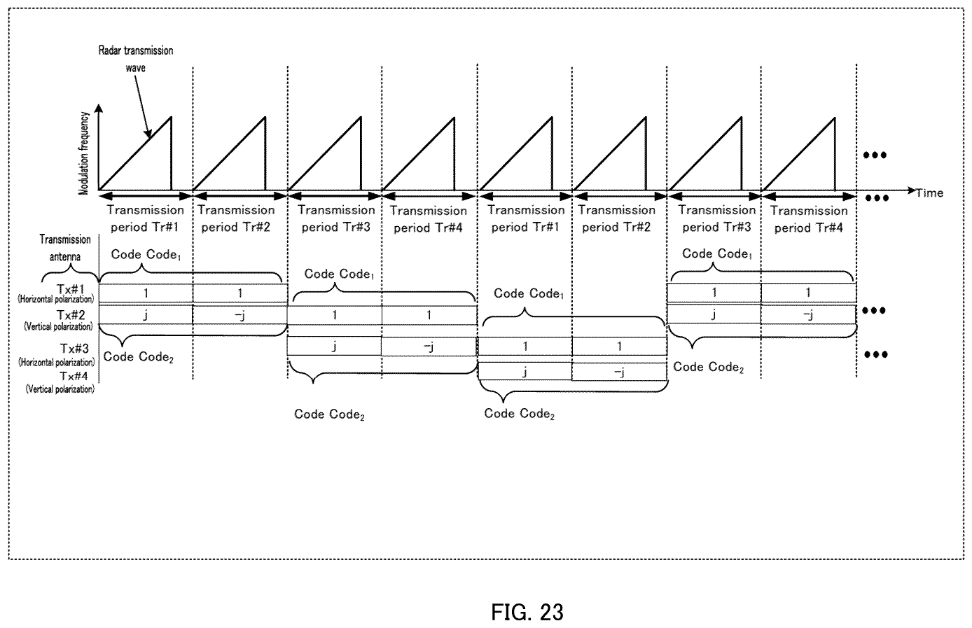

Note that some of transmission antennas 109 may overlap with each other between the transmission pairs. For example, as illustrated in FIG. 23, transmission switching controller 110 performs a control of switching the two transmission antennas to which transmission switch 111 performs output every two transmission periods, which are the transmission periods of a code length Loc of 2 assigned by encoder 107. In addition, in the example illustrated, encoder 107 assigns the codes, Code₁1=[1 1] and Code₂=[j−j].

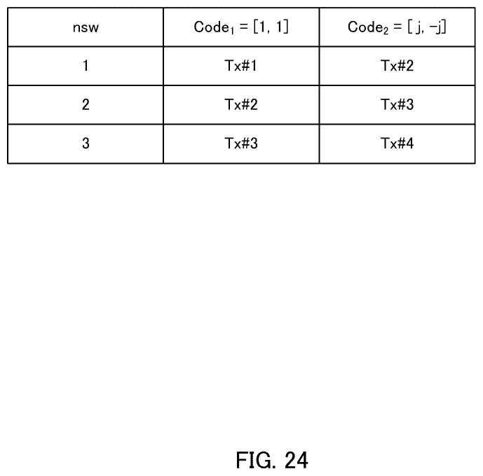

Here, transmission switching controller 110 may hold information related to the transmission switching control illustrated in FIG. 24 (for example, “transmission switching control table”). Transmission switching controller 110 may perform the assignment of codes to transmission antennas #1 to #4 and the switching control based on the transmission switching control table. For example, for index nsw=1 of the transmission pair, transmission switching controller 110 uses transmission antennas Tx #1 and Tx #2, and assigns the antennas with codes Code₁=[1 1] and Code₂=[j−j], respectively. For index nsw=2 of the transmission pair, transmission switching controller 110 uses transmission antennas Tx #2 and Tx #3, and assigns the antennas with codes Code₁=[1 1] and Code₂=[j−j], respectively. In addition, for index nsw=3 of the transmission pair, transmission switching controller 110 uses transmission antennas Tx #3 and Tx #4, and assigns the antennas with codes Code₁=[1 1] and Code₂=[j−j], respectively. In this example, a part (Tx #2) of the antennas overlaps between the transmission pairs for indexes nsw of the transmission pairs=1 and 2. Also, a part (Tx #3) of the antennas overlaps between the transmission pairs for indexes nsw of the transmission pairs=3 and 4.

Based on the control of transmission switching controller 110, encoder 107, phase rotator 108, and transmission switch 111 may be similarly controlled.

Also, radar receiver 200b performs the same operation as that described with reference to FIG. 21.

When a part of the antennas overlaps between the transmission pairs as described above, direction estimator 214 can increase the number of elements of forward-circularly-polarized virtual reception array correlation vector h_{c1}(f_{b_cfar}, f_{s_cfar}) and reverse-circularly-polarized virtual reception array correlation vector h_{c2}(f_{b_cfa}r, f_{s_cfar}), so as to improve the reception SNR of the direction estimation processing with respect to the forward circular polarization and the direction estimation processing with respect to the reverse circular polarization. Further, for example, by devising antenna arrangement, grating lobes or sidelobes at the time of direction estimation can be reduced. Further, by devising the antenna arrangement, the aperture length can be increased, and the angular resolution can be improved.

### Embodiment 2

Embodiment 1 has been described with respect to an operation using MIMO multiplexing transmission in which Doppler multiplexing and code multiplexing are combined. In Embodiment 1, code multiplexing transmission is performed using a common Doppler multiplexed signal (for example, the same Doppler shift amount) for a pair providing antenna arrangement in which differently linearly polarized antennas are adjacent to each other (for example, a pair of a horizontally polarized antenna and a vertically polarized antenna). In addition, orthogonal codes (for example, orthogonal codes [1 1] and [j−j]) whose phases differ by 90° between code elements and having an orthogonal relation are used as the codes used for code multiplexing. In addition, when there are a plurality of pairs providing antenna arrangement in which differently linearly polarized antennas are adjacent to each other, code multiplexing transmission is performed using different Doppler multiplexed signals (for example, different Doppler shift amounts) for these pairs.

Such operations make it possible to obtain reception signals of reflected waves not only by transmission from differently linearly polarized antennas but also by transmission by two types of circular polarization (for example, right-handed and left-handed circular polarizations having rotation directions opposite to each other), and it is thus possible to perform transmission by more types of polarization than the types of polarization of transmission antennas 109, and to perform transmission by an increased number of types of polarizations with a reduced number of transmission antennas. Further, by combining the polarization of transmission antennas 109 and the polarization of reception antennas 202, more combinations of transmission and reception polarizations can be obtained. Further, by performing the direction estimation processing in direction estimator 214 for each combination of polarizations of transmission and reception antennas, it is possible to improve the target detection performance or the target identification performance when, for example, a reflected wave of a characteristic polarization is obtained for each target. In addition, by using MIMO multiplexing transmission in which Doppler multiplexing and code multiplexing are combined, it is possible to achieve a reduction in transmission time as compared with transmission performed while sequentially switching antennas in a time division manner.

The present disclosure is not limited to the operation using MIMO multiplexing transmission as described in Embodiment 1, and the same advantages can be obtained in the operation using another MIMO multiplexing transmission.

For example, the present embodiment will be described with respect to an operation in which, in MIMO multiplexing transmission with Doppler multiplexing transmission, transmission is performed with switching over time between transmission processing with Doppler multiplexing using a plurality of linearly polarized antennas (for example, processing for multiplexing transmission using different Doppler shift amounts) and transmission processing with Doppler multiplexing on a beam transmission using adjacently arranged and differently linearly polarized antennas.

Such an operation also makes it possible to obtain reception signals of reflected waves not only by transmission from differently linearly polarized antennas but also by transmission by at least one type of circular polarization (for example, one of the right-handed and left-handed circular polarizations having rotation directions opposite to each other). For example, it is possible to perform transmission by more types of polarization than the types of polarization of transmission antennas, and it thus becomes possible to perform transmission by an increased number of types of polarizations with a reduced number of transmission antennas. Therefore, the same effects as those described in Embodiment 1 can be obtained.

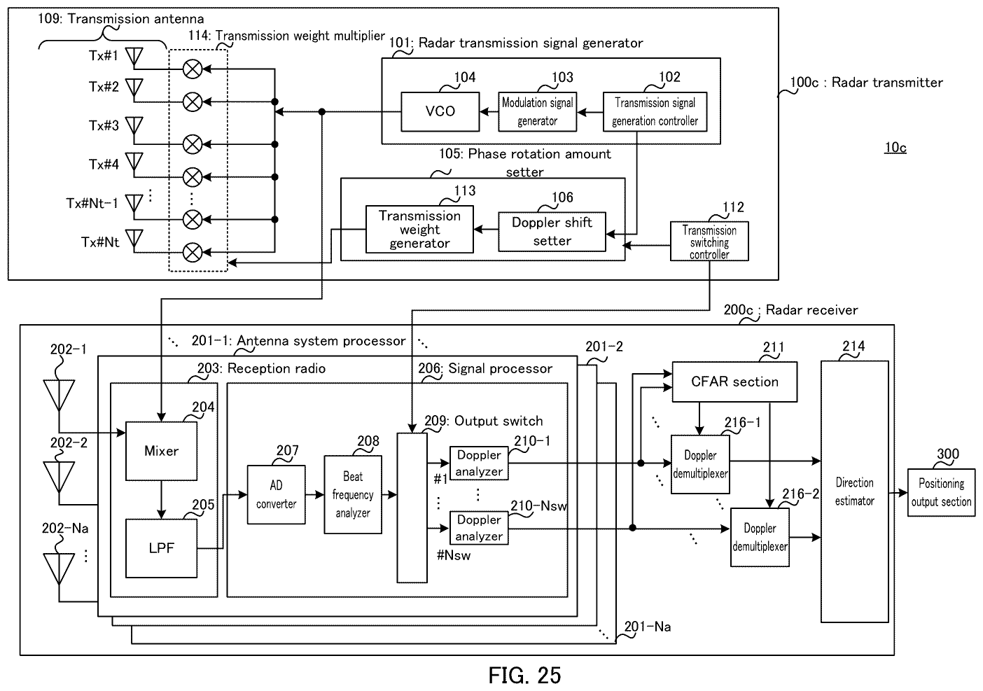

FIG. 25 illustrates an exemplary configuration of radar apparatus 10c according to the present embodiment.

In FIG. 25, transmission switching controller 112 is included in addition to the configuration (FIG. 1) of Embodiment 1, which performs a control such that switching takes place over time between transmission in which Doppler multiplexing is performed using a plurality of linearly polarized antennas and transmission in which Doppler multiplexing is performed on beam transmission using adjacently arranged and differently linearly polarized antennas. In addition, in FIG. 25, transmission weight generator 113 and transmission weight multiplier 114 are included instead of encoder 107, which perform a weight factor multiplication for circularly polarizing the adjacently arranged and differently linearly polarized antennas or perform configuration and multiplication by a zero amplitude weight (an operation equivalent to a transmission-OFF control) such that a antenna not performing transmission is set to transmission OFF.

Hereinafter, operations different from those of Embodiment 1 will mainly be described.

[Configuration of Radar Transmitter 100c]

Since the operation of radar transmission signal generator 101 is the same as that of Embodiment 1, the description thereof will be omitted.

Transmission switching controller 112 holds information on the Doppler shift amounts periodically assigned to transmission antennas Tx #1 to #Nt and beam transmission antennas Num_BF=1 to N_{BF} at variably configured Doppler shift period N_{sw} (hereinafter, the information is referred to as “Doppler multiplexing assignment table” as an example). Transmission switching controller 112 controls components of phase rotation amount setter 105, for example, based on the Doppler multiplexing assignment table. Further, transmission switching controller 112 outputs the information on the variably configured Doppler shift period (for example, transmission switching index nsw to be described later) to output switch 209.

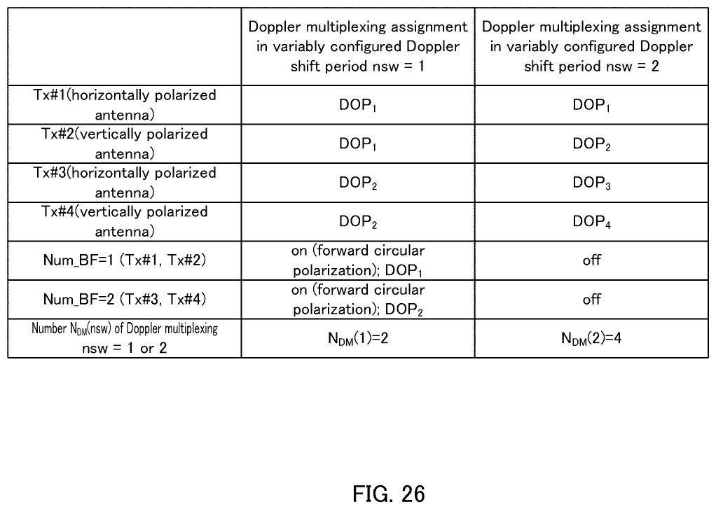

FIG. 26 illustrates an example of the Doppler multiplexing assignment table. The table illustrated in FIG. 26 is a Doppler multiplexing assignment table for the antenna arrangement illustrated in FIG. 25 of Tx #1 to #4 (number Nt of transmission antennas=4) and number N_{BF} of beam transmission antennas=2 and variably configured Doppler shift period N_{sw}=2.

In the example illustrated in FIG. 26, in the transmission period of nsw=1, assignment of the Doppler shift amounts (DOP₁ and DOP₂) for number N_{DM}(1) of Doppler multiplexing=2 s performed from two beam transmission antennas Tx #5 (forward-circularly-polarized beam transmission using Tx #1 and Tx #2) and Tx #6 (forward-circularly-polarized beam transmission using Tx #3 and Tx #4).

Further, in the example illustrated in FIG. 26, Doppler shifts for number N_{DM} of Doppler multiplexing(2)=4 are assigned from four transmission antennas Tx #1 to #4 in the transmission period of nsw=2.

Here, the transmission period of nsw=1 is a transmission period satisfying mod(m−1, N_{sw})+1=1. The transmission period of nsw=2 is a transmission period satisfying mod(m−1, N_{sw})+1=2. Here, m is an index indicating the number of transmissions in the transmission period, and m=1 to Nc. Hereinafter, nsw will be referred to as “transmission switching index.”

In the following description, the number of Doppler multiplexing in nsw transmission periods will be referred to as N_{DM}(nsw). Here, N_{DM}(1)=2 and N_{DM}(2)=4 are configured, but the present disclosure is not limited thereto, and any configuration that satisfies the following conditions may be used.

### <Configuration Conditions for Number of Doppler Multiplexing in Variably Configured Doppler Shift Period Nsw>

The sum of the number of Doppler multiplexing in variably configured Doppler shift period N_{sw} is set to be equal to or greater than the sum (Nt+N_{BF}) of number Nt of transmission antennas and number N_{BF} of beam transmissions as expressed by following Expression 82:

$$[ 85 ]$$

$${\sum }_{nsw = 1}^{Nsw} {N}_{DM} ( nsw ) \geq {N}_{t} + {N}_{BF} . \qquad ( Expression 82 )$$

In addition, the configuration may be such that transmission is performed at least once or more times from each of the transmission antennas of number Nt transmission antenna and number N_{BF} of beam transmissions. Further, transmission antennas 109 and the transmission antennas used for beam transmission may be configured so as not to overlap each other in each variably configured Doppler shift period.

It should be noted that number N_{DM}(nsw) of Doppler multiplexing in nsw transmission periods may be set so that Nt≥N_{DM}(nsw)≥1. Here, nsw=1 to Nsw.

For example, Nsw=3 may be configured, and the variably configured Doppler shift period having three transmission periods may be used. For example, the configuration may be such that the forward-circularly-polarized transmission is performed by the beam transmission antennas in the case of transmission switching index nsw=1, the reverse-circularly-polarized transmission is performed by the beam transmission antennas in that case of nsw=2, and transmission from transmission antennas 109 (horizontally polarized or vertically polarized) is performed in the case of transmission switching index nsw=3.

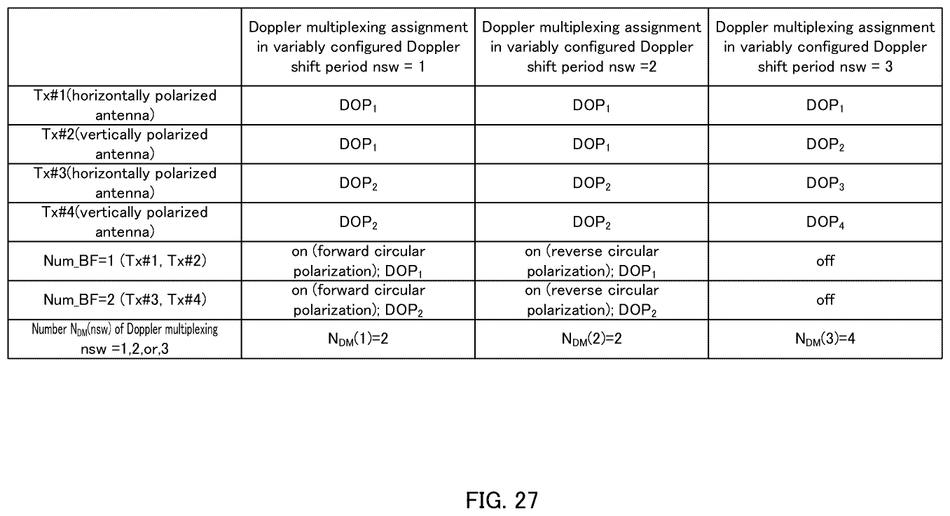

FIG. 27 illustrates an example of the Doppler multiplexing assignment table. The table illustrated in FIG. 27 is a Doppler multiplexing assignment table for the antenna arrangement illustrated in FIG. 25 with Tx #1 to #4 (number Nt of transmission antennas=4) and number N_{BF} of beam transmission antennas=2 and variably configured Doppler shift period N_{sw}=3. In the example illustrated in FIG. 27, in the transmission period of nsw=1, the Doppler shift amounts (DOP₁ and DOP₂) are assigned from two beam transmission antennas Tx #5 (forward-circularly-polarized beam transmission using Tx #1 and Tx #2) and Tx #6 (forward-circularly-polarized beam transmission using Tx #3 and Tx #4) with number N_{DM}(1) of Doppler multiplexing=2.

Further, in the example illustrated in FIG. 27, in the transmission period of nsw=2, the Doppler shift amounts (DOP₁ and DOP₂) are assigned from two beam transmission antennas Tx #5 (reverse-circularly-polarized beam transmission using Tx #1 and Tx #2) and Tx #6 (reverse-circularly-polarized beam transmission using Tx #3 and Tx #4) with number N_{DM}(1) of Doppler multiplexing=2. Further, in the example illustrated in FIG. 27, Doppler shifts are assigned from four transmission antennas Tx #1 to #4 with number N_{DM}(3) of Doppler multiplexing=4 in the transmission period of nsw=3.

Further, for example, the transmissions may be configured such that circularly polarized and linearly polarized transmissions are mixed in each variably configured Doppler shift period as in the case where the forward- or reverse-circularly-polarized transmission by the beam transmission antennas and transmission from (horizontally polarized or vertically polarized) transmission antennas different from the beam transmission antennas are performed. For example, at the time of transmission from at least one set of adjacent transmission antennas 109, radar transmitter 100c may perform, in the same transmission period, transmission processing for multiplexing transmission of a radar transmission signal by applying the same Doppler shift amount and transmission weights having phases differing by 90°, and transmission processing for multiplexing transmission of the radar transmission signal by applying different Doppler shift amounts.

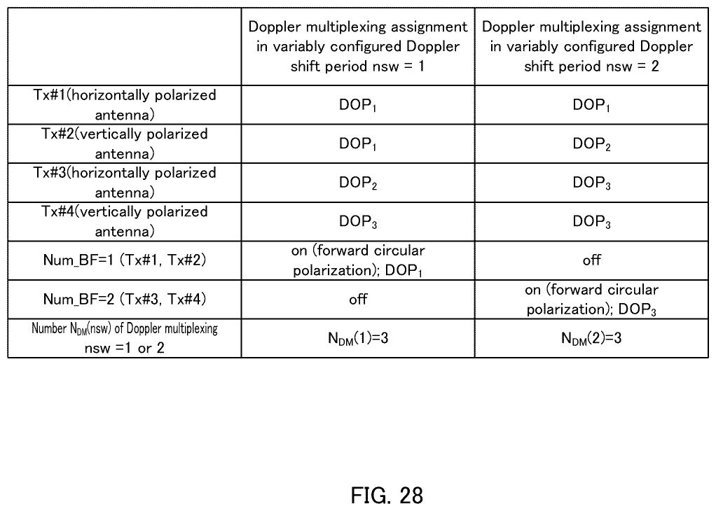

FIG. 28 illustrates an example of the Doppler multiplexing assignment table. The table illustrated in FIG. 28 is a Doppler multiplexing assignment table for the antenna arrangement illustrated in FIG. 25 with Tx #1 to #4 (number Nt of transmission antennas=4) and number N_{BF} of beam transmission antennas=2 and variably configured Doppler shift period N_{sw}=2. In the example illustrated in FIG. 28, in the transmission period of nsw=1, the Doppler shifts are assigned from one beam transmission antenna Tx #5 (forward-circularly-polarized beam transmission from Tx #1 and Tx #2 using Doppler shift amount DOP₁) and two transmission antennas Tx #3 and Tx #4 (transmissions using Doppler shift amounts DOP₂ and DOP₃, respectively) with number N_{DM}(2) of Doppler multiplexing=3.

Further, in the example illustrated in FIG. 28, in the transmission period of nsw=2, the Doppler shifts are assigned from the other beam transmission antenna Tx #6 (forward-circularly-polarized beam transmission from Tx #3 and Tx #4 using Doppler shift amount DOP₃) and two transmission antennas Tx #1 and Tx #2 (transmissions using Doppler shift amounts DOP₁ and DOP₂, respectively) with number N_{DM}(2) of Doppler multiplexing=3.

Transmission switching controller 112 performs the following control for Doppler shift setter 106, for example, based on the above-described Doppler multiplexing assignment table.

Doppler shift setter 106 configures phase rotation amount DOP_{ndm}(nsw) for applying the Doppler shift amount φ_{ndm}(nsw) using number N_{DM}(nsw) of Doppler multiplexing in nsw transmission periods based on the control of transmission switching controller 112, and outputs the phase rotation amount to transmission weight generator 113. Note that an antenna that does not perform transmission in nsw transmission periods (an antenna for which transmission is to be OFF) may be included. Here, ndm=1 to N_{DM}(nsw) and nsw=1 to N_{sw}.

The configuration of phase rotation amount φ_{ndm} for applying Doppler shift amount DOP_{ndm}(nsw) using number N_{DM}(nsw) of Doppler multiplexing in phase rotation amount setter 105 is the same operation as that of Embodiment 1, and Doppler shift amounts at equal intervals may be configured, or the Doppler shift amounts at unequal intervals may be configured.

For example, following Expression 83 may be used as the Doppler shift amounts at equal intervals:

$$[ 86 ]$$

$${ϕ}_{ndm} ( nsw ) = \frac{2 π ( ndm - 1 )}{{N}_{DM} ( nsw )} . \qquad ( Expression 83 )$$

Further, for example, following Expression 84 may be used as the Doppler shift amounts at unequal intervals:

$$[ 87 ]$$

$${ϕ}_{ndm} ( nsw ) = \frac{2 π ( ndm - 1 )}{{N}_{DM} ( nsw ) + {N}_{int} ( nsw )} . \qquad ( Expression 84 )$$

Here, Nᵢₙₜ(nsw) is an integer value equal to or greater than 0.

Transmission weight generator 113 configures transmission weight Wₙₜₓ(nsw) composed of an amplitude and a phase for transmission antennas Tx #1 to #Nt (number Nt of transmission antennas) under the control of transmission switching controller 112 as follows. Here, ntx=1 to Nt.
(1) When a beam transmission antenna is ON, transmission weight generator 113 configures a weight factor for circular polarization using differently linearly polarized antennas for transmission antennas 109 constituting the beam transmission antenna for which transmission is to be ON.

The transmission weight factor for circular polarization using differently linearly polarized antennas is, for example, a transmission weight that gives Amp×exp[j(η+π/2)] or Amp×exp[j(η−π/2)] for one transmission antenna 109 when a transmission weight of Amp×exp[jη] is configured for the other transmission antenna 109. For example, the phase difference between the transmission weights for circular polarization using differently linearly polarized antennas is +90° or −90°. By such multiplication by the transmission weights, right-handed or left-handed circularly polarized transmission signals are transmitted. Hereinafter, in a case where the direction of one circular polarization is a forward rotation, the direction of the other circular polarization may be referred to as a reverse rotation. Here, is any phase.
(2) A transmission antenna for which transmission is to be ON and that is not included in beam transmission antennas for which transmission is to be ON is given a non-zero predetermined amplitude value Amp.

A transmission antenna which is not included in category (1) or (2) and for which transmission is to be OFF is configured with a zero amplitude weight (operation equivalent to the transmission OFF control) for configuring transmission OFF.

For example, when transmission switching controller 112 performs control based on the Doppler multiplexing assignment table illustrated in FIG. 26, transmission weight generator 113 may configure the transmission weight as described below.

In the case of nsw=1,

$${W}_{1} ( 1 ) = Amp \times exp [ j η ] , {W}_{2} ( 1 ) = Amp \times exp [ j ( η + π / 2 ) ] , and$$

$${W}_{3} ( 1 ) = Amp \times exp [ j η ] , {W}_{4} ( 1 ) = Amp \times exp [ j ( η + π / 2 ) ] .$$

$$Or ,$$

$${W}_{1} ( 1 ) = Amp \times exp [ j η ] , {W}_{2} ( 1 ) = Amp \times exp [ j ( η - π / 2 ) ] , and$$

$${W}_{3} ( 1 ) = Amp \times exp [ j η ] , {W}_{4} ( 1 ) = Amp \times exp [ j ( η - π / 2 ) ] .$$

In the case of nsw=2, W₁(2)=W₂(2)=W₃(2)=W₄(2)=Amp.

Note that, when a beam transmission antenna is ON, transmission weight generator 113 may configure a transmission weight factor for circular polarization using differently linearly polarized antennas for transmission antennas 109 constituting the beam transmission antenna for which transmission is to be ON. For example, transmission weight generator 113 may configure a transmission weight that gives Amp×exp[j(η+ξ)] or Amp×exp[j(η−ξ)] for one transmission antenna 109 when a transmission weight of Amp×exp[jη] is configured for the other transmission antenna 109.

Here, ξ may be in the range of π/6 to 5π/6 radians (=30° to 150°). For example, in a case where the phase deviation between transmission antennas 109 is corrected in advance, a circularly polarized wave in which a main beam direction of a transmission beam is changed in dependence on “ξ” is generated in the course of beam transmission. For example, in a case where the transmission antenna spacing for beam transmission is λ/2 and ξ=90°, a circularly polarized wave in which the main beam direction is the front 0° direction is generated.

In addition, for example, in the case of ξ=30°, the circularly polarized wave is generated in which the main beam direction is shifted by about −15° from the front direction. In addition, for example, in the case of ξ=150°, the circularly polarized wave is generated in which the main beam direction is shifted by about +15° from the front direction. Here, λ is the wavelength of a high-frequency signal output from the transmission antenna (when the chirp signal is used, the wavelength of the chirp signal at the center frequency is used).

Transmission weight generator 113 includes the Doppler phase rotation amount in the configured transmission weight to configure transmission weight (hereinafter referred to as “Doppler multiplexing transmission weight”) WDₙₜₓ, and outputs it to transmission weight multiplier 114.

Following Expression 85 illustrates Doppler multiplexing transmission weight WDₙₜₓ for ntxth transmission antenna in mth transmission period Tr. Here, ntx=1 to Nt.

$$[ 88 ]$$

$${WD}_{ntx} ( m ) = {W}_{ntx} ( mod ( m - 1 , {N}_{sw} ) + 1 ) exp \{ jfloor [ \frac{m - 1}{{N}_{sw}} ] \times {ϕ}_{ndm} ( mod ( m - 1 , {N}_{sw} ) + 1 ) \} \qquad ( Expression 85 )$$

Note that, floor[x] is an operator that outputs the largest integer that does not exceed real number x. The character “j” is an imaginary unit.

Nt transmission weight multipliers 114 multiply chirp signals cp(t) inputted from radar transmission signal generator 101 by Doppler multiplexing transmission weights WDₙₜₓ(m) for Nt transmission antennas 109 per transmission periods Tr, respectively. Note that ntx=1 to Nt. Outputs from Nt transmission weight multipliers 114 are amplified to a defined transmission power and then radiated into space from Nt transmission antennas 109 of a transmission array antenna section.

For example, ntxth transmission weight multiplier 114 multiplies mth chirp signal cp(t) generated by radar transmission signal generator 101 by Doppler multiplexing transmission weight WDₙₜₓ(m) and outputs the result to ntxth transmission antenna 109. For example, ntxth transmission weight multiplier 114 multiplies N_{c} chirp signals cp(t) generated in radar transmission signal generator 101 for each transmission period by the Doppler multiplexing transmission weight WDₙₜₓ(nsw) as given by following Expression 86 and outputs the result to ntxth transmission antenna:

$$[ 89 ]$$

$${WD}_{ntx} ( 1 ) \times cp ( t ) , {WD}_{ntx} ( 2 ) \times cp ( t ) , … , {WD}_{ntx} ( {N}_{c} ) \times cp ( t ) . \qquad ( Expression 86 )$$

As described above, at the time of transmission from at least one set of adjacent transmission antennas 109 (for example, a pair of a horizontally polarized antenna and a vertically polarized antenna), radar transmitter 100c switches transmission processing over time between transmission processing for multiplexing transmission of a radar transmission signal by applying the same Doppler shift amount and transmission weights having phases differing by 90°, and transmission processing for multiplexing transmission of the radar transmission signal by applying different Doppler shift amounts. For example, by using transmission weights with phases different by 90°, radar apparatus 10c as the radar apparatus in Embodiment 1 can use more transmission antennas than number Nt of transmission antennas for multiplexing transmission and can use transmission antennas with a polarization (for example, circular polarization) different from the polarization (for example, horizontal polarization and vertical polarization) of transmission antennas 109.

[Configuration of Radar Receiver 200c]

Regarding the operations of radar receiver 200c in FIG. 25, the operations of from mixer 204 to beat frequency analyzer 208 are the same as those of Embodiment 1.

Output switch 209 performs selective switching to output the output of beat frequency analyzer 208 for each transmission period to nswth Doppler analyzer 210 among N_{sw} Doppler analyzers 210 based on transmission switching index nsw inputted from transmission switching controller 112. For example, output switch 209 selects mod(m−1, N_{sw})+1th Doppler analyzer 210 in mth transmission period Tr. Here, nsw=1 to N_{sw}.

Signal processor 206 includes N_{sw} Doppler analyzers 210-1 to 210-N_{sw} (also referred to as first to N_{sw}th Doppler analyzers 210). For example, data is inputted by output switch 209 to nswth Doppler analyzer 210 in each of N_{sw} transmission periods (N_{sw}×Tr). The nswth Doppler analyzer 210 performs Doppler analysis for each distance index f_{b} using data of Ncsub (=Nc/N_{sw}) transmission periods among N_{c} transmission periods (for example, using beat frequency response RFT_{z}(f_{b}, m) inputted from beat frequency analyzer 208). Note that N_{c} is set to an integer multiple of N_{sw}.

For example, when Ncode is a power of 2, FFT processing is applicable in the Doppler analysis. In this case, the FFT size is Ncsub, and a maximum Doppler frequency that is derived from the sampling theorem and in which no aliasing occurs is ±1/(2N_{sw}×Tr). Further, the Doppler frequency interval for Doppler frequency index fₛ is 1/(N_{sw}×Ncsub×Tr), and the range of Doppler frequency index fₛ is fₛ=−Ncsub/2, . . . , 0, . . . , Ncsub/2−1.

For example, outputs VFT_{z}^{nsw} (f_{b}, fₛ) of Doppler analyzers 210 of zth signal processor 206 is given by an expression in which Ncode is replaced with Ncsub, Loc is replaced with (Loc×N_{sw}), and noc is replaced with nsw in Expression 39. The other operations are the same as those in Embodiment 1.

In FIG. 25, CFAR section 211 performs CFAR processing (for example, adaptive threshold judgement) using the outputs of N_{sw} Doppler analyzers 210 in each of the first to Nath signal processors 206 and extracts distance indices f_{b_cfar} and Doppler frequency indices f_{s_cfar} that provide peak signals.

For example, CFAR section 211 performs two-dimensional CFAR processing with the distance axis and the Doppler frequency axis (corresponding to the relative velocity) or CFAR processing that is a combination of one-dimensional CFAR processing using PowerFT_{nsw}(f_{b}, fₛ) obtained by power addition per outputs VFT_{z}^{nsw} (f_{b}, fₛ) of nswth Doppler analyzers 210 in first to Nath signal processors 206 as illustrated in following Expression 87. CFAR section 211 adaptively configures a threshold and outputs to Doppler demultiplexer 216, distance index f_{b_cfar}(nsw), Doppler frequency index f_{s_cfar}(nsw), and received-power information PowerFT_{nsw}(f_{b_cfar}(nsw), f_{s_cfar}(nsw)) that provides received power greater than the threshold.

$$[ 90 ]$$

$${PowerFT}_{nsw} ( {f}_{b} , {f}_{s} ) = {\sum }_{z = 1}^{{N}_{a}} {\vert {VFT}_{z}^{nsw} ( {f}_{b} , {f}_{s} ) \vert}^{2} \qquad ( Expression 87 )$$

Alternatively, when the number of Doppler multiplexing for each nsw is the same (N_{DM}(1)= . . . =N_{DM}(N_{sw})) and the Doppler shift amount for each nsw is also the same, CFAR section 211 may output PowerFT(f_{b}, fₛ) obtained by power addition of all the outputs of Doppler analyzers 210 for each nsw as in following Expression 88, and perform common CFAR processing. CFAR section 211 adaptively configures a threshold value, and outputs a distance index f_{b_cfar}, a Doppler frequency index f_{s_cfar}, and a received power data PowerFT (f_{b_cfar}, f_{s_cfar}) having a received power greater than the threshold value to the Doppler demultiplexers.

$$[ 91 ]$$

$$PowerFT ( {f}_{b} , {f}_{s} ) = {\sum }_{nsw = 1}^{{N}_{sw}} {PowerFT}_{nsw} ( {f}_{b} , {f}_{s} ) \qquad ( Expression 88 )$$

Note that, for example, when Expression 83 is used as the phase rotation amount φ_{ndm} for imparting Doppler shift amount DOP_{ndm}, the Doppler shift amount in the Doppler frequency domain at the output of Doppler analyzer 210 has an interval equal to the interval, and when the Doppler shift amount interval ΔFD(nsw is expressed at the interval of the Doppler frequency index, ΔFD(nsw=Ncsub/N_{DM}(nsw). Accordingly, in the outputs of Doppler analyzers 210, a peak is detected for each Doppler-shift multiplexed signal at an interval of ΔFD in the Doppler frequency domain, and the Doppler domain compression CFAR processing described as the processing of CFAR section 211 in Embodiment 1 can be applied. In this case, f_{s_comp}=−ΔFD(nsw)/2 to −ΔFD(nsw)/2−1. Further, for example, CFAR section 211 outputs distance index f_{b_cfar} and Doppler frequency index f_{s_comp_cfar}(nsw) to Doppler demultiplexer 216.

Further, for example, when Expression 84 is used as the phase rotation amount φ_{ndm} for imparting Doppler shift amount DOP_{ndm}, the interval of the Doppler shift amount in the Doppler frequency domain at the output of Doppler analyzer 210 is an unequal interval, and is an integer multiple of interval ΔFD(nsw) of the Doppler shift amount at the interval of the Doppler frequency index. Here, ΔFD(nsw)=Ncsub/(N_{DM}(nsw)+Nᵢₙₜ(nsw)). Accordingly, in the outputs of Doppler analyzers 210, a peak is detected for each Doppler-shift multiplexed signal at an interval of ΔFD(nsw) or an interval of an integer multiple of ΔFD(nsw) in the Doppler frequency domain, and the Doppler domain compression CFAR processing described as the processing of CFAR section 211 in Embodiment 1 can be applied. In this case, f_{s_comp}=−ΔFD(nsw)/2 to −ΔFD(nsw)/2−1. Further, for example, CFAR section 211 outputs distance index f_{b_cfar} and Doppler frequency index f_{s_comp_cfar}(nsw) to Doppler demultiplexer 216.

A description will be given below of the operation performed when the Doppler domain compression CFAR processing is applied.

In FIG. 25, nswth Doppler demultiplexer 216 demultiplexes the Doppler multiplexed signal based on distance index f_{b_cfar}(nsw) and Doppler frequency index f_{s_comp_cfar}(nsw) inputted from CFAR section 211 and the output from nswth Doppler analyzer 210.

For example, the separation of Doppler multiplexed signals of unequal intervals using Expression 84 is described in PTL 5, and a detailed description thereof is thus omitted. Further, Doppler demultiplexer 216 specifies Doppler multiplexed signal DOP_{ndm}(nsw) by using the power information of the Doppler frequency index that provides outputs VFT_{z}^{nsw} (f_{b_cfar}, f_{s_comp_cfar}(nsw)) and VFT_{z}^{nsw}(f_{b_cfar}, f_{s_comp_cfar}(nsw)+ΔFD (nsw)×(integer multiple)) of nswth Doppler analyzer 210 for distance index f_{b_cfar}(nsw) and Doppler frequency index f_{s_comp_cfar}(nsw). Further, Doppler demultiplexer 216 can detect transmission antenna 109 assigned for the Doppler multiplexed signal based on the Doppler multiplexing assignment table. Further, Doppler demultiplexer 216 can detect the Doppler frequency of the target object within the range of ±1/(2N_{sw}×Tr).

Further, for example, in the separation of Doppler multiplexed signals of equal intervals using Expression 83, Doppler demultiplexer 216 configures the Doppler frequency of the target object within the range of ±1/(2N_{sw}×N_{DM}(nsw)×Tr) and specifies Doppler multiplexed signal DOP_{ndm}(nsw) by using the Doppler frequency index that provides outputs VFT_{z}^{nsw} (f_{b_cfar}, f_{s_comp_cfar}(nsw)) and VFT_{z}^{nsw}(f_{b_cfar}, f_{s_comp_cfar}(nsw)+ΔFD(nsw)×(integer multiple)) of nswth Doppler analyzer 210 for distance index f_{b_cfar}(nsw) and Doppler frequency index f_{s_comp_cfar}(nsw). Further, Doppler demultiplexer 216 can detect transmission antenna 109 assigned for the Doppler multiplexed signal based on the Doppler multiplexing assignment table.

Hereinafter, the Doppler frequency of ndmth Doppler multiplexed signal of the detected target object is denoted as FDP(ndm, f_{s_comp_cfar}(nsw)) with respect to distance index f_{b_cfar}(nsw) and Doppler frequency index f_{s_comp_cfar}(nsw) inputted from CFAR section 211.

Through the above operations, nswth Doppler demultiplexer 216 performs Doppler demultiplexing based on distance index f_{b_cfar} and Doppler frequency index f_{s_comp_cfar} inputted from CFAR section 211 and the output from nswth Doppler analyzer 210. Then, nswth Doppler demultiplexer 216 outputs, to direction estimator 214, outputs VFT_{z}^{nsw} (f_{b_cfar}, FDP(1, f_{s_comp_cfar})), VFT_{z}^{nsw} (f_{b_cfar}, FDP(2, f_{s_comp_cfar})), . . . , VFT_{z}^{nsw}(f_{b_cfar}, FDP(N_{DM}(nsw), f_{s_comp_cfar})) of nswth Doppler analyzer 210 for distance index f_{b_cfar} and the Doppler frequency components of N_{DM}(nsw) Doppler multiplexed signals as demultiplexed reception signals of the Doppler multiplexed signal. Here, z=1 to Na and nsw=1 to N_{sw}.

In FIG. 25, direction estimator 214 performs a target direction estimation processing based on the demultiplexed reception signals of the Doppler multiplexed signals with respect to distance index f_{b_cfar} and Doppler frequency index f_{s_comp_cfar} inputted from Doppler demultiplexer 216.

Direction estimator 214 generates virtual reception array correlation vector hs_{nsw}(b_cfar, f_{s_comp_cfar}) for each output VFT_{z}^{nsw}(f_{b_cfar}, FDP(1, f_{s_comp_cfar})), VFT_{z}^{nsw}(f_{b_cfar}, FDP(2, f_{s_comp_cfar})), . . . , and VFT_{z}^{nsw} (f_{b_cfar}, FDP(N_{DM}(nsw), f_{s_comp_cfar})) of each nswth Doppler analyzer 210, which is a demultiplexed reception signal of a Doppler multiplexed signal, and performs direction estimation processing. As given by Expression 89, each virtual reception array correlation vector hs_{nsw}(f_{b_cfar}, f_{s_comp_cfar}) includes N_{DM}(nsw)×Na elements. Based on phase differences between reception antennas 202, direction estimator 214 performs the direction estimation processing on the reflected wave signals from a target using N_{sw} virtual reception array correlation vectors hs₁(f_{b_cfar}, f_{s_comp_cfar}) to hS_{Nsw}(f_{b_cfar}, f_{s_comp_cfar}).

$$[ 92 ]$$

$${hs}_{nsw} ( {f}_{b \_ cfar} , {f}_{s \_ comp \_ cfar} ) = [ \begin{matrix}{VFT}_{1}^{nsw} ( {f}_{b \_ cfar} , FDP ( 1 , {f}_{s \_ comp \_ cfar} ) ) \\ {VFT}_{2}^{nsw} ( {f}_{b \_ cfar} , FDP ( 1 , {f}_{s \_ comp \_ cfar} ) ) \\ ⋮ \\ {VFT}_{{N}_{a}}^{nsw} ( {f}_{b \_ cfar} , FDP ( 1 , {f}_{s \_ comp \_ cfar} ) ) \\ {VFT}_{1}^{nsw} ( {f}_{b \_ cfar} , FDP ( 2 , {f}_{s \_ comp \_ cfar} ) ) \\ {VFT}_{2}^{nsw} ( {f}_{b \_ cfar} , FDP ( 2 , {f}_{s \_ comp \_ cfar} ) ) \\ ⋮ \\ {VFT}_{{N}_{a}}^{nsw} ( {f}_{b \_ cfar} , FDP ( 2 , {f}_{s \_ comp \_ cfar} ) ) \\ ⋮ \\ {VFT}_{1}^{nsw} ( {f}_{b \_ cfar} , FDP ( {N}_{DM} ( nws ) , {f}_{s \_ comp \_ cfar} ) ) \\ {VFT}_{2}^{nsw} ( {f}_{b \_ cfar} , FDP ( {N}_{DM} ( nws ) , {f}_{s \_ comp \_ cfar} ) ) \\ ⋮ \\ {VFT}_{{N}_{a}}^{nsw} ( {f}_{b \_ cfar} , FDP ( {N}_{DM} ( nws ) , {f}_{s \_ comp \_ cfar} ) )\end{matrix} ] \qquad ( Expression 89 )$$

Direction estimator 214 may extract, from N_{sw} virtual reception array correlation vectors hs₁(f_{b_cfar}, f_{s_comp_cfar}) to hS_{Nsw}(f_{b_cfar}, f_{s_comp_cfar}), elements that are combinations of the polarization of a predetermined transmission antenna and the polarization of a reception antenna, and perform the direction estimation processing using the virtual reception array correlation vector composed of the extracted elements. It is thus possible to obtain a direction estimation result per polarization of the predetermined transmission antenna and polarization of the reception antenna.

For example, when transmission switching controller 112 performs control based on the Doppler multiplexing assignment table of FIG. 26 described above, N_{sw} (=2) virtual reception array correlation vectors hs₁(f_{b_cfar}, f_{s_comp_cfar}) and hs₂(f_{b_cfar}, f_{s_comp_cfar}) are obtained.

Here, virtual reception array correlation vector hs₁(f_{b_cfar}, f_{s_comp_cfar}) for which nsw is 1 includes elements as given by following Expression 90, and number N_{DM}(1) of Doppler multiplexing=2. Further, since a Doppler multiplexed signal using DOP₁ and DOP₂ is a reflected reception signal with respect to a forward-circularly-polarized transmission signal, direction estimator 214 performs the direction estimation processing using virtual reception array correlation vector hs₁(f_{b_cfar}, f_{s_comp_cfar}) in the direction estimation processing with respect to the forward circular polarization.

$$[ 93 ]$$

$${hs}_{1} ( {f}_{b \_ cfar} , {f}_{s \_ comp \_ cfar} ) = [ \begin{matrix}{VFT}_{1}^{1} ( {f}_{b \_ cfar} , FDP ( 1 , {f}_{s \_ comp \_ cfar} ) ) \\ {VFT}_{2}^{1} ( {f}_{b \_ cfar} , FDP ( 1 , {f}_{s \_ comp \_ cfar} ) ) \\ ⋮ \\ {VFT}_{{N}_{a}}^{1} ( {f}_{b \_ cfar} , FDP ( 1 , {f}_{s \_ comp \_ cfar} ) ) \\ {VFT}_{1}^{1} ( {f}_{b \_ cfar} , FDP ( 2 , {f}_{s \_ comp \_ cfar} ) ) \\ {VFT}_{2}^{1} ( {f}_{b \_ cfar} , FDP ( 2 , {f}_{s \_ comp \_ cfar} ) ) \\ ⋮ \\ {VFT}_{{N}_{a}}^{1} ( {f}_{b \_ cfar} , FDP ( 2 , {f}_{s \_ comp \_ cfar} ) )\end{matrix} ] \qquad ( Expression 90 )$$

Further, virtual reception array correlation vector hs₂(f_{b_cfar}, f_{s_comp_cfar}) for which nsw is 2 includes elements as given by following Expression 91, and number N_{DM}(1) of Doppler multiplexing=4. Further, since a Doppler multiplexed signal using DOP₁, DOP₂, DOP₃, and DOP₄ is a reflected reception signal with respect to a horizontally or vertically polarized transmission signal, direction estimator 214 performs the direction estimation processing using virtual reception array correlation vector hs₂(f_{b_cfar}, f_{s_comp_cfar}) in the direction estimation processing with respect to the linear circular polarization.

$$[ 94 ]$$

$${hs}_{2} ( {f}_{b \_ cfar} , {f}_{s \_ comp \_ cfar} ) = [ \begin{matrix}{VFT}_{1}^{2} ( {f}_{b \_ cfar} , FDP ( 1 , {f}_{s \_ comp \_ cfar} ) ) \\ {VFT}_{2}^{2} ( {f}_{b \_ cfar} , FDP ( 1 , {f}_{s \_ comp \_ cfar} ) ) \\ ⋮ \\ {VFT}_{{N}_{a}}^{2} ( {f}_{b \_ cfar} , FDP ( 1 , {f}_{s \_ comp \_ cfar} ) ) \\ {VFT}_{1}^{2} ( {f}_{b \_ cfar} , FDP ( 2 , {f}_{s \_ comp \_ cfar} ) ) \\ {VFT}_{2}^{2} ( {f}_{b \_ cfar} , FDP ( 2 , {f}_{s \_ comp \_ cfar} ) ) \\ ⋮ \\ {VFT}_{{N}_{a}}^{2} ( {f}_{b \_ cfar} , FDP ( 2 , {f}_{s \_ comp \_ cfar} ) ) \\ ⋮ \\ {VFT}_{1}^{2} ( {f}_{b \_ cfar} , FDP ( 4 , {f}_{s \_ comp \_ cfar} ) ) \\ {VFT}_{2}^{2} ( {f}_{b \_ cfar} , FDP ( 4 , {f}_{s \_ comp \_ cfar} ) ) \\ ⋮ \\ {VFT}_{{N}_{a}}^{2} ( {f}_{b \_ cfar} , FDP ( 4 , {f}_{s \_ comp \_ cfar} ) )\end{matrix} ] \qquad ( Expression 91 )$$

Hereinafter, the direction estimation processing with respect to the linear polarization using virtual reception array correlation vector hₛ₂(f_{b_cfar}, f_{s_cfar}) and the direction estimation processing with respect to the forward circular polarization using forward-circularly-polarized virtual reception array correlation vector hₛ₂(f_{b_cfar}, f_{s_cfar}) in direction estimator 214 are the same as those in Embodiment 1, and the description of the operation thereof is omitted.

Note that, direction estimator 214 may perform direction estimation processing using a reception signal including a combination of different types of polarization. In this case, a direction estimation result that is less dependent on the polarization is obtained, and the reception SNR can be improved by performing the direction estimation processing using more virtual antennas. Thus, the detection performance of radar apparatus 10c can be improved. Further, since the direction estimation processing using the maximum aperture length of the available virtual reception antennas is performed, the angular resolution is also improved.

Further, direction estimator 214 may perform the direction estimation processing using the polarized antennas of the same type for the transmission and reception as described above, and the direction estimation processing combining the polarizations of the different types, and may use both of the direction estimation results as the direction estimation processing result. As a result, a direction estimation processing result highly dependent on the polarization and a direction estimation processing result less dependent on the polarization are obtained. The result of such direction estimation processing may be input to a target object identification processor not illustrated in the figures, and target object identification processing may be performed.

Note that transmission weight Wntx(nsw) used in Embodiment 2 represent codes in a case where the phase difference between the transmission antennas 109 are corrected in advance. Therefore, in transmission weight generator 113, when the beam transmission antenna is ON, the phase difference between feeding points of the two transmission antennas constituting the beam transmission antenna is the phase difference between the transmission weights applied to the transmission antennas.

Here, regarding the transmission weights applied to the two transmission antennas constituting the beam transmission antenna, when the transmission weight of Amp×exp[jη] is configured for one of transmission antennas 109 and the transmission weight of Amp×exp[j(η+π/2)] or Amp×exp[j(η−π/2)] is applied to the other transmission antenna 109, the phase difference between the feeding points of the two transmission antennas is 900 or −90° for each transmission period.

Likewise, regarding the transmission weights applied to the two transmission antennas constituting the beam transmission antenna, when the transmission weight of Amp×exp[jη] is configured for one of transmission antennas 109 and the transmission weight of Amp×exp[j(η+ξ)] or Amp×exp[j(η−ξ)] is applied to the other transmission antenna 109, the phase difference between the feeding points of the two transmission antennas is ξ or −ξ for each transmission period. Here, for example, it is possible to use a range of π/6 to 5π/6 radians (=300 to 150°) for ξ.

The embodiments of the present disclosure have been described above.

### Other Embodiments

(1) By way of example, the antenna arrangement examples illustrated in FIGS. 15 to 18 have been described in which the types of polarization of transmission antennas 109 are “H,” “V,” “H,” and “V” from the left, but the arrangement of transmission antennas 109 is not limited thereto, and the arrangement may be such that adjacent transmission antennas 109 form a pair of a horizontally polarized antenna (H) and a vertically polarized antenna (V).

For example, in the antenna arrangements illustrated in FIGS. 15 to 18, the arrangement of the types of polarization of transmission antennas 109 may be “H,” “V,” “V,” and “H” from the left. In the case of this arrangement, for example, high isolation is achieved. Further, for example, in the antenna arrangements illustrated in FIGS. 15 to 18, the arrangement of the types of polarization of transmission antennas 109 may be “V,” “H,” “H,” and “V” from the left.
(2) In the radar apparatuses according to one exemplary embodiment of the present disclosure, the radar transmitter and the radar receiver may be individually arranged in physically separate locations from each other. In the radar receiver according to the exemplary embodiments of the present disclosure, the direction estimator and any other component may be individually arranged in physically separate locations from one another.
(3) The numerical values of parameters such as number Nt of transmission antennas, number Na of reception antennas, number N_{DM} of Doppler multiplexing, number N_{CM} of codes, number N_{BF} of beam transmission antennas, the number of pairs of transmission antennas, and the variably configured Doppler shift period used in one exemplary embodiment are examples, and are not limited to those values.

A radar apparatus according to an exemplary embodiment of the present disclosure includes, for example, a central processing unit (CPU), a storage medium such as a read only memory (ROM) that stores a control program, and a work memory such as a random access memory (RAM), which are not illustrated. In this case, the functions of the sections described above are implemented by the CPU executing the control program. However, the hardware configuration of the radar apparatus is not limited to that in this example. For example, the functional sections of the radar apparatus may be implemented as an integrated circuit (IC). Each functional section may be formed as an individual chip, or some or all of them may be formed into a single chip.

Various embodiments have been described with reference to the drawings hereinabove. Obviously, the present disclosure is not limited to these examples. Obviously, a person skilled in the art would arrive variations and modification examples within a scope described in claims, and it is understood that these variations and modifications are within the technical scope of the present disclosure. Each constituent element of the above-mentioned embodiments may be combined optionally without departing from the spirit of the disclosure.

The expression “section” used in the above-described embodiments may be replaced with another expression such as “circuit (circuitry),” “device,” “unit,” or “module.”

The above embodiments have been described with an example of a configuration using hardware, but the present disclosure can be realized by software in cooperation with hardware.

Each functional block used in the description of each embodiment described above is typically realized by an LSI, which is an integrated circuit. The integrated circuit controls each functional block used in the description of the above embodiments and may include an input terminal and an output terminal. The LSI may be individually formed as chips, or one chip may be formed so as to include a part or all of the functional blocks. The LSI herein may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, a Field Programmable Gate Array (FPGA) that can be programmed after the manufacture of the LSI or a reconfigurable processor in which the connections and the configurations of circuit cells disposed inside the LSI can be reconfigured may be used.

If future integrated circuit technology replaces LSIs as a result of the advancement of semiconductor technology or other derivative technology, the functional blocks could be integrated using the future integrated circuit technology. Biotechnology can also be applied.

### Summary of Present Disclosure

A radar apparatus according to one exemplary embodiment of the present disclosure includes: a plurality of transmission antennas including a first transmission antenna for emitting a first linearly polarized wave and a second transmission antenna adjacent to the first transmission antenna and for emitting a second linearly polarized wave different from the first linearly polarized wave; and transmission circuitry, which, in operation, performs multiplexing transmission of a transmission signal to which a phase rotation amount with a phase different by ξ or −ξ between the first transmission antenna and the second transmission antenna in each transmission period is applied, from the plurality of transmission antennas.

In one exemplary embodiment of the present disclosure, the transmission circuitry performs code multiplexing on the transmission signal using a plurality of orthogonal codes, and among the plurality of orthogonal codes, a phase of a code element corresponding to each transmission period is different by ξ or −ξ between a first orthogonal code for the transmission signal transmitted from the first transmission antenna and a second orthogonal code for the transmission signal transmitted from the second transmission antenna.

In one exemplary embodiment of the present disclosure, the ξ is any value in a range of from 300 to 150°.

In one exemplary embodiment of the present disclosure, the transmission circuitry configures a same Doppler shift amount for the first transmission antenna and the second transmission antenna.

In one exemplary embodiment of the present disclosure, when the plurality of transmission antennas include a plurality of pairs of the first transmission antenna and the second transmission antenna, the transmission circuitry configures a Doppler shift amount different for each of the plurality of pairs.

In one exemplary embodiment of the present disclosure, the radar apparatus further includes: first Doppler analysis circuitry, which in operation, performs Doppler analysis using a reflected wave signal resulting from the transmission signal transmitted from each of the first transmission antenna and the second transmission antenna and reflected by a target in either odd-numbered or even-numbered transmission period; second Doppler analysis circuitry, which in operation, performs Doppler analysis using the reflected wave signal in an other of the odd-numbered and even-numbered transmission periods; first separation circuitry, which in operation, separates a circularly polarized signal using either an output of the first Doppler analysis circuitry or an output of the second Doppler analysis circuitry; and second separation circuitry, which in operation, separates at least one signal of the first linearly polarized wave and the second linearly polarized wave using both the output of the first Doppler analysis circuitry and the output of the second Doppler analysis circuitry.

In one exemplary embodiment of the present disclosure, the radar apparatus further includes a plurality of reception antennas, in which the plurality of reception antennas include an antenna for receiving at least one of the first linearly polarized wave, the second linearly polarized wave, a circularly polarized wave in a first direction, and a circularly polarized wave in a second direction opposite to the first direction.

In one exemplary embodiment of the present disclosure, when the plurality of transmission antennas include a plurality of pairs of the first transmission antenna and the second transmission antenna, the transmission circuitry performs time-division multiplexing transmission of the transmission signal from each of the plurality of pairs.

In one exemplary embodiment of the present disclosure, upon transmission from each of the first transmission antenna and the second transmission antenna, the transmission circuitry switches transmission processing over time between first transmission processing for performing multiplexing transmission of the transmission signal by applying a same Doppler shift amount and a transmission weight including the phase rotation amount with the phase different by the ξ or −ξ, and second transmission processing for performing multiplexing transmission of the transmission signal by applying different Doppler shift amounts.

In one exemplary embodiment of the present disclosure, upon transmission from each of the first transmission antenna and the second transmission antenna, the transmission circuitry performs, in a same transmission period, first transmission processing for performing multiplexing transmission of the transmission signal by applying a same Doppler shift amount and a transmission weight including the phase rotation amount with the phase different by the ξ or −ξ, and second transmission processing for performing multiplexing transmission of the transmission signal by applying different Doppler shift amounts.

In one exemplary embodiment of the present disclosure, when the plurality of transmission antennas include a plurality of pairs of the first transmission antenna and the second transmission antenna, the transmission circuitry configures a Doppler shift amount different for each of the plurality of pairs in the first transmission processing.

In one exemplary embodiment of the present disclosure, the radar apparatus further includes a plurality of reception antennas, in which the plurality of transmission antennas includes a plurality of pairs of the first transmission antenna and the second transmission antenna, and a difference between, on one hand, a spacing between phase centers of the plurality of pairs and, on the other hand, a spacing between adjacent reception antennas of the plurality of reception antennas is a defined value based on a wavelength of the transmission signal.

In one exemplary embodiment of the present disclosure, the defined value is any value in a range of from 0.45 times to 0.8 times the wavelength.

In one exemplary embodiment of the present disclosure, the radar apparatus further including a plurality of reception antennas, in which a spacing between the first transmission antenna and the second transmission antenna and a spacing between adjacent reception antennas of the plurality of reception antennas have a first defined value based on a wavelength of the transmission signal in a first direction, and a spacing between a part of the plurality of reception antennas and an other of the plurality of reception antennas has a second defined value based on the wavelength of the transmission signal in a second direction orthogonal to the first direction.

In one exemplary embodiment of the present disclosure, each of the first defined value and the second defined value is any value in a range of from 0.45 times to 0.8 times the wavelength.

The disclosure of Japanese Patent Application No. 2022-047159, filed on Mar. 23, 2022, including the specification, drawings and abstract, is incorporated herein by reference in its entirety.

### INDUSTRIAL APPLICABILITY

The present disclosure is suitable as a radar apparatus for wide-angle range sensing.

### REFERENCE SIGNS LIST

10, 10a, 10b, 10c Radar apparatus
100, 100a, 100b, 100c Radar transmitter
101 Radar transmission signal generator
102 Transmission signal generation controller
103 Modulation signal generator
104 VCO
105 Phase rotation amount setter
106 Doppler shift setter
107 Encoder
108 Phase rotator
109 Transmission antenna
110, 112 Transmission switching controller
111 Transmission switch
113 Transmission weight generator
114 Transmission weight multiplier
200 Radar receiver
201 Antenna system processor
202 Reception antenna
203 Reception radio
204 Mixer
205 LPF
206 Signal processor
207 AD converter
208 Beat frequency analyzer
209 Output switch
210 Doppler analyzer
211 CFAR section
212 Coded Doppler demultiplexer
213, 216 Doppler demultiplexer
214 Direction estimator
215 Code demultiplexer
300 Positioning output section

1. A radar apparatus, comprising:
a plurality of transmission antennas including a first transmission antenna for emitting a first linearly polarized wave and a second transmission antenna adjacent to the first transmission antenna and for emitting a second linearly polarized wave different from the first linearly polarized wave; and
transmission circuitry, which, in operation, performs multiplexing transmission of a transmission signal to which a phase rotation amount with a phase different by ξ or −ξ between the first transmission antenna and the second transmission antenna in each transmission period is applied, from the plurality of transmission antennas.

2. The radar apparatus according to claim 1, wherein:
the transmission circuitry performs code multiplexing on the transmission signal using a plurality of orthogonal codes, and
among the plurality of orthogonal codes, a phase of a code element corresponding to each transmission period is different by ξ or −ξ between a first orthogonal code for the transmission signal transmitted from the first transmission antenna and a second orthogonal code for the transmission signal transmitted from the second transmission antenna.

3. The radar apparatus according to claim 1, wherein
the ξ is any value in a range of from 30° to 150°.

4. The radar apparatus according to claim 2, wherein
the transmission circuitry configures a same Doppler shift amount for the first transmission antenna and the second transmission antenna.

5. The radar apparatus according to claim 2, wherein
when the plurality of transmission antennas include a plurality of pairs of the first transmission antenna and the second transmission antenna, the transmission circuitry configures a Doppler shift amount different for each of the plurality of pairs.

6. The radar apparatus according to claim 1, further comprising:
first Doppler analysis circuitry, which in operation, performs Doppler analysis using a reflected wave signal resulting from the transmission signal transmitted from each of the first transmission antenna and the second transmission antenna and reflected by a target in either odd-numbered or even-numbered transmission period;
second Doppler analysis circuitry, which in operation, performs Doppler analysis using the reflected wave signal in an other of the odd-numbered and even-numbered transmission periods;
first separation circuitry, which in operation, separates a circularly polarized signal using either an output of the first Doppler analysis circuitry or an output of the second Doppler analysis circuitry; and
second separation circuitry, which in operation, separates at least one signal of the first linearly polarized wave and the second linearly polarized wave using both the output of the first Doppler analysis circuitry and the output of the second Doppler analysis circuitry.

7. The radar apparatus according to claim 1, further comprising:
a plurality of reception antennas, wherein
the plurality of reception antennas include an antenna for receiving at least one of the first linearly polarized wave, the second linearly polarized wave, a circularly polarized wave in a first direction, and a circularly polarized wave in a second direction opposite to the first direction.

8. The radar apparatus according to claim 1, wherein
when the plurality of transmission antennas include a plurality of pairs of the first transmission antenna and the second transmission antenna, the transmission circuitry performs time-division multiplexing transmission of the transmission signal from each of the plurality of pairs.

9. The radar apparatus according to claim 1, wherein
upon transmission from each of the first transmission antenna and the second transmission antenna, the transmission circuitry switches transmission processing over time between:
first transmission processing for performing multiplexing transmission of the transmission signal by applying a same Doppler shift amount and a transmission weight including the phase rotation amount with the phase different by the ξ or −ξ, and
second transmission processing for performing multiplexing transmission of the transmission signal by applying different Doppler shift amounts.

10. The radar apparatus according to claim 1, wherein
upon transmission from each of the first transmission antenna and the second transmission antenna, the transmission circuitry performs, in a same transmission period,
first transmission processing for performing multiplexing transmission of the transmission signal by applying a same Doppler shift amount and a transmission weight including the phase rotation amount with the phase different by the ξ or −ξ, and
second transmission processing for performing multiplexing transmission of the transmission signal by applying different Doppler shift amounts.

11. The radar apparatus according to claim 8, wherein
when the plurality of transmission antennas include the plurality of pairs of the first transmission antenna and the second transmission antenna, the transmission circuitry configures a Doppler shift amount different for each of the plurality of pairs in transmission processing for performing multiplexing transmission of the transmission signal by applying a same Doppler shift amount and a transmission weight including the phase rotation amount with the phase different by the ξ or −ξ.

12. The radar apparatus according to claim 1, further comprising:
a plurality of reception antennas, wherein
the plurality of transmission antennas includes a plurality of pairs of the first transmission antenna and the second transmission antenna, and
a difference between, on one hand, a spacing between phase centers of the plurality of pairs and, on the other hand, a spacing between adjacent reception antennas of the plurality of reception antennas is a defined value based on a wavelength of the transmission signal.

13. The radar apparatus according to claim 12, wherein
the defined value is any value in a range of from 0.45 times to 0.8 times the wavelength.

14. The radar apparatus according to claim 1, further comprising:
a plurality of reception antennas, wherein
a spacing between the first transmission antenna and the second transmission antenna and a spacing between adjacent reception antennas of the plurality of reception antennas have a first defined value based on a wavelength of the transmission signal in a first direction, and
a spacing between a part of the plurality of reception antennas and an other of the plurality of reception antennas has a second defined value based on the wavelength of the transmission signal in a second direction orthogonal to the first direction.

15. The radar apparatus according to claim 14, wherein
each of the first defined value and the second defined value is any value in a range of from 0.45 times to 0.8 times the wavelength.

16. A radar signal processing method, comprising:
applying, to a transmission signal, a phase rotation amount with a phase different by ξ or −ξ between a first transmission antenna and a second transmission antenna in each transmission period; and
performing multiplexing transmission of the transmission signal from a plurality of transmission antennas including the first transmission antenna and the second transmission antenna, wherein
the first transmission antenna emits a first linearly polarized wave, and
the second transmission antenna is adjacent to the first transmission antenna, and emits a second linearly polarized wave different from the first linearly polarized wave.

17. The radar signal processing method according to claim 16, wherein:
the multiplexing transmission is code multiplexing transmission using a plurality of orthogonal codes, and
among the plurality of orthogonal codes, a phase of a code element corresponding to each transmission period is different by ξ or −ξ between a first orthogonal code for the transmission signal transmitted from the first transmission antenna and a second orthogonal code for the transmission signal transmitted from the second transmission antenna.

18. The radar signal processing method according to claim 16, wherein
the ξ is any value in a range of from 30° to 150°.

19. The radar signal processing method according to claim 17, wherein
a Doppler shift amount the same between the first transmission antenna and the second transmission antenna is further configured for the transmission signal.

20. The radar signal processing method according to claim 17, wherein
when the plurality of transmission antennas includes a plurality of pairs of the first transmission antenna and the second transmission antenna, a Doppler shift amount different for each of the plurality of pairs is configured for the transmission signal.
